(19) United States
(12) Patent Application Publication
(10) Pub. No.: US 2023/0288771 A1
(43) Pub. Date: Sep. 14, 2023

(54) CONNECTORS FOR SMART WINDOWS

(71) Applicant: View, Inc., Milpitas, CA (US)

(72) Inventors: Trevor Gustav Frank, San Jose, CA (US); Daniel Loy Purdy, Benicia, CA (US); Brady William Harris, Henderson, NV (US); Aaron Michael Smith, Madison, CT (US); Robert Michael Martinson, Palo Alto, CA (US); Karan Soni, Collierville, TN (US)

(73) Assignee: View, Inc., Milpitas, CA (US)

(21) Appl. No.: 18/174,544

(22) Filed: Feb. 24, 2023

Related U.S. Application Data
(63) Continuation-in-part of application No. PCT/US2021/047809, filed on Aug. 26, 2021.
Application No. PCT/US2021/047809 is a continuation-in-part of application No. 16/197,178, filed on Nov. 20, 2018, now Pat. No. 11,181,797.
Application No. 16/197,178 is a continuation of application No. 15/243,816, filed on Aug. 22, 2016, now Pat. No. 10,175,549.
Application No. 15/243,816 is a continuation-in-part of application No. 14/489,414, filed on Sep. 17, 2014, now Pat. No. 9,778,532.
Application No. 14/489,414 is a continuation-in-part of application No. PCT/US2014/043514, filed on Jun. 20, 2014.
Application No. 15/243,816 is a continuation-in-part of application No. 14/363,769, filed on Jun. 6, 2014, now Pat. No. 9,671,665.
Application No. 15/243,816 is a continuation-in-part of application No. 13/968,258, filed on Aug. 15, 2013, now Pat. No. 9,482,922.
Application No. PCT/US2014/043514 is a continuation-in-part of application No. 13/931,459, filed on Jun. 28, 2013, now Pat. No. 9,412,290.
Application No. 14/363,769 is a continuation-in-part of application No. 13/326,168, filed on Dec. 14, 2011, now Pat. No. 8,643,933.
Application No. 13/968,258 is a continuation-in-part of application No. 13/326,168, filed on Dec. 14, 2011, now Pat. No. 8,643,933.
Application No. 14/489,414 is a continuation-in-part of application No. 13/309,990, filed on Dec. 2, 2011, now Pat. No. 8,864,321.
Application No. 13/968,258 is a continuation of application No. 13/049,756, filed on Mar. 16, 2011, now Pat. No. 9,454,055.
Application No. 13/309,990 is a continuation of application No. 13/049,623, filed on Mar. 16, 2011, now Pat. No. 8,254,013.
(60) Provisional application No. 63/374,226, filed on Aug. 31, 2022.
(60) Provisional application No. 63/070,692, filed on Aug. 26, 2020.

(51) Int. Cl. E06B 7/28; G02F 1/163; H01H 15/04; H01H 15/14; H02G 11/00; H01R 41/00; H01R 12/53; H01R 12/62; H01R 13/62; E06B 3/44; E06B 3/46; E06B 9/24

(52) U.S. Cl. CPC E06B 7/28; E06B 3/44; E06B 3/4636; E06B 9/24; G02F 1/163; H01H 15/04; H01H 15/14; H01R 12/53; H01R 12/62; H01R 13/6205; H01R 41/00; H02G 11/00; H01R 12/55

(57) ABSTRACT

This disclosure provides connectors for smart windows and doors. A smart window or door may incorporate an optically switchable pane. In one aspect, a smart window or door includes an insulated glass unit including an optically switchable pane. One aspect pertains to connectors such as, e.g., detachable power transfer connectors for movable doors or windows.

### CROSS-REFERENCES TO RELATED APPLICATIONS

This application is a continuation-in-part of International Application Number PCT/US2021/047809 (designating the United States), titled “CONNECTORS FOR SMART WINDOWS” and filed on Aug. 26, 2021; This application also claims priority to U.S. Provisional Application 63/374,226, titled “CONNECTORS FOR SMART WINDOWS” and filed on Aug. 31, 2022; International Application Number PCT/US2021/047809 claims benefit of and priority to U.S. Provisional Application 63/070,692, titled “CONNECTORS FOR SMART WINDOWS” and filed on Aug. 26, 2020; International Application Number PCT/US2021/047809 is also a continuation-in-part of U.S. Pat. Application 16/197,178, titled “CONNECTORS FOR SMART WINDOWS” and filed on Nov. 20, 2018; U.S. Pat. Application 16/197,178 is a continuation of U.S. Pat. Application 15/243,816, titled “CONNECTORS FOR SMART WINDOWS” and filed on Aug. 22, 2016, which is a continuation-in-part of U.S. Pat. Application 14/363,769 (now U.S. Pat. No. 9,671,665), filed on Jun. 6, 2014 and titled “CONNECTORS FOR SMART WINDOWS,” which is a national stage application under 35 U.S.C. §371 to International Application Number PCT/US12/68950 (designating the United States), filed on Dec. 11, 2012 and titled “CONNECTORS FOR SMART WINDOWS,” which is a continuation-in-part of U.S. Pat. Application 13/326,168 (now U.S. Pat. No. 8,643,933), filed on Dec. 14, 2011 and titled “CONNECTORS FOR SMART WINDOWS;” U.S. Pat. Application 15/243,816 is also a continuation-in-part of U.S. Pat. Application No. 13/968,258 (now U.S. Pat. No. 9,482,922), filed on Aug. 15, 2013 and titled “MULTIPURPOSE CONTROLLER FOR MULTISTATE WINDOWS,” which is a continuation of U.S. Pat. Application No. 13/049,756 (now U.S. Pat. No. 9,454,055), titled “MULTIPURPOSE CONTROLLER FOR MULTISTATE WINDOWS” and filed on Mar. 16, 2011;, U.S. Pat. Application No. 13/968,258 is also a continuation-in-part of U.S. Pat. Application No. 13/326,168 (now U.S. Pat. No. 8,643,933), titled “CONNECTORS FOR SMART WINDOWS” and filed on Dec. 14, 2011; U.S. Pat. Application 15/243,816 is also a continuation-in-part of U.S. Pat. Application No. 14/489,414 (now U.S. Pat. No. 9,778,532), filed on Sep. 17, 2014 and titled “CONTROLLING TRANSITIONS IN OPTICALLY SWITCHABLE DEVICES;” U.S. Pat. Application No. 14/489,414 is a continuation-in-part of U.S. Pat. Application No. 13/309,990 (now U.S. Pat. No. 8,864,321), filed on Dec. 2, 2011 and titled “CONTROLLING TRANSITIONS IN OPTICALLY SWITCHABLE DEVICES,” which is a continuation of U.S. Pat. Application No. 13/049,623 (now U.S. Pat. No. 8,254,013), filed on Mar. 16, 2011 and titled “CONTROLLING TRANSITIONS IN OPTICALLY SWITCHABLE DEVICES;” and U.S. Pat. Application No. 14/489,414 is also a continuation-in-part of international PCT application PCT/US14/43514 (designating the United States), filed on Jun. 20, 2014 and titled “CONTROLLING TRANSITIONS IN OPTICALLY SWITCHABLE DEVICES,” which is a continuation-in-part of U.S. Pat. Application 13/931,459 (now U.S. Pat. No. 9,412,290), filed on Jun. 28, 2013 and titled “CONTROLLING TRANSITIONS IN OPTICALLY SWITCHABLE DEVICES;” each of these applications is hereby incorporated by reference in its entirety and for all purposes.

### FIELD

The disclosed embodiments relate generally to optically switchable devices, and more particularly to connectors for optically switchable windows.

### BACKGROUND

Various optically switchable devices are available for controlling tinting, reflectivity, etc. of window panes. Electrochromic devices are one example of optically switchable devices generally. Electrochromism is a phenomenon in which a material exhibits a reversible electrochemically-mediated change in an optical property when placed in a different electronic state, typically by being subjected to a voltage change. The optical property being manipulated is typically one or more of color, transmittance, absorbance, and reflectance. One well known electrochromic material is tungsten oxide (WO₃). Tungsten oxide is a cathodic electrochromic material in which a coloration transition, transparent to blue, occurs by electrochemical reduction.

Electrochromic materials may be incorporated into, for example, windows for home, commercial, and other uses. The color, transmittance, absorbance, and/or reflectance of such windows may be changed by inducing a change in the electrochromic material, that is, electrochromic windows are windows that can be darkened or lightened electronically. A small voltage applied to an electrochromic device of the window will cause it to darken; reversing the voltage causes it to lighten. This capability allows for control of the amount of light that passes through the window and presents an enormous opportunity for electrochromic windows to be used not only for aesthetic purposes but also for energy-savings.

With energy conservation being foremost in modern energy policy, it is expected that growth of the electrochromic window industry will be robust in the coming years. An important aspect of electrochromic window engineering is how to integrate electrochromic windows into new and existing (retrofit) applications. Of particular import is how to deliver power to the electrochromic glazings through framing and related structures.

### SUMMARY

Connectors for optically switchable devices, including electrochromic devices, are disclosed herein. A connector and an electrochromic device may be associated with or incorporated in an insulated glass unit (IGU), a window assembly, or a window unit, in some embodiments.

In one embodiment, a window unit includes an IGU including an optically switchable pane. A wire assembly is attached to an edge of the IGU and includes wires in electrical communication with distinct electrodes of the optically switchable pane. A floating connector is attached to the distal end of the wire assembly, with the floating connector being electrically coupled to the optically switchable pane. The floating connector includes a flange and a nose extending from the flange by a distance approximately equal to a thickness of a first frame in which the IGU is to be mounted. The nose includes a terminal face presenting, at least, two exposed contacts of opposite polarities. Other contacts may be present, e.g., for communication to a logic circuit in the window unit. The floating connector further includes two holes in the flange for affixing the floating connector to the first frame. The two holes in the flange are arranged with respect to the nose such that the nose is closer to one of the holes than the other, thereby requiring that the two exposed contacts be arranged in a defined orientation when the floating connector is affixed to the first frame. In other embodiments, the floating connector includes an asymmetric element in the shape of the nose and/or the flange that permits installation in only one way.

In another embodiment, a window assembly includes an IGU including an optically switchable pane. A first connector is mounted to the IGU in a sealant of the IGU. The first connector includes exposed contacts electrically coupled to leads extending from the optically switchable pane and through the IGU, e.g., around the perimeter of a spacer of the IGU and to the first connector. The first connector further includes a first ferromagnetic element which itself may be magnetized. A wire assembly is configured to be detachably mounted to the IGU through the first connector. The wire assembly includes at least two wires extending from and electrically coupled to a second connector. The second connector includes a surface having contacts and the surface is shaped for mechanical engagement to the first connector. The second connector further includes a second ferromagnetic element, which itself may be magnetized. At least one of the first and second ferromagnetic elements is magnetized such that the first and second connectors may magnetically engage one another to provide electrical communication between their respective contacts.

In another embodiment, a window system includes a first IGU. The first IGU includes a first optically switchable pane and a first connector in electrical communication with electrodes of the first optically switchable pane. A first coupling unit includes two connectors linked by a flexible ribbon cable, with a first of the two connectors being configured to mate with the first connector.

Certain embodiments include pre-wired spacers, electrical connection systems for IGUs that include at least one optical device and the IGUs that include such systems. In some embodiments, onboard controllers are part of the electrical connection systems. Many components of the electrical connection systems may be embedded within the secondary seal. Electrical connection systems described herein may include components for providing electrical powering to the IGU at virtually any location about the perimeter of the IGU. In this way, the installer in the field is given maximum convenience and flexibility when installing IGUs having optical devices, e.g., electrochromic devices.

Certain embodiments pertain to an electrical connection system for a sliding door. The electrical connection system comprises a guide and a shuttle. The guide comprises a recess within which pass one or more wires for electrical communication between at least a power source and an optically switchable device in the sliding door or window. The guide further comprises an outer surface and a lengthwise slot in the outer surface. The shuttle is configured to couple to the sliding door or window and slidably engage with the lengthwise slot in the guide. The shuttle is further configured to pass the one or more wires from the sliding door or window, through a body of the shuttle into the recess in the guide, wherein during movement of the sliding door or window, the one or more wires are protected from interaction with one or more moving components. In some cases, electrical connection system a flexible member affixed at one end to the shuttle. The one or more wires are coupled to the flexible member and the flexible member comprises a bend portion allowing the flexible member to pass back over itself and reside substantially parallel to the length of, and inside, the guide. In one example, the one or more wires are a ribbon cable and the flexible member is a spring steel tape. In another example, the flexible member is a chain guide made of a non-electrically conducting material, and the one or more wires reside within the body of the chain guide.

Certain embodiments pertain to an electrical connection system for a sliding door or window where the electrical connection system comprises a frame bracket configured to couple to the sliding door or window and a base bracket configured to couple to a header of the sliding window or door, or to a base rail. The frame bracket and the base bracket are configured to house opposing ends of an IGU connector cable. In one embodiment, the electrical connection system further comprises a chain guide configured to house a middle portion of the IGU connector cable between the frame bracket and the base bracket.

Certain embodiments pertain to an electrical connection system for a plurality of sliding doors or windows. The electrical connection system comprises a first frame guide with a plurality of lengthwise slots and shuttles configured to couple to the sliding doors or windows and configured to slidably engage with the lengthwise slots of the first frame guide. The electrical connection system also comprises chain guides configured to fold and unfold in a horizontal direction inside the lengthwise slots of the frame guide. The chain guides are coupled at one end to the shuttles and at the other end to the first frame guide or to a header. Each comprises a recess within which one or more wires reside. The one or more wires of the chain guides are in electrical communication with a power source and one or more optically-switchable devices of the sliding doors or windows.

Certain embodiments pertain to magnetic power transfer connectors. Some aspects pertain to a magnetic power transfer connector comprising a first component and a second component. The first component comprises a housing and a floating portion configured to float within the housing. The floating portion includes a first cone, a second cone and one or more first magnets. The first component also includes a plurality of pins. The second component comprises a first cup and a second cup. The first cup and the second cup are configured to receive the first and second cones respectively. The second component also comprises a plurality of pads configured for connection with the plurality of pins and metal or one or more second magnets of opposing polarity from the one or more first magnets.

Certain embodiments pertain to magnetic power transfer connectors and/or a window or door comprising one or more magnetic power transfer connectors.

Some embodiments pertain to a magnetic power transfer connector comprising a first component and a second component. The first component comprises a housing and a floating portion configured to float within the housing. The floating portion includes a first cone, a second cone and one or more first magnets. The first component also includes a plurality of pins. The second component comprises a first cup and a second cup. The first cup and the second cup are configured to receive the first and second cones respectively. The second component also comprises a plurality of pads configured for connection with the plurality of pins and metal or one or more second magnets of opposing polarity from the one or more first magnets.

Certain embodiments pertain to a door or window system comprising a plurality of detachable sliding doors or windows configured to slide along, and connect to and disconnect from, a rail. Each detachable sliding door or window comprises one or more magnetic power transfer connectors. Each magnetic power transfer connector comprises a first component and a second component. The first component comprises a housing and a floating portion configured to float within the housing. The floating portion includes a first cone, a second cone and one or more first magnets. The first component also includes a plurality of pins. The second component comprises a first cup and a second cup. The first cup and the second cup are configured to receive the first and second cones respectively. The second component also comprises a plurality of pads configured for connection with the plurality of pins and metal or one or more second magnets of opposing polarity from the one or more first magnets.

Certain embodiments pertain to a door or a window comprising an insulated glass unit having one or more optically switchable devices and a magnetic power transfer connector component. The magnetic power transfer connector component comprising a housing and a floating portion configured to float within the housing. The floating portion includes a first cone, a second cone, one or more first magnets and a plurality of first pins or first pads.

Certain embodiments pertain to detachable power transfer (DPT) connectors and/or a window or door comprising one or more DPT connectors. In some cases, the DPT connector comprises a first component (e.g., a frame-side component) and a second component (e.g., a window or door side component). In some cases, a DPT connector has only two active electrical contacts between the first and second components. The first component may include one or more spring-loaded conductive elements for providing power. The second component may comprise one or more conductive contact pads configured to electrically contact the one or more spring-loaded conductive elements.

Certain embodiments pertain to movable door/window systems. In some cases, a movable door or window system includes at least one movable door or window configured to move into a closed position within a frame of a building. The movable door or window system may also include a DPT connector having a first component attached to the frame of the building and a second component attached to the at least one movable door or window. The first component may include one or more spring-loaded conductive elements for providing power.

The second component may include one or more conductive pads configured to electrically contact the one or more spring-loaded conductive elements. The DPT connector may have only two active electrical contacts at each of the first and second components for establishing electrical contact.

Certain embodiments pertain to a movable door or window comprising an insulated glass unit having one or more optically switchable devices (e.g., electrochromic devices). The movable door or window also includes a DPT connector comprising one or more conductive pads configured to electrically contact one or more spring-loaded conductive elements when the movable door or window is in a closed position. The movable door or window has only two active electrical contacts between the one or more conductive pads and the one or more spring-loaded conductive elements.

These and other features and advantages will be described in further detail below, with reference to the associated drawings.

### BRIEF DESCRIPTION OF THE DRAWINGS

FIG. 1 shows an example of a voltage profile for driving optical state transitions for an electrochromic device.

FIG. 2 is a cross-sectional schematic of an electrochromic device.

FIG. 3 shows examples of the operations for fabricating an IGU including an electrochromic pane and incorporating the IGU into a frame.

FIG. 4 shows an example of a manner in which an IGU including an electrochromic pane may be transported during fabrication and/or testing of the IGU.

FIG. 5A is a schematic diagram of an IGU including an electrochromic pane and an associated wire assembly.

FIG. 5B shows an example of the manner in which an IGU including an electrochromic pane may be transported during fabrication and/or testing of the IGU.

FIG. 5C depicts a first connector and second connector, each having two ferromagnetic elements.

FIG. 5D depicts an IGU with two or more redundant connectors embedded in the secondary seal.

FIG. 6 shows examples of schematic diagrams of an IGU including an electrochromic pane in a frame with a floating connector installed in the frame.

FIG. 7 shows examples of schematic diagrams of a window unit incorporating an IGU including an electrochromic pane with detail of a connection configuration for powering the IGU.

FIG. 8 shows examples of schematic diagrams of a window unit incorporating IGUs including electrochromic panes with detail of a connection configuration for powering the IGUs.

FIGS. 9A-9D show examples of schematic diagrams of IGUs and window units with ribbon cable connector embodiments as described herein.

FIG. 9E shows an example of a schematic diagram of a sliding door with a ribbon cable connector system.

FIG. 9F shows an example of a schematic diagram of a sliding door with another ribbon cable connector system.

FIGS. 9G and 9H depict perspective views of a power/communications cable management system for movable doors or windows.

FIGS. 10A and 10B include schematic diagrams of an IGU with a frame that may serve as both as a secondary sealing element and an electrical connector for an electrochromic pane of the IGU.

FIGS. 11A-E depict aspects of IGU wiring schemes.

FIGS. 12A-D depict aspects of pre-wired spacers.

FIGS. 13A and 13B depict aspects of a pre-wired spacer.

FIGS. 14A and 14B depict aspects of another pre-wired spacer.

FIG. 15 is a cross-sectional perspective of a pre-wired spacer including electrical connection about the perimeter of the spacer and through-spacer wiring.

FIG. 16A is a cross-sectional perspective of another pre-wired spacer including electrical connection about the perimeter of the spacer and through-spacer wiring.

FIGS. 16B-C show aspects of a particular embodiment in accord with the pre-wired spacer described in relation to FIG. 16A.

FIG. 16D shows alternative piercing-type pin connectors in accord with the embodiments described in relation to FIGS. 16A-C.

FIG. 17A depicts an electrical connection system where ribbon cable is used in the secondary seal in conjunction with piercing-type connectors as described herein.

FIG. 17B depicts an electrical connection system where ribbon cable is used in the secondary seal, and pin and socket connectors are configured in the secondary seal as well.

FIG. 18A depicts an electrochromic window controller having piercing-type pin connectors as described herein.

FIG. 18B depicts a close up perspective of a controller as described in relation to FIG. 18A.

FIG. 19A depicts components of a sliding door assembly including a fixed door and four movable doors in a stackable configuration, according to an implementation.

FIG. 19B depicts a cross-sectional view of the sliding door assembly of FIG. 19A at five different positions, according to an implementation.

FIG. 19C depicts a cross-sectional view of a portion of the sliding door assembly of FIG. 19A showing details of a first frame guide, according to an implementation.

FIG. 19D depicts a cross-sectional view of another portion of the sliding door assembly of FIG. 19A showing details of a second frame guide, according to an implementation.

FIG. 19E depicts a cross-sectional view of another example of a sliding door assembly having frame guides with four lengthwise slots, according to an implementation.

FIG. 19F depicts a cross-sectional view of another example of a sliding door assembly having frame guides with five lengthwise slots, according to an implementation.

FIG. 20A depicts a sliding door assembly with controllers housed in shuttles, according to an implementation.

FIG. 20B depicts a sliding door assembly with controllers housed in shuttles, according to an implementation.

FIG. 21 is a schematic drawing depicting a system including plurality of four detachable sliding doors, according to an implementation.

FIG. 22 is a drawing of an isometric view of an example of a magnetic power transfer component, according to an implementation.

FIG. 23A is a drawing of a cross-sectional view of an example of a magnetic power transfer component in the disconnected state, according to an implementation.

FIG. 23B is a drawing of a cross-sectional view of the magnetic power transfer component in FIG. 23A in the connected state, according to an implementation.

FIG. 24 is a drawing of a cross-sectional view of an example of a magnetic power transfer component, according to an implementation.

FIG. 25 is a drawing of an isometric view of an example of a magnetic power transfer component, according to an implementation.

FIG. 26A is a photograph of an example of a magnetic power transfer component, according to an implementation.

FIG. 26B is a photograph of the magnetic power transfer component of FIG. 26A in a disconnected state, according to an implementation.

FIG. 26C is a photograph of the magnetic power transfer component of FIG. 26A in a connected state, according to an implementation.

FIG. 27 is a schematic drawing of a network of electrochromic windows and electrochromic window controllers with a trunk line, according to an implementation.

FIG. 28 is a schematic drawing of a trunk line system, according to an implementation.

FIG. 29 is a schematic drawing of an example of a trunk line system, according to an implementation.

FIG. 30 is a schematic drawing of another example of a trunk line system, according to an implementation.

FIG. 31 is a schematic drawing depicting a cross-sectional view of a window assembly including components of an example of a detachable power transfer (DPT) connector, according to certain embodiments.

FIG. 32 is a schematic drawing depicting a cross-sectional view of a window assembly including components of an example of a detachable power transfer (DPT) connector, according to certain embodiments.

FIG. 33 is a drawing of an exploded view of a frame-side component (e.g., sash-side component) of an example of a DPT connector, according to certain embodiments.

FIG. 34 is a drawing of an exploded view of a door side component associated with the frame-side component (e.g., sash-side component) depicted in FIG. 33, in accordance with certain embodiments.

FIG. 35 is a schematic drawing depicting a cross-sectional view of components of a movable door system including an example of a detachable power transfer (DPT) connector attached to a side frame of a building, according to certain embodiments.

FIG. 36 is a schematic drawing depicting a cross-sectional view of components of a movable door system with an example of frame-side component (also referred to as a sash-side component) of a detachable power transfer (DPT) connector, according to certain embodiments.

FIG. 37A is a schematic drawing depicting a cross-sectional view of components of a detachable power transfer (DPT) connector, according to certain embodiments.

FIG. 37B is a schematic drawing depicting an isometric view of components of the detachable power transfer (DPT) connector in FIG. 37B, according to certain embodiments.

FIG. 38A is a schematic drawing depicting a side view of components of a detachable power transfer (DPT) connector, according to certain embodiments.

FIG. 38B is a schematic drawing depicting an isometric view of components of the detachable power transfer (DPT) connector in FIG. 38B, according to certain embodiments.

FIG. 39A is a schematic drawing depicting an isometric view of components of a detachable power transfer (DPT) connector, according to certain embodiments.

FIG. 39B is a schematic drawing depicting an sectional view of components of the detachable power transfer (DPT) connector in FIG. 39B, according to certain embodiments.

The figures and components therein may not be drawn to scale. Various components of the figures described herein may not be drawn to scale.

### DETAILED DESCRIPTION

Different aspects are described below with reference to the accompanying drawings. The features illustrated in the drawings may not be to scale. In the following description, numerous specific details are set forth in order to provide a thorough understanding of the presented implementations. The disclosed implementations may be practiced without one or more of these specific details. In other instances, well-known operations have not been described in detail to avoid unnecessarily obscuring the disclosed implementations. While the disclosed implementations will be described in conjunction with the specific implementations, it will be understood that it is not intended to limit the disclosed implementations.

It should be understood that while the disclosed embodiments focus on electrochromic (EC) windows (also referred to as smart windows), the concepts disclosed herein may apply to other types of switchable optical devices, including liquid crystal devices, suspended particle devices, and the like. For example, a liquid crystal device or a suspended particle device, instead of an electrochromic device, could be incorporated in any of the disclosed embodiments.

An IGU can include the transparent portion of a “window.” In the following description, an IGU may include two substantially transparent substrates, for example, two panes of glass, where at least one of the substrates includes an electrochromic device disposed thereon, and the substrates have a separator (or “spacer”) disposed between them. One or more of these substrates may itself be a structure having multiple substrates. In certain implementations, an IGU is hermetically sealed, having an interior region that is isolated from the ambient environment. A window assembly may include an IGU, electrical connectors for coupling the one or more electrochromic devices of the IGU to a window controller, and a frame that supports the IGU and related wiring.

In order to orient the reader to embodiments for delivering power to one or more electrochromic devices in an IGU and/or window assembly, an exemplary description of a powering curve for transitioning an electrochromic window is presented.

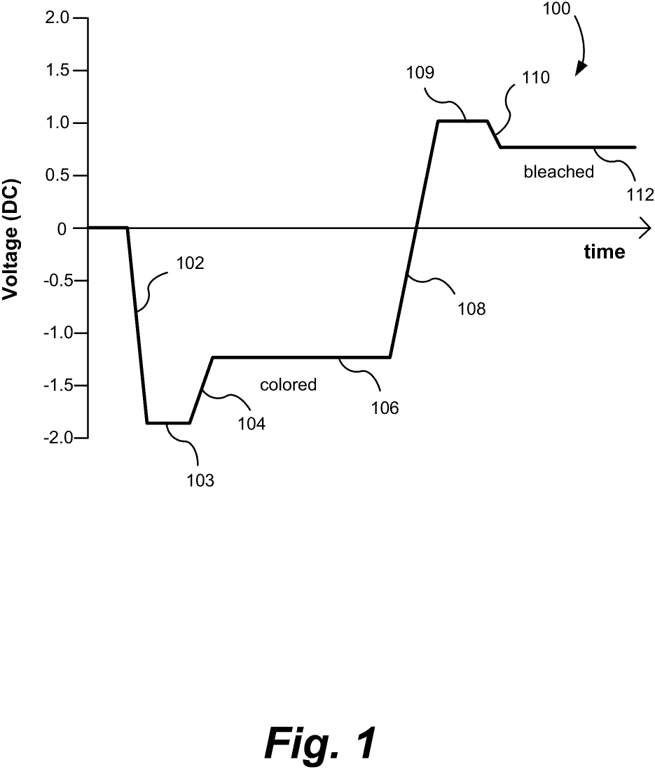

FIG. 1 shows an example of a voltage profile for driving optical state transitions for an electrochromic device. The magnitude of the DC voltages applied to an electrochromic device may depend in part on the thickness of the electrochromic stack of the electrochromic device and the size (e.g., area) of the electrochromic device. A voltage profile, 100, includes the following sequence: a negative ramp, 102, a negative hold, 103, a positive ramp, 104, a negative hold, 106, a positive ramp, 108, a positive hold, 109, a negative ramp, 110, and a positive hold, 112. Note that the voltage remains constant during the length of time that the device remains in its defined optical state, i.e., in negative hold 106 and positive hold 112. Negative ramp 102 drives the device to the colored state and negative hold 106 maintains the device in the colored state for a desired period of time. Negative hold 103 may be for a specified duration of time or until another condition is met, such as a desired amount of charge being passed sufficient to cause the desired change in coloration, for example. Positive ramp 104, which increases the voltage from the maximum in negative voltage ramp 102, may reduce the leakage current when the colored state is held at negative hold 106.

Positive ramp 108 drives the transition of the electrochromic device from the colored to the bleached state. Positive hold 112 maintains the device in the bleached state for a desired period of time. Positive hold 109 may be for a specified duration of time or until another condition is met, such as a desired amount of charge being passed sufficient to cause the desired change in coloration, for example. Negative ramp 110, which decreases the voltage from the maximum in positive ramp 108, may reduce leakage current when the bleached state is held at positive hold 112.

Further details regarding voltage control algorithms used for driving optical state transitions in an electrochromic device may be found in U.S. Pat. Application No. 13/049,623 (now U.S. Pat. No. 8,254,013), titled “CONTROLLING TRANSITIONS IN OPTICALLY SWITCHABLE DEVICES,” filed Mar. 16, 2011, which is hereby incorporated by reference in its entirety.

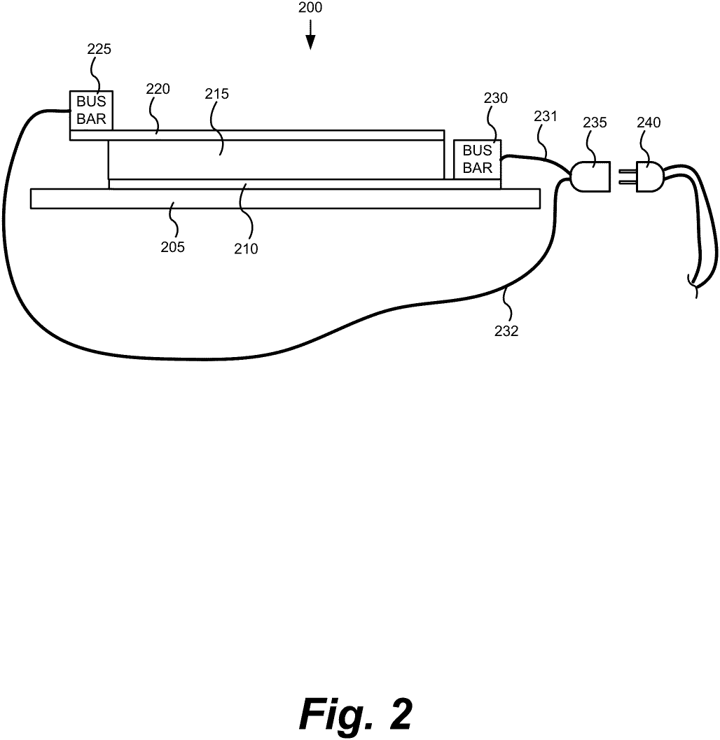

To apply voltage control algorithms, there may be associated wiring and connections to the electrochromic device being powered. FIG. 2 shows an example of a cross-sectional schematic drawing of an electrochromic device, 200. Electrochromic device 200 includes a substrate, 205. The substrate may be transparent and may be made of, for example, glass. A first transparent conducting oxide (TCO) layer, 210, is on substrate 205, with first TCO layer 210 being the first of two conductive layers used to form the electrodes of electrochromic device 200. Electrochromic stack 215 may include (i) an electrochromic (EC) layer, (ii) an ion-conducting (IC) layer, and (iii) a counter electrode (CE) layer to form a stack in which the IC layer separates the EC layer and the CE layer. Electrochromic stack 215 is sandwiched between first TCO layer 210 and a second TCO layer, 220, TCO layer 220 being the second of two conductive layers used to form the electrodes of electrochromic device 200. First TCO layer 210 is in contact with a first bus bar, 230, and second TCO layer 220 is in contact with a second bus bar, 225. Wires, 231 and 232, are connected to bus bars 230 and 225, respectively, and form a wire assembly (not shown) which terminates in a connector, 235. Wires of another connector, 240, may be connected to a controller that is capable of effecting a transition of electrochromic device 200, e.g., from a first optical state to a second optical state. Connectors 235 and 240 may be coupled, such that the controller may drive the optical state transition for electrochromic device 200.

Further details regarding electrochromic devices may be found in U.S. Pat. Application No. 12/645,111, titled “FABRICATION OF LOW DEFECTIVITY ELECTROCHROMIC DEVICES,” filed Dec. 22, 2009. Further details regarding electrochromic devices may also be found in U.S. Pat. Application No. 12/645,159, filed Dec. 22, 2009, U.S. Pat. Application No. 12/772,055 (now U.S. Pat. No. 8,300,298) filed Apr. 30, 2010, U.S. Pat. Application No. 12/814,277 filed Jun. 11, 2010, and U.S. Pat. Application No. 12/814,279 filed Jun. 11, 2010, each titled “ELECTROCHROMIC DEVICES;” each of the aforementioned are hereby incorporated by reference in their entireties.

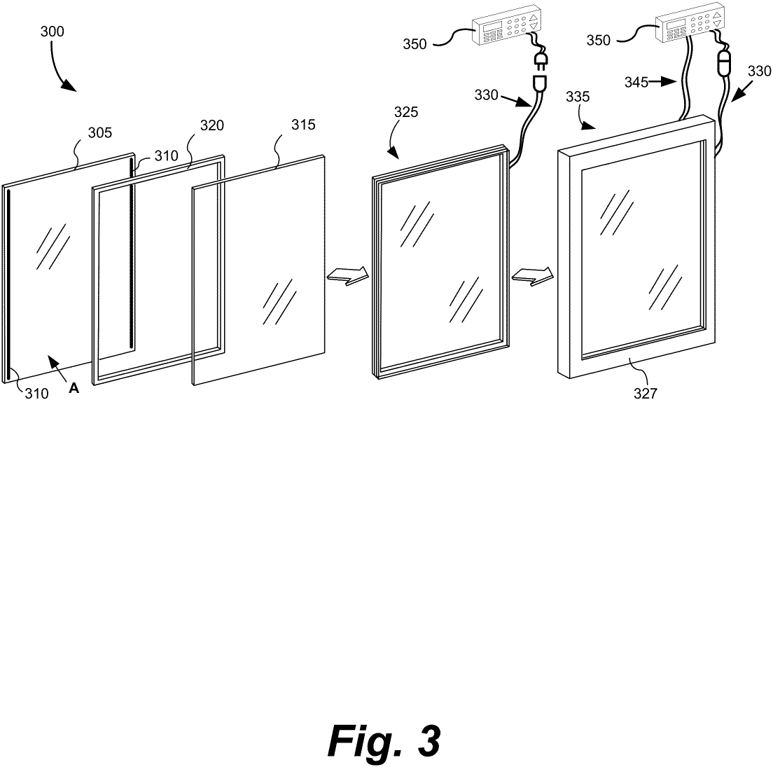

In accordance with voltage algorithms and associated wiring and connections for powering an electrochromic device, there are also aspects of how the wired electrochromic glazing is incorporated into an IGU and how the IGU is incorporated into, e.g., a frame. FIG. 3 shows an example of operations 300 for fabricating an IGU, 325, including an electrochromic pane, 305, and incorporating the IGU 325 into a frame, 327. Electrochromic pane 305 has an electrochromic device (not shown, but for example on surface A) and bus bars, 310, which provide power to the electrochromic device, is matched with another glass pane, 315. The electrochromic pane may include, for example, an electrochromic device similar to the electrochromic device shown in FIG. 2, as described above. In some embodiments, the electrochromic device is solid state and inorganic.

During fabrication of IGU 325, a separator, 320 is sandwiched in between and registered with glass panes 305 and 315. IGU 325 has an associated interior space defined by the faces of the glass panes in contact with separator 320 and the interior surfaces of the separator. Separator 320 may be a sealing separator, that is, the separator may include a spacer and sealing material (primary seal) between the spacer and each glass pane where the glass panes contact the separator. A sealing separator together with the primary seal may seal, e.g., hermetically, the interior volume enclosed by glass panes 305 and 315 and separator 320 and protect the interior volume from moisture and the like. Once glass panes 305 and 315 are coupled to separator 320, a secondary seal may be applied around the perimeter edges of IGU 325 in order to impart further sealing from the ambient environment, as well as further structural rigidity to IGU 325. The secondary seal may be a silicone based sealant, for example.

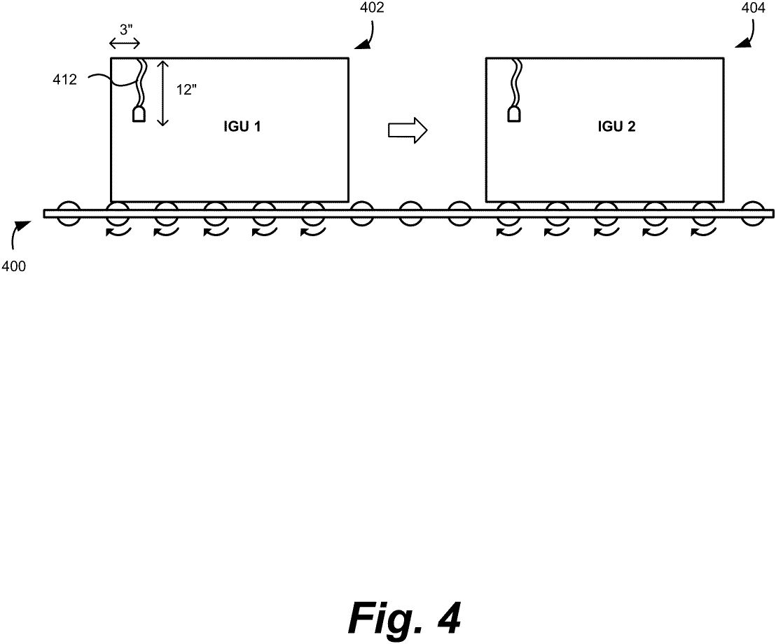

IGU 325 may be wired to a window controller, 350, via a wire assembly, 330. Wire assembly 330 includes wires electrically coupled to bus bars 310 and may include other wires for sensors or for other components of IGU 325. Insulated wires in a wire assembly may be braided and have an insulated cover over all of the wires, such that the multiple wires form a single cord or line. In some cases, the wire assembly may include a “pigtail” connector as described herein. IGU 325 may be mounted in frame 327 to create a window assembly, 335. Window assembly 335 is connected, via wire assembly 330, to window controller, 350. Window controller 350 may also be connected to one or more sensors in frame 327 with one or more communication lines, 345. During fabrication of IGU 325, care must be taken, e.g., due to the fact that glass panes may be fragile but also because wire assembly 330 extends beyond the IGU glass panes and may be damaged. An example of such a scenario is depicted in FIG. 4.

FIG. 4 shows an example of the manner in which an IGU including an electrochromic pane may be transported during the fabrication process for the IGU. As shown in FIG. 4, IGUs, 402 and 404, may be transported and handled on a transport system, 400, in a manner in which an IGU rests on its edge. For example, transport system 400 may include a number of rollers such that IGUs may easily be translated along an assembly or testing line. Handling an IGU in a vertical manner (i.e., with the IGU resting on its edge) may have the advantage of the IGU having a smaller footprint on a manufacturing floor. Each IGU may include a wire assembly, 412, with a connector (e.g., pigtail connector) that provides electrical contact to the bus bars and the electrochromic stack in each IGU. The wire assembly may be about 12 inches long such that the wire does not interfere with transport system 400, e.g., when the IGU vertical dimension as it rests on transport system 400 is about 12 inches or more. The wire assembly also may be offset from an edge of the IGU by about 3 inches, e.g., to ensure that when installed in a frame the wires do not interfere with blocks or other means of securing the IGU in the frame. During transport on transport system 400, the wire assembly, although sized to avoid contact with transport system 400, may catch on other features of a fabrication facility or be inadvertently held while the IGU is still moving along transport system 400. When the wire assembly is permanently attached to the IGU as shown in FIGS. 3 and 4, the wire assembly may be inadvertently detached from the IGU or otherwise damaged. This may include damaging the wiring within the secondary seal of the IGU. When this happens, the entire IGU may need to be replaced. Since typically the electrochromic glazing(s) of the IGU are the most expensive feature, it is unacceptably costly to dispose of the entire IGU as a result of damaging the wiring component of the IGU assembly due to external portions of the wiring. Embodiments described herein avoid such a result.

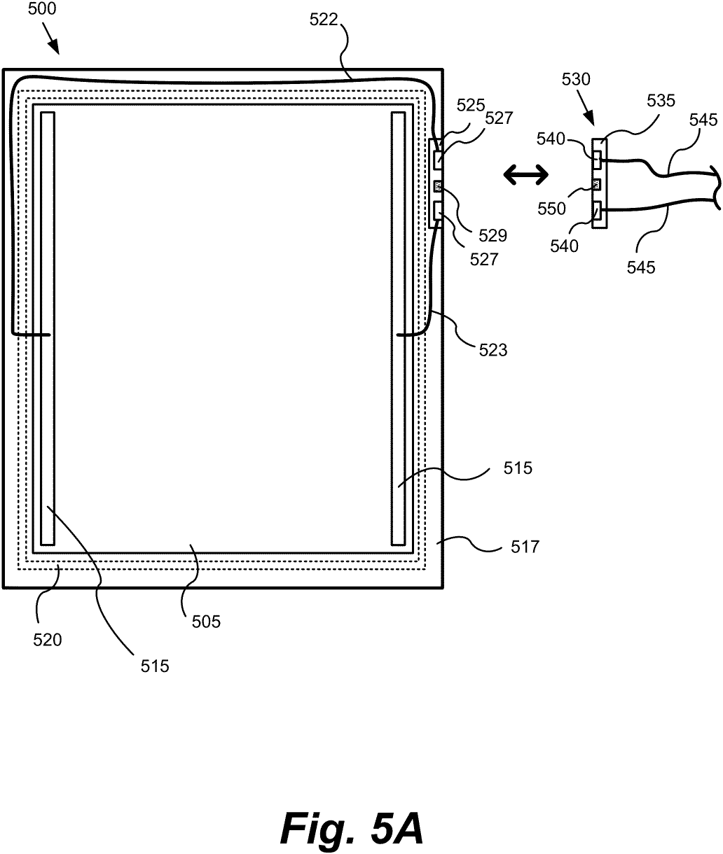

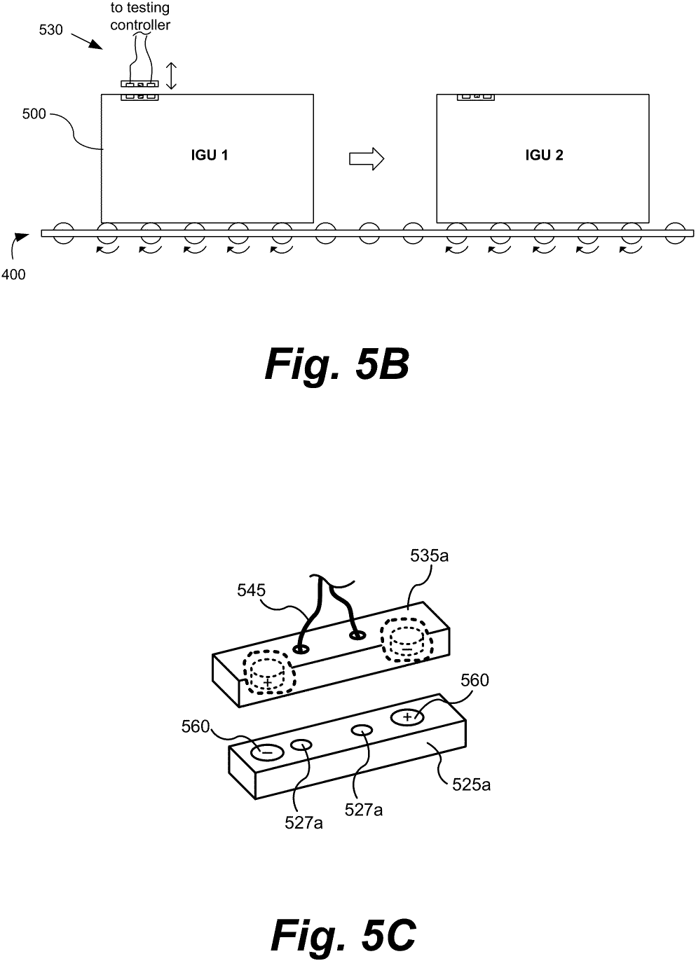

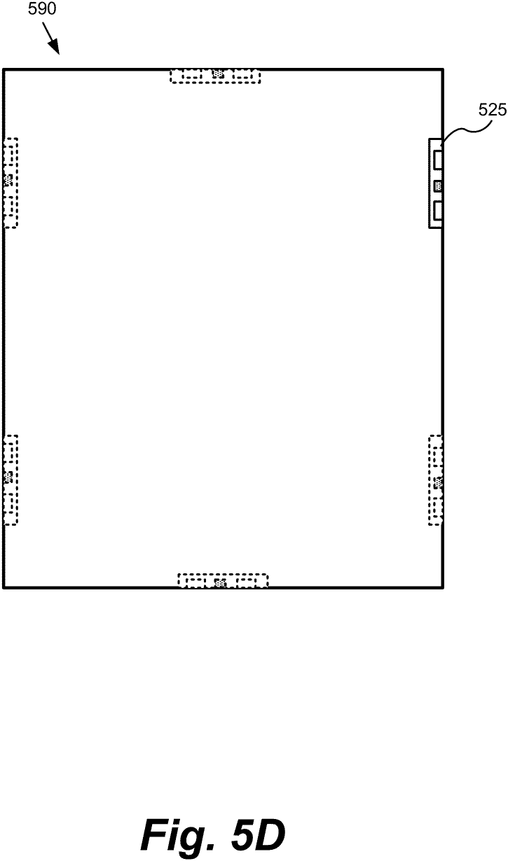

FIG. 5A is a schematic diagram of an IGU, 500, including an electrochromic pane, 505, and an associated wire assembly, 530. IGU 500 includes electrochromic pane 505 which includes bus bars, 515, which are in electrical communication with an electrochromic device, 517 (for an exemplary cross-section see FIG. 2). Electrochromic pane 505 is matched with another pane (not shown) and attached to the other pane with a separator, 520 (indicated by the dotted lines). The area of electrochromic pane 505 outside of separator 520 is a secondary sealing area, while electrochromic device lies within the perimeter of separator 520 (which forms the primary seal against the glass panes of the IGU). In the assembled IGU, the secondary sealing area may be filled with a sealing compound (as described in relation to FIG. 3) to form a secondary seal. Wires, 522 and 523, are connected to bus bars 515 and extend through IGU 500 from bus bars 515, through or under spacer 520, and within the secondary seal to a first connector, 525. Wires 522 and 523 may be positioned such that they do not appear in the viewable region of the panes. For example, the wires may be enclosed in the sealing separator or the secondary seal as depicted. In some embodiments, and as depicted, first connector 525 may be housed substantially within the secondary seal. For example, first connector 525 may be surrounded by the secondary sealant on all sides except for the face of first connector 525 having two pads, 527. The first connector may be housed substantially within the secondary seal in different manners. For example, in some embodiments, the first connector may be housed substantially within the secondary seal and be recessed relative to the edges of the glass panes. In some embodiments, first connector 525 may be housed substantially within the secondary seal and protrude beyond the edges of the glass panes. In other embodiments, first connector 525 may itself form part of the secondary seal, e.g., by sandwiching between the glass panes with sealant disposed between itself and the glass panes.

As noted above, first connector 525 includes two pads 527. The two pads are exposed and provide electrical contact to wires 522 and 523. In this example, first connector 525 further includes a ferromagnetic element, 529. Wire assembly 530 includes a second connector, 535, configured to mate with and provide electrical communication with pads 527. Second connector 535 includes a surface having two pads, 540, that provide electrical contact to wires, 545, of the wire assembly. Second connector 535 further includes a ferromagnetic element, 550, configured to register and mate with ferromagnetic element 529 of the first connector.

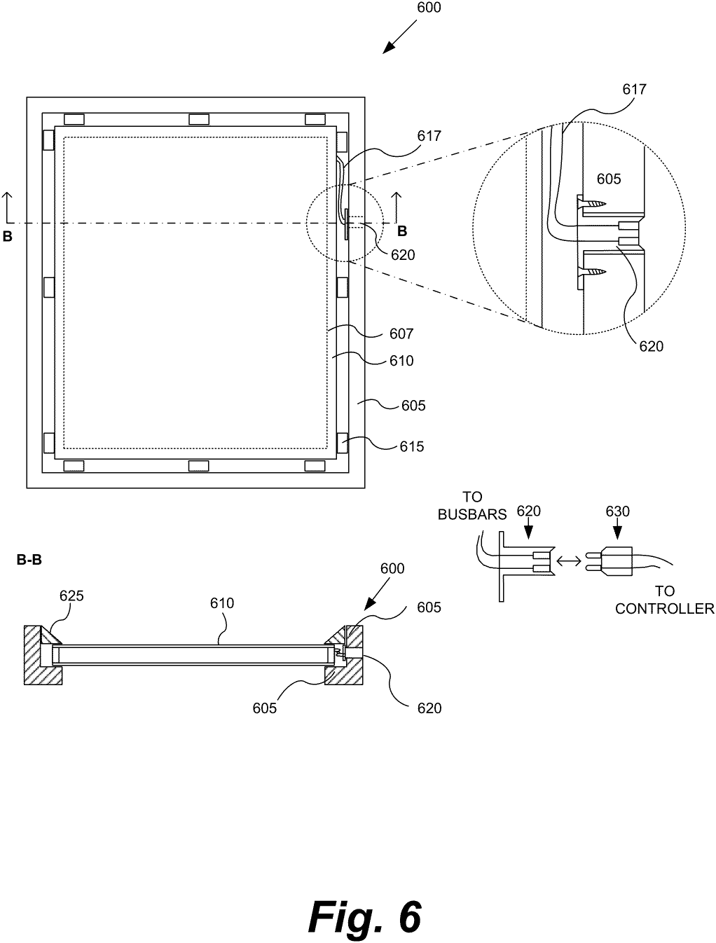

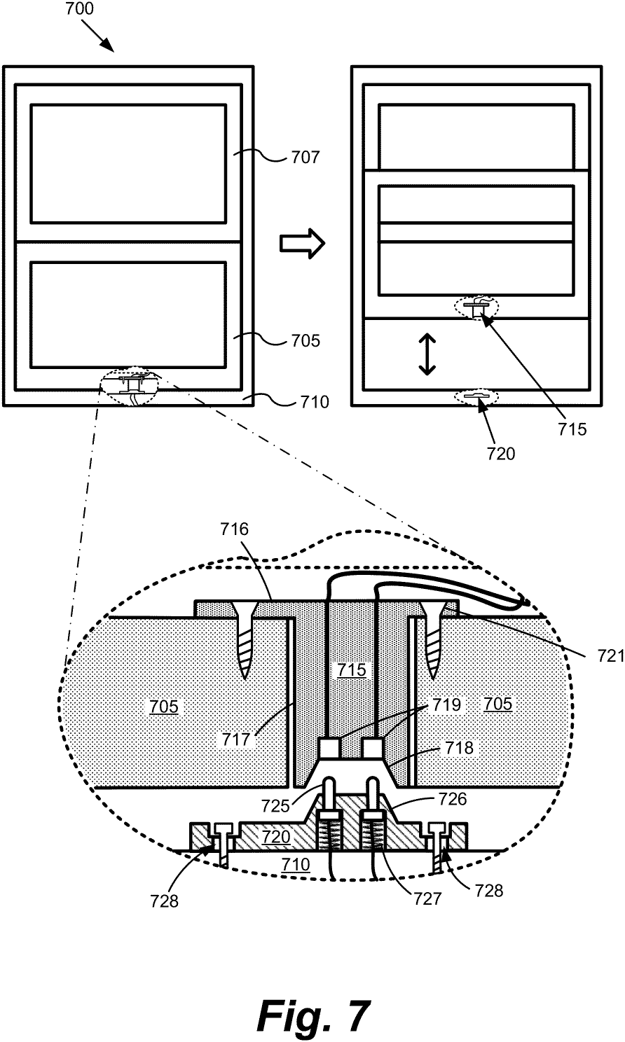

Pads 540 of second connector 535 are configured or shaped for mechanical and electrical contact with pads 527 of first connector 525. Further, at least one of ferromagnetic elements 529 of first connector 525 or 550 of second connector 535, respectively, may be magnetized. With at least one of ferromagnetic elements 529 or 550 being magnetized, first connector 525 and second connector 535 may magnetically engage one another and provide electrical communication between their respective pads. When both ferromagnetic elements are magnetized, their polarity is opposite so as not to repel each other when registered. A distal end (not shown) of the wire assembly 530 may include terminals, sometimes provided in a plug or socket, that allow the wire assembly to be connected to a window controller. In one embodiment, a distal end of wire assembly 530 include a floating connector, e.g., as described in relation to FIGS. 6 and 7.

In one embodiment, rather than a pad to pad contact (e.g., 527 to 540 as in FIG. 5A) for the first and second connectors, a pad to spring-type pin configuration is used. That is, one connector has a pad electrical connection and the other connector has a corresponding spring-type pin, or “pogo pin”; the spring-type pin engages with the pad of the other connector in order to make the electrical connection. In one embodiment, where ferromagnetic elements are also included, the magnetic attraction between the ferromagnetic elements of the first and second connectors is sufficiently strong so as to at least partially compress the spring mechanism of the pogo pin so as to make a good electrical connection when engaged. In one embodiment, the pads and corresponding pogo pins are themselves the ferromagnetic elements.

In some embodiments, first connector 525, second connector 535, or the terminals or connector at the distal end of the wire assembly (e.g., a floating connector) may include a memory device and/or an integrated circuit device. The memory device and/or integrated circuit device may store information for identifying and/or controlling electrochromic pane 505 in IGU 500. For example, the device may contain a voltage and current algorithm or voltage and current operating instructions for transitioning electrochromic pane 505 from a colored stated to a bleached state or vice versa. The algorithm or operating instructions may be specified for the size, shape, and thickness of electrochromic pane 505, for example. As another example, the device may contain information that identifies the shape or size of electrochromic pane 505 to a window controller such that electrochromic pane 505 may operate in an effective manner. As yet another example, the device may contain information specifying a maximum electric signal and a minimum electric signal that may be applied to electrochromic pane 505 by a window controller. Specifying maximum and minimum electric signals that may be applied to the electrochromic pane may help in preventing damage to the electrochromic pane.

In another example, the memory and/or integrated circuit device may contain cycling data for the electrochromic device to which it is connected. In certain embodiments, the memory and/or integrated circuit device includes part of the control circuitry for the one or more electrochromic devices of the IGU. In one embodiment, individually, the memory and/or integrated circuit device may contain information and/or logic to allow identification of the electrochromic device architecture, glazing size, etc., as described above, e.g., during a testing or initial programming phase when in communication with a controller and/or programming device. In one embodiment, collectively, the memory and/or integrated circuit device may include at least part of the controller function of the IGU for an external device intended as a control interface of the installed IGU.

Further, in embodiments in which first connector 525 includes the memory device and/or the integrated circuit device, damage to the electrochromic pane may be prevented because the device is part of IGU 500. Having the maximum and minimum electric signals that may be applied to electrochromic pane 505 stored on a device included in first connector 525 means that this information will remain associated with IGU 500. In one example, a wiring assembly as described herein includes five wires and associated contacts; two of the wires are for delivering power to the electrodes of an electrochromic device, and the remaining three wires are for data communication to the memory and/or integrated circuit device.

Wire assembly 530 described with respect to FIG. 5A may be easily attachable to, and detachable from, IGU 500. Wire assembly 530 also may aid in the fabrication and handling of an IGU because wire assembly 530 is not permanently attached to the IGU and will therefore not interfere with any fabrication processes. This may lower the manufacturing costs for an IGU. Further, as noted above, in some IGUs that include wire assemblies that are permanently attached to the IGU, if the wire assembly becomes damaged and/or separated from the IGU, the IGU may need to be disassembled to reconnect the wire assembly or the IGU may need to be replaced. With a detachable wire assembly, an IGU may be installed and then the wire assembly attached, possibly precluding any damage to the wire assembly. If a wire assembly is damaged, it can also be easily replaced because it is modular.

Additionally, the detachable wire assembly allows for the replacement or the upgrade of the wire assembly during the installed life of the associated IGU. For example, if the wire assembly includes a memory chip and/or a controller chip that becomes obsolete or otherwise needs replacing, a new version of the assembly with a new chip can be installed without interfering with the physical structure of the IGU to which it is to be associated. Further, different buildings may employ different controllers and/or connectors that each require their own special wire assembly connector (each of which, for example, may have a distinct mechanical connector design, electrical requirements, logic characteristics, etc.). Additionally, if a wire assembly wears out or becomes damaged during the installed life of the IGU, the wire assembly can be replaced without replacing the entire IGU.

Another advantage of a detachable wire assembly is shown in FIG. 5B. FIG. 5B is a schematic diagram of an IGU 500 on a transport system 400 and an associated wire assembly. The IGU 500 includes an electrochromic pane and a connector. The transport system 400 may include a number of rollers such that IGU 500 may easily be moved, as described above. The portion of transport system 400 shown in FIG. 5B may reside in a testing region of the manufacturing floor, for example, after the IGU is fabricated. With IGU 500 including a connector and a wire assembly 530 with a connector capable of being magnetically coupled to one another as described in FIG. 5A, IGU 500 may be easily tested. For example, testing of the IGU may be performed automatically by dropping wire assembly 530 including a connector that includes a ferromagnetic element on to an edge of the IGU. The connector of the wire assembly may connect with the connector of the IGU, with little or no physical alignment needed, e.g., due to arrangement of one or more ferromagnetic elements in the mating connectors. For example, the testing connector end may simply be dangled near the IGU; the registration and connection between the connectors being accomplished by magnetic attraction and alignment making it “snap” into place automatically. The IGU may then be tested, for example, by a testing controller coupled to the other end of the wire assembly 530. Testing may include, for example, activating the electrochromic pane and assessing the electrochromic pane for possible defects. The wire assembly may then be removed from the IGU by a force sufficient to overcome the magnetic attraction between the two connectors. In certain embodiments, the external connector may require appropriate flexible supports to prevent the wiring to the external connector from experiencing the stress of pulling the connectors apart. The wire assembly may then be ready to engage the next IGU moving along the manufacturing line.

In certain embodiments, each of the first and second connectors includes at least two ferromagnetic elements. In a specific embodiment, each of the first and second connectors includes two ferromagnetic elements. A “double” magnetic contact allows for more secure connections. Magnets such as neodymium based magnets, e.g., comprising Nd2Fe14B, are well suited for this purpose because of their relatively strong magnetic fields as compared to their size. As described above, the two ferromagnetic elements may be part of the electrical pads, or not. In one embodiment, the two ferromagnetic elements in each of the first and the second connectors are themselves magnets, where the poles of the magnets of each of the first and second connectors that are proximate when the connectors are registered, are opposite so that the respective magnets in each of the first and second connectors attract each other.

FIG. 5C depicts a first connector (IGU and wiring to the first connector not shown), 525a, having two magnets, 560, one with the positive pole exposed and one with the negative pole exposed. The surfaces of electrical contacts, 527a, are also depicted. A second connector, 535a, has corresponding magnets where the poles facing the exposed poles of magnets 560 are opposite so as to attract magnets 560. Second connector also has wires, 545, that lead to a power source such as a controller (electrical pads on connector 535a are not depicted). Using such a connector configuration assures that the electrical connections (the pads in this example) will align correctly due to the magnetic poles attracting only when the opposite poles are proximate each other. In one embodiment, this arrangement is used where the pad-to-pad or pad-to-pogo-pin electrical connections are so magnetized and poles so configured.

When installing an IGU in some framing systems, e.g., a window unit or curtain wall where multiple IGUs are to be installed in proximity, it is useful to have flexibility in where the electrical connection is made to each IGU. This is especially true since the electrochromic glazing of the IGUs may be placed on the outside of the installation, facing the external environment of the installation. Given this configuration, having the connectors in the same position within the secondary seal of the IGUs of the installation requires much more wiring to the controller. However, for example, if the electrical connectors in the IGUs (as described herein) can be positioned more proximate to each other, then less wiring is needed from the IGU to the framing system in which the IGUs are installed. Thus, in some embodiments, IGU 500 may include more than one first connector 525, that is, redundant connectors are installed. For example, referring to FIG. 5D, an IGU 590 might include not only a first connector 525 at the upper right hand side, but also (as indicated by the dotted line features) another connector at the lower left hand side or at the lower right hand side or the upper left hand side or in the top or bottom portion of the IGU. In this example, the connectors are all within the secondary seal. The exact position on each edge is not critical; the key is having more than one connector that feeds the same electrochromic device so that when installing the IGU, there is flexibility in where to attach the external connector to the IGU. When IGU 590 is mounted in a frame holding 2, 4, 6, or more IGUs similar to IGU 590, for example, having multiple first connectors included within each IGU 590 allows for more convenient routing of the wires (e.g., wires 545 as in FIG. 5A associated with each wire assembly 530) in the frame due to the flexibility of having multiple redundant first connectors to which the second connector may be coupled. In one embodiment, the IGU has two first connectors, in another embodiment three first connectors, in yet another embodiment four first connectors. In certain embodiments there may be five or six first connectors. Although the number of connectors may impact production costs, this factor may be more than compensated for by the higher degree of flexibility in installation, e.g., in an expensive and sophisticated curtain wall installation where volume to accommodate wiring is often limited and installing multiple first connectors during fabrication is relatively easy.

In some embodiments, the IGU, e.g., 500 or 590, may include two electrochromic panes. In these embodiments, the first connector may include four pads (or corresponding pad to pin contacts) to provide contacts to the bus bars of each of the electrochromic panes (i.e., each electrochromic pane would include at least two bus bars). Additional pads for control and communication with the electrochromic device and/or onboard controller may also be included, e.g., four pads for bus bar wiring and three additional pads for communication purposes. Onboard controllers, e.g., where the controller components are integrated within the secondary seal of the IGU, are described in U.S. Pat. 8,213,074, titled “Onboard Controller for Multistate Windows,” which is hereby incorporated by reference in its entirety. Likewise, second connector 535 would include four pads to provide electrical contact to wires of the wire assembly. In other embodiments, each electrochromic pane may have its own first connector, or two or more redundant first connectors. Further description of an IGU that includes two or more electrochromic panes is given in U.S. Pat. Application No. 12/851,514 (now U.S. Pat. No. 8,270,059), titled “MULTI-PANE ELECTROCHROMIC WINDOWS,” filed Aug. 05, 2010, which is hereby incorporated by reference in its entirety.

Certain embodiments include connectors that are external to the IGU and provide electrical communication from a framing structure to the IGU (either directly wired to the IGU or wired to a first and second connector assembly as described above). FIG. 6 shows examples of schematic diagrams of a window assembly, 600, including an IGU, 610, which includes an electrochromic pane. IGU 610 resides in a frame, 605. A connector, 620, is wired to IGU 610, and as installed attached to a frame 605; at least part of connector 620 (the nose, infra) passes through an aperture in frame 605. FIG. 6 includes a top-down schematic diagram (top left, looking at window assembly 600 from a major face, but with some aspects missing so as to show internal detail of the assembly) as well as a cross-section (bottom left) B of window assembly 600. The cross-section B is indicated by cut B on the top-down diagram. Dashed line 607 indicates the front edge of frame 605 (behind the IGU as depicted); the portion of IGU 610 within dashed line 607 corresponds to the viewable area of IGU 610 that one would see when the frame is assembled, i.e., that which would function as the window. Glazing blocks 615 between IGU 610 and frame 605 serve to support IGU 610 within frame 605. Glazing blocks 615 may be compliant to account for differences in the coefficients of thermal expansion between frame 605 and IGU 610. For example, the glazing blocks 615 may be a foam material or a polymeric material. Framing material, 625, holds IGU 610 against frame 605. Note that framing material 625 is not shown in the top-down schematic of window assembly 600. Note also that IGU 610 may be in contact with frame 605 and framing material 625 on each face, respectively, as shown but there may also be some sealant between the glass and the framing material. The cross section shows that this IGU contains two glazings separated by spacers.

IGU 610 includes a wire assembly 617 including at least two wires electrically coupled to the two bus bars (not shown) of an electrochromic device (not shown) on the electrochromic pane of the IGU. Note that wire assembly 617 is not shown in the cross section of window assembly 600. The wires of wire assembly 617 terminate at a floating connector 620 at a distal end of the wire assembly. Floating connector 620 includes two female sockets that are electrically coupled to the wires. Further details regarding embodiments of floating connectors are given below with respect to FIG. 7. A fixed connector, 630, including two male pins may be plugged into floating connector 620. The fixed connector may be fixed to a frame or building in which window assembly 600 is mounted, for example. With fixed connector 630 being electrically coupled to a window controller, the optical state of the electrochromic device of IGU 610 may be changed.

While floating connector 620 and fixed connector 630 as shown in FIG. 6 are pin/socket type connectors, other types of connectors may be used. For example, in some embodiments, a face of the nose of the floating connector may be flat and include magnetic pads presented on the face of the floating connector. Wires of wire assembly 617 may be coupled to these magnetic pads. Fixed connector 630 may also include magnetic pads that are configured or shaped for mechanical and electrical contact with the pads of the floating connector. Alternatively, floating connector 620 and fixed connector 630 may be similar to the connectors described above in relation to FIG. 5A.

Floating connector 620 may be attached to frame 605 with screws, nails, or other devices, or may be a compression fit with no additional affixing members. A nose of the floating connector may be flush with the outer edge of frame 605. The nose of the floating connector may be circular, rectangular, or other shape.

While wire assembly 617 is shown as being directly connected to floating connector 620, other mechanisms may be used to connect wire assembly 617 to floating connector 620. For example, in some embodiments, the connection of wire assembly 617 to floating connector 620 may be made with connectors similar to the connectors described above in relation to FIG. 5A.

Further, similar to the connectors and the wire assembly described in FIG. 5A, floating connector 620, fixed connector 630, or the distal end of the wire assembly, of which the fixed connector 630 is a part, may include a memory device and/or an integrated circuit device. The device may store information for identifying and/or controlling the electrochromic pane in IGU 610, as described above.

In some embodiments, IGU 610 may include two electrochromic panes. In this embodiment, the floating connector may include four female sockets that are electrically coupled to the bus bars of each of the electrochromic panes (i.e., each electrochromic pane would include at least two bus bars). Likewise, fixed connector 630 would include four male pins to be plugged into the floating connector.

FIG. 7 shows examples of schematic diagrams of a window unit, 700, incorporating an IGU including an electrochromic pane. Window unit 700 includes a frame, 710, in which a fixed frame, 707, and a movable frame, 705, are mounted. Fixed frame 707 may be fixedly mounted in frame 710 so that it does not move. Movable frame 705 may be movably mounted in frame 710 so that it may move from a closed position to an open position, for example. In the window industry, the window unit may be referred to as a single hung window, the fixed frame may be referred to as a fixed sash, and the movable frame may be referred to as a movable sash. Movable frame 705 may include an IGU (not shown) including an electrochromic pane (not shown), with connection of the electrochromic pane to a window controller being provided by a floating connector, 715, and a fixed connector, 720. While FIG. 7 shows a window unit including one movable frame with connectors for connecting the electrochromic pane of the movable frame to a window controller, the connectors also may be used with a window unit including two movable frames. Also, one of ordinary skill in the art would appreciate that the described embodiments with one or two movable frames could include horizontally-sliding windows.

When movable frame 705 is in an open position, floating connector 715, affixed to the movable frame 705, may not be in contact with fixed connector 720, which is affixed to the frame 710. Thus, when movable frame 705 is in an open position, the electrochromic pane of the IGU mounted in movable frame 705 may not be able to be controlled by a window controller. When movable frame 705 is in a closed position, however, floating connector 715 makes contact with fixed connector 720. The mating of floating connector 715 and fixed connector 720 provides electrical communication, and thus allows for actuation of the electrochromic pane of the IGU in movable frame 705. For example, the fixed connector may be coupled to a window controller, with the window controller being configured to transition the electrochromic pane of the IGU between a first optical state and a second optical state.

Floating connector 715 and fixed connector 720 are one example of a pair of connectors for electrically coupling an electrochromic pane to a window controller. Other pairs of connectors are possible. Floating connector 715 has a flange, 716, and a nose, 717, extending from the flange. Nose 717 may have a length about equal to a thickness of movable frame 705. Nose 717 includes a terminal face, 718, that includes two exposed female contacts, 719. Floating connector 715 may be affixed to movable frame 715 through mounting holes 721 in the flange 716 using screws, nails, or other attachment devices and/or press fit (i.e., secured by compression only). Because female contacts 719 of floating connector 715 may have opposite polarities, both floating connector 715 and fixed connector 720 may have offset mounting holes and/or be shaped or configured so that they can be installed in only one way, e.g., having an asymmetrical element associated with the shape of the connector and/or a registration notch or pin. That is, for example, one mounting hole 721 in flange 716 may be located closer to nose 717 than another mounting hole 721. With the mounting holes arranged in this offset manner, the exposed contacts may be arranged in a defined orientation when floating connector 715 is affixed to movable frame 705. For example, movable frame 705 may include holes that are drilled or formed in the movable frame when it is made. When installing the IGU in the movable frame, one may mount floating connector 715 in movable frame 705 such that offset holes 721 in flange 716 are arranged to match the holes pre-formed in movable frame 705. This offset arrangement of mounting elements prevents the IGU from being connected to a window controller incorrectly, which may damage the electrochromic pane of the IGU.

Another mechanism instead of, or in addition to, screws or nails may be used to affix floating connector 715 to movable frame 705. For example, in some implementations, nose 717 of floating connector 715 may further include protrusions. Such protrusions may engage with movable frame 705 and hold nose 717 of floating connector 715 when the nose is passed through a hole or an aperture in the movable frame to expose terminal face 718 of nose 717. In some implementations, the protrusions from nose 717 may be incompressible. The incompressible protrusions may engage with and deform the inside of the hole or aperture in movable frame 705 when nose 717 is passed through the hole during installation (e.g., the nose is partially inserted into the hole and then the remainder of the nose tapped in with a rubber mallet). When the incompressible protrusions engage with and deform inside the hole, they may hold floating connecter 715 in movable frame 705. In one example, the protrusions are barbs or similar “one-way” protrusions that are configured to hold the nose in the aperture once inserted therein. In another example, the protrusions, although incompressible and configured to hold the nose in the aperture, allow the nose to be removed with some amount of force that will not damage the connector. In other implementations, the protrusions from nose 717 may be compressible. The compressible protrusions may compressively engage with the inside of a hole or an aperture in movable frame 705 when nose 717 is inserted into the hole. When the compressible protrusions engage with the hole, they may hold floating connecter 715 in movable frame 705.

Fixed connector 720 includes two male contacts 725. When movable frame 705 is in a closed position, male contacts 725 of fixed connector 720 contact the two female contacts 719 of floating connector 715. This allows electrical communication with the electrochromic pane in movable frame 705. Springs 727 or other mechanical devices are used to cause male contacts 725 to extend from the raised surface 726 of fixed connector 720. Springs 727 or other mechanical devices also allow male contacts 725 to recede into raised surface 726 of fixed connector 720 when a force is applied to male contacts 725. Springs 727 in fixed connector 720 may aid in protecting male contacts 725 during use of window unit 700. For example, without springs 727, male contacts 725 may be exposed and otherwise damaged by a user opening and closing the window in some cases. Male contacts 725 are one type of pogo pin electrical contact.

In some embodiments, terminal face 718 of floating connector 715 may include a circumferential rim and an interior recessed region where exposed female contacts 719 are presented. The circumferential rim may have a slope directed inwardly towards the interior recessed region. The inwardly directed slope of the circumferential rim may facilitate mating of raised surface 726 of fixed connector 720 with terminal face 718 of floating connector 715. Raised surface 726 may aid in guiding male contacts 725 of fixed connector 720 to register with female contacts 719 of floating connector 715.

Similar to floating connector 715, fixed connector 720 may be affixed to frame 710 through mounting holes 728 in fixed connector 720 using screws, nails, or other attachment devices. Fixed connector 720 also may have offset mounting holes. That is, for example, one mounting hole, 728, in fixed connector 720 may be located closer to raised surface 726 than another mounting hole, 728. With the mounting holes arranged in this offset manner, male contacts 725 may be arranged in a defined orientation when fixed connector 720 is affixed to frame 710. For example, frame 710 may include holes that are drilled or formed in the frame when it is made. An installer of fixed connector 720 in frame 710 may mount the fixed connector to the frame such that offset holes 728 are arranged to match the holes formed in the frame. This prevents the IGU from being connected to a window controller incorrectly, which may damage the electrochromic pane of the IGU.

In this example, mounting holes 728 in fixed connector 720 also allow for movement of fixed connector 720, that is, fixed connector 720 is movably affixed to frame 710. For example, each of mounting holes 728 includes an open volume around the screw that passes through it. This open volume may be a slot that allows fixed connector 720 to translate orthogonally (in the plane of the page as drawn) to the motion of movable frame 705 in order to align with floating connector 715 when movable frame 715 moves towards a closed position and thereby connectors 715 and 720 “dock” with each other. The slot is sized so that the heads of the attaching screws cannot pass through the slots, thus fixed connector 720 is “slidably” attached to frame 710.

Fixed frame 707 of window unit 700 also may include an IGU (not shown) including an electrochromic pane (not shown). Connectors, such as connectors 715 and 720 described above, may be used to connect the electrochromic pane of fixed frame 707 to a window controller. A fixed connector having springs 727, or other mechanical devices that may protect the male contacts 725, may not need to be used in the connectors for fixed frame 707, however, as fixed frame 707 may remain fixed and not move from an open position to a closed position.

In some embodiments of a fixed connector and a floating connector for a movable frame mounted in a frame, springs or other mechanisms are not used to cause male contacts 725 to extend from raised surface 726 of fixed connector 720. Instead, for example, a magnetic force is used to cause male contacts 725 of fixed connector 720 to couple with female contacts 719 of floating connector 715. The magnetic force may be provided by either or both of female contacts 719 in floating connector 715 and/or male contacts 725 in fixed connector 720 including magnetic elements, for example. The magnetic elements may be neodymium magnets, for example. A magnetic force between male contacts 725 and female contacts 719 causes male contacts 725 to extend from raised surface 726 and couple to female contacts 719 in floating connector 715 when floating connector 715 and fixed connector 720 are in close proximity to one another. When fixed connector 720 and floating connector 715 are a distance apart from one another, a mechanical device may impart a force on male contacts 725 that causes male contacts 725 to recede into the fixed connector 720, for example, springs that cause male contacts 725 to recede into fixed connector 720 when the magnetic force is sufficiently diminished by separation of fixed connector 720 and floating connector 715.

It should be noted that, as described thus far, when movable frame 705 of window unit 700 is closed, electrical contact is made via the contacts as described. In one embodiment, the movable frame containing the IGU and the frame in which the movable frame resides have a wireless power generator and receiver. In this way, the electrochromic pane can be transitioned even if the movable frame is in an open position. It is convenient to have the wireless power generator in the frame and the receiver in the movable frame containing the IGU and the electrochromic pane, but embodiments are not so limited. Wireless powered electrochromic windows are described in U.S. Pat. Application Serial No. 12/971,576, filed Dec. 17, 2010, titled “Wireless Powered Electrochromic Windows,” which is hereby incorporated by reference in its entirety. In one embodiment, the frame contains a radio frequency (RF) generator for transmitting wireless power and the movable frame contains a receiver for transforming the wirelessly transmitted energy into electrical energy to power the electrochromic pane. In another embodiment, one or more wireless power generators are located away from the electrochromic pane while the receiver is in the movable frame. In other embodiments, magnetic induction is used to generate wireless power for the electrochromic pane.

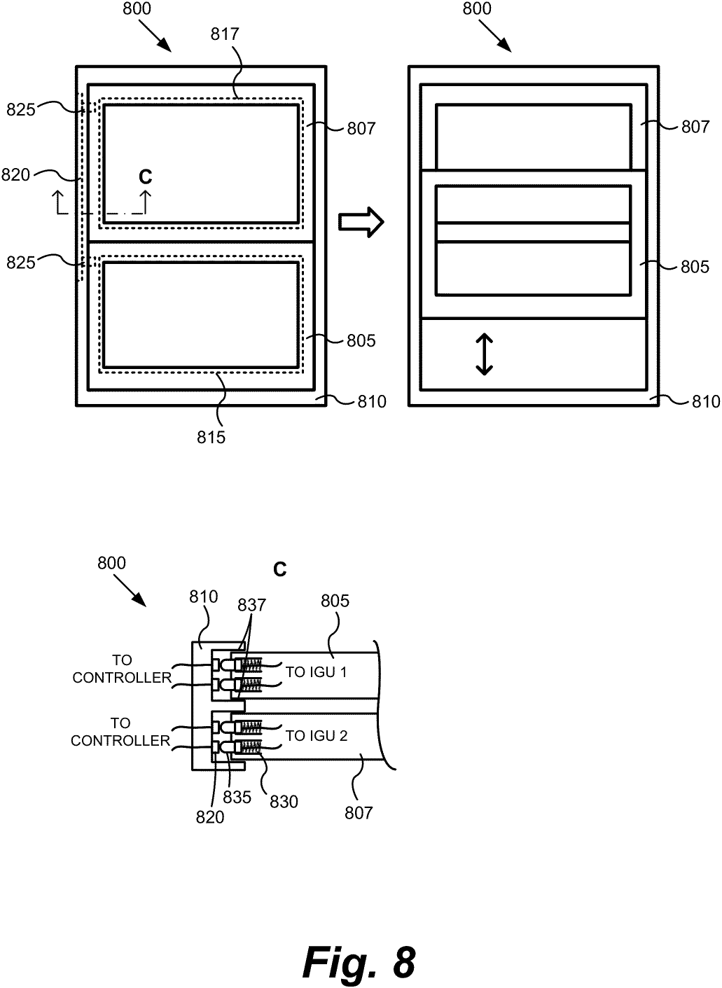

In other embodiments, continuous electrical contact between a frame and a movable frame mounted in the frame is made via connectors with sliding contacts. FIG. 8 includes schematic diagrams of a window unit, 800, which includes IGUs each including an electrochromic pane. FIG. 8 includes front views and a partial cross section of the window unit 800. Cross-section C (lower portion of FIG. 8) is indicated by line C on the front view in the upper left portion of FIG. 8.

Window unit 800 includes a frame, 810, in which a first movable frame, 805, and a second movable frame, 807, are mounted. First movable frame 805 and second movable frame 807 are movably mounted in frame 810 so that they both may move up and down in frame 810. In the window industry, window unit 800 may be referred to as a double hung window and movable frames 805 and 807 may be referred to as movable sashes. First movable frame 805 includes an IGU, 815, including an electrochromic pane (not shown). Second movable frame, 807, includes an IGU 817 including an electrochromic pane (not shown).

To provide electrical connections to the electrochromic panes in each of IGUs 815 and 817, frame 810 includes rails (e.g., two rails for each of movable frames 805 and 807, and additional rails for communication to onboard circuitry if included in the IGU) that are electrically coupled to a window controller when the sashes are installed in frame 810. In this example, each of IGUs 815 and 817 include a floating connector, 825, that electrically connects the bus bars (not shown) of the electrochromic panes to connector pins 835 mounted in movable frames 805 and 807, respectively. Springs 830 or other mechanisms may be associated with connector pins 835 to force connector pins 835 into contact with rails 820 when movable frames 805 and 807 are mounted in frame 810. Note that rails 820 need not, and in this example do not, traverse the entire height of frame 810. This is due to the positioning of connectors 825 mounted in movable frames 805 and 807. By virtue of this placement, electrical connection between pins 835 and rails 820 is maintained throughout the entire slidable range of the movable frames. In some embodiments, rails 820 traverse the entire height of the frame 810, depending on the positioning of connectors 825 in each of the movable frames 805 and 807.

In some embodiments, rails 820 may be a metal. In other embodiments, rails 820 may be carbon or other conductive material, e.g., carbon brushes or woven carbon fibers, e.g., in the form of a compressible tube. In some embodiments, connector pins 835 may be a metal or carbon. Connector pins 835 may also be in the form of brushes. In some embodiments, the interface between rails 820 and connector pins 835 may serve as a weather seal. Further, the motion of movable frames 805 and 807 in frame 810 may serve to clean the surfaces where rails 820 contact connector pins 835 so that electrical contact may be maintained.

Other configurations of rails 820 and connector pins 835 are possible. For example, the rails may be positioned at 837 where a movable frame contacts frame 810. Pins 835 or other conductive surface may be arranged to contact rails 820 positioned at 837.

While FIG. 8 shows a window unit including two movable frames with connectors for connecting the electrochromic panes of the movable frames to a window controller, the connectors also may be used with a window unit including one movable frame or horizontally sliding windows.

In some embodiments of IGU 815 or 817, the IGU may include two electrochromic panes. In this embodiment, to provide electrical connections to the electrochromic panes in each of IGUs 815 and 817, frame 810 may include rails (e.g., four rails for each of the moveable frames 805 and 807, as each electrochromic pane would include at least two bus bars). The rails in the frame may be electrically coupled to a window controller. In one embodiment, the four rails for each movable frame are configured as two pairs, each pair on opposite sides of the movable frame so as to avoid contact due to any play the movable frame may have in the frame in which it resides. In another embodiment, the four (or more) rails associated with each IGU are on the same side of the movable frame, substantially parallel but spaced apart sufficiently so as to avoid contact with another rail’s floating connector contacts. Another way to maintain continuous electrical communication between a movable frame mounted in a frame is by direct wiring. Embodiments described herein use flexible wiring, e.g., ribbon cable, to make the electrical connections.

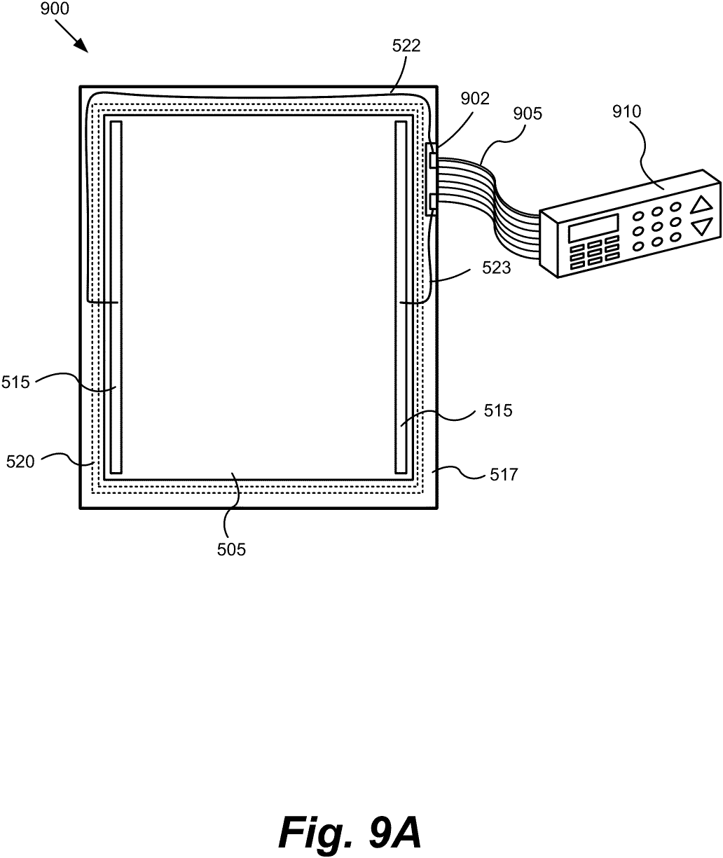

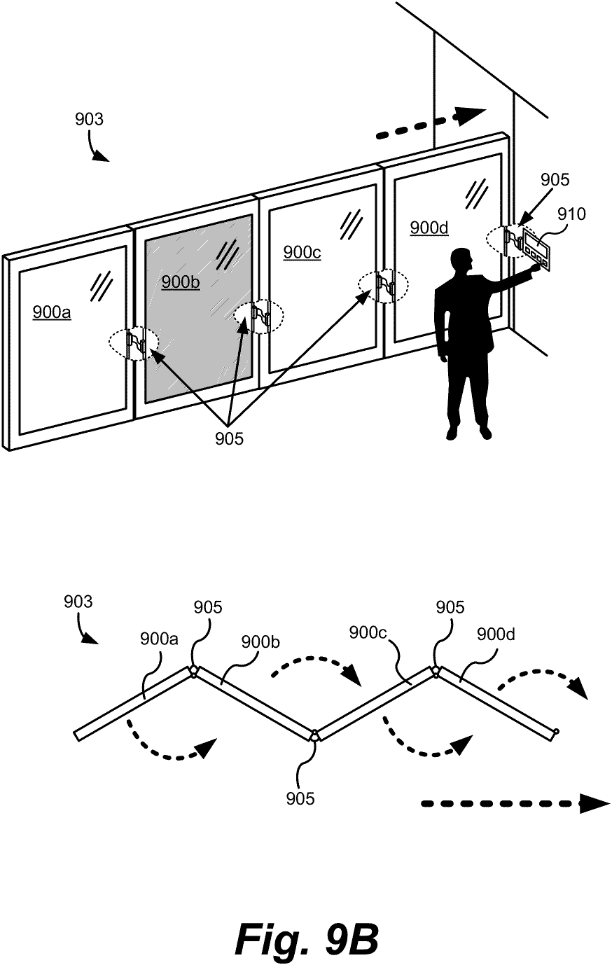

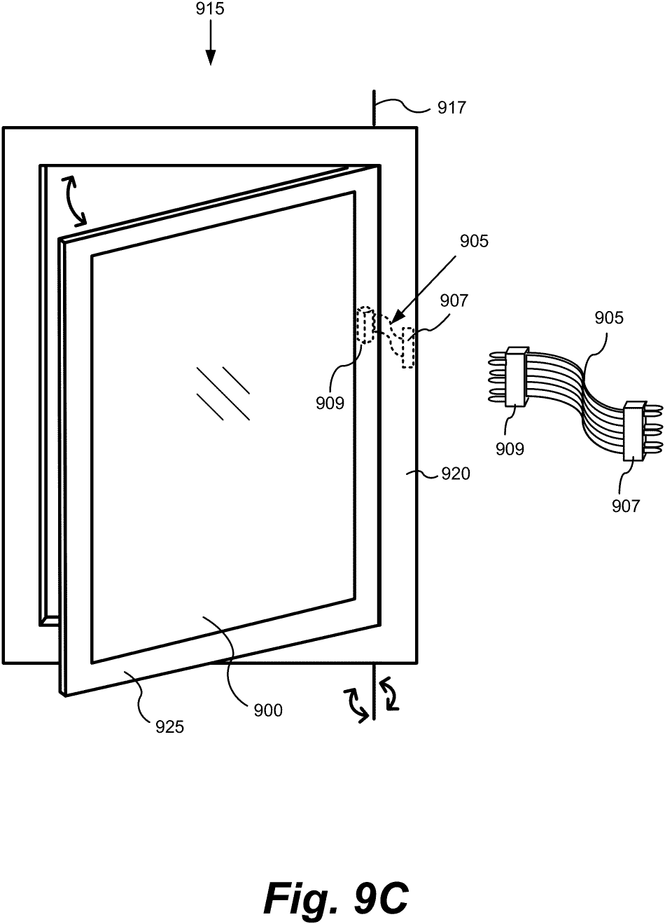

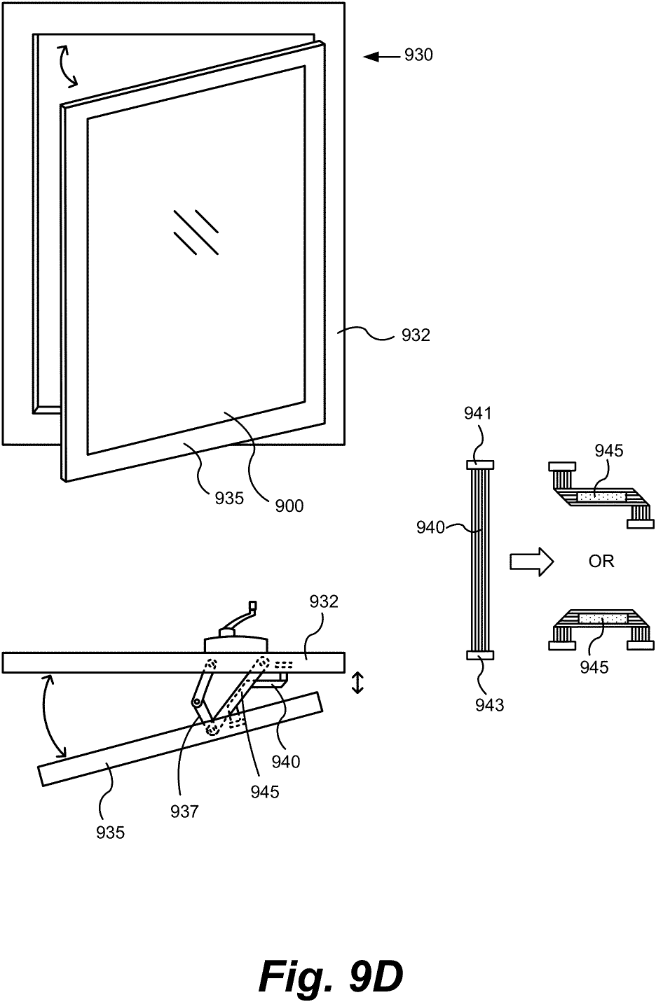

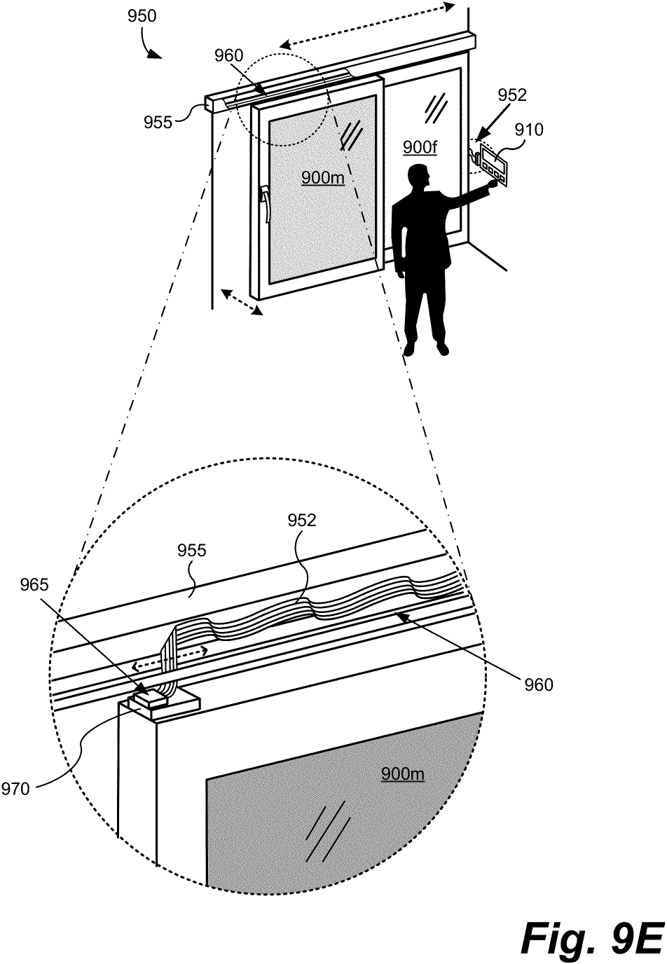

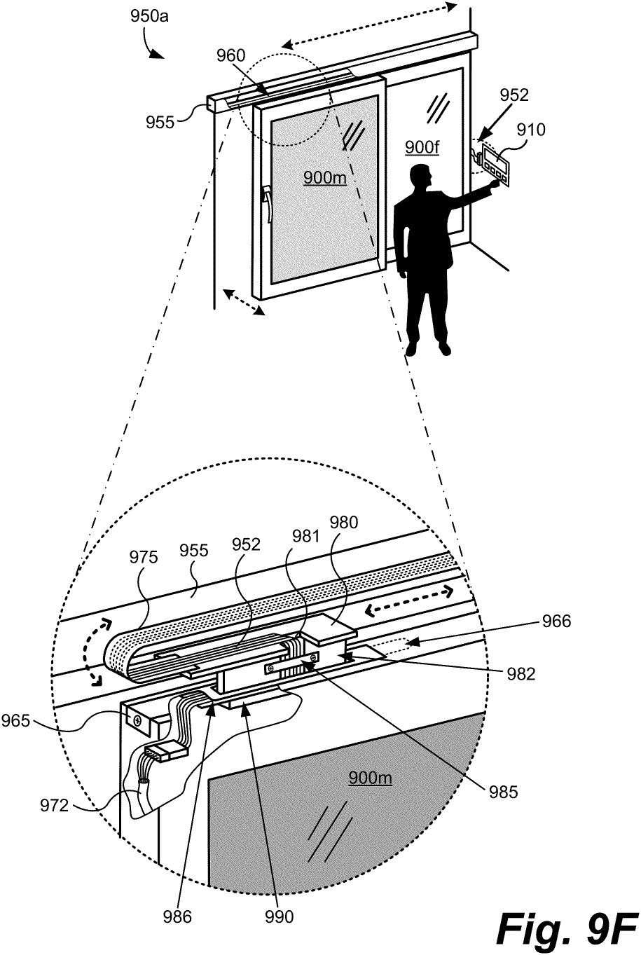

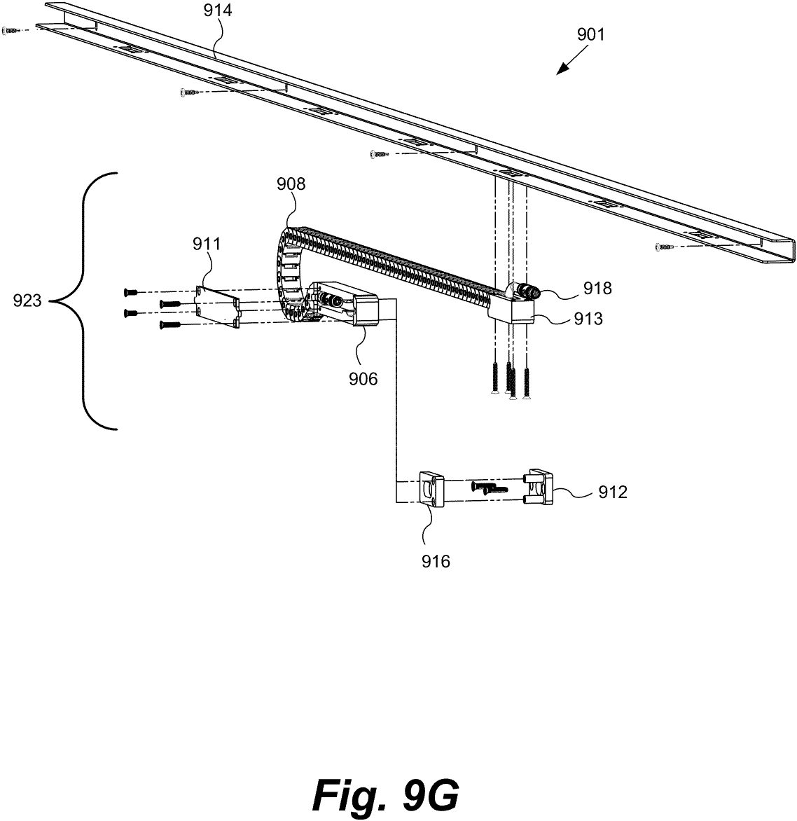

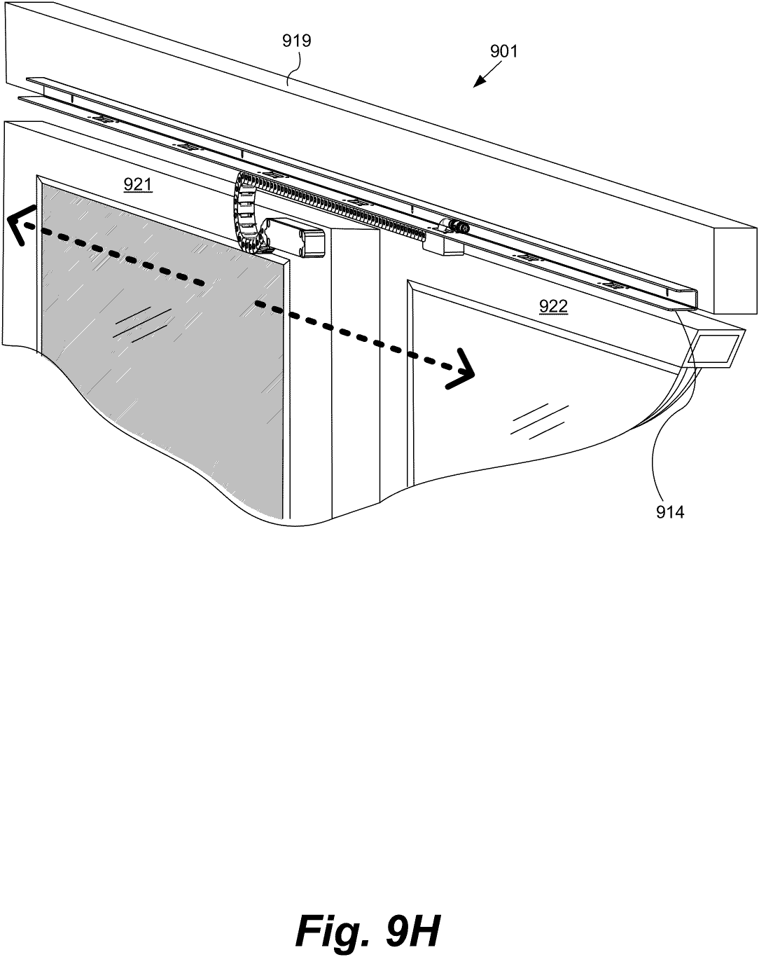

FIG. 9A shows a schematic diagram of an IGU 900 including an electrochromic pane 505 and an associated ribbon cable 905. The IGU 900 includes an electrochromic pane, 505, having bus bars, 515, which are in electrical communication with an electrochromic device, 517 (for an exemplary cross-section see FIG. 2). Electrochromic pane 505 is matched with another pane (not shown) and attached to the other pane with a separator, 520 (indicated by the dotted lines). Outside of separator 520 is a secondary sealing area. Wires 522 and 523 are connected to bus bars 515 and extend through IGU 900 to a connector, 902. Connector 902 is capable of being connected to a ribbon cable, 905. Ribbon cable 905 may be connected to a window controller, 910. In some embodiments, the ribbon cable may be a cable with many conducting wires running parallel to each other on the same plane. The ends of the ribbon cable may include connectors for connecting to connector 902 and to window controller 910.

In some embodiments, connector 902 may be similar to connector 525 (i.e., connector 902 may include one or more ferromagnetic elements) and ribbon cable 905 also may include one or more ferromagnetic elements for engaging connector 902 with ribbon cable 905. Other mechanisms also may be used to engage connector 902 with ribbon cable 905.

In some embodiments, connector 902 may include a memory device and/or an integrated circuit device. Ribbon cable 905 may include more wires or electrically conductive paths than the two paths needed to electrically connect to bus bars 515 of electrochromic pane 505 so that the window controller can communicate with the memory device and/or the integrated circuit device. In some embodiments, the ribbon cable may have electrically conductive paths for controlling more than one electrochromic pane, as described below. Ribbon cables have advantages including the capability of having multiple parallel wires for carrying power, communication signals etc., in a thin, flexible format.

In some embodiments, IGU 900 includes two or more electrochromic panes. Connector 902 may be capable of providing electrical contact to the bus bars of each of the electrochromic panes (i.e., each electrochromic pane would include at least two bus bars). Thus, in the example of an IGU having two electrochromic panes, the ribbon cable may include four conducting wires running parallel to each other on the same plane for powering the electrochromic panes.

As described above, in certain embodiments, an IGU may include more than one connector. In one embodiment, a second connector or further connectors are redundant and serve the same function as the first connector, such as for facilitating installation of the IGU by providing more flexibility in wiring configurations to the IGU. In other embodiments, the second or further connectors are for connecting the IGU to other IGUs in series or in parallel. In one example, the IGUs are linked via connectors and wiring assemblies in order to function, for example, independently, according to the commands of a single controller. The controller may also include capability to control physical movement of one or more of the IGUs via a movement mechanism. The movement mechanism can include, e.g., components to open or close a window which includes an IGU, and/or components for positioning a folding assembly containing two or more IGUs in windows and/or doors. An illustration of this is depicted in FIG. 9B, which shows a system including a plurality of IGUs, in this case four IGUs, 900a-d, incorporated into a folding door system, 903. In this example, system 903 includes four doors, each containing an IGU, 900a-d, respectively. The system could include more or less doors and/or IGUs and may include windows as well as doors. The IGUs of system 903 are each independently controlled by a controller 910, e.g., as indicated in FIG. 9B by IGU 900b being in a colored state while IGUs 900a, 900c, and 900d are transitioned to a bleached state.

System 903 may be used, for example, in a large conference room as an optional divider when the room is to be bifurcated into two smaller conference rooms. As indicated in the top view (FIG. 9B, lower schematic) the doors containing IGUs 900a-d are hinged in order to fold in an accordion fashion and also to translate (as indicated by the heavy dashed arrow), e.g., into a recess in a wall for storage. In this example, controller 910 controls not only the independent transitioning of IGUs 900a-d, but also the folding/unfolding of the doors as well as the translation of the doors into the storage position. The mechanism(s) for folding and translating the doors is not depicted in FIG. 9B; however, one of ordinary skill in the art would appreciate that such mechanisms may be commercially available. The mechanisms may include components that require powering via one or more of the doors, and thus the electrical communication in such instances may pass through wiring assemblies, such as ribbon cable assemblies 905 between IGUs 900a-d, but this is not necessary. In some embodiments, a controller controls not only the transition of an electrochromic device (i.e., the electrochromic device associated with an IGU), but also, independently, an associated movement of the IGU via a movement mechanism(s).

Referring back to FIG. 9B, controller 910 can accept input manually as depicted and/or wirelessly (e.g., via a remote control device). Controller 910 is in electrical communication with each of IGUs 900a-d via ribbon cable assemblies, 905. In this example, each of IGUs 900b-900d has two connectors, e.g., IGU 900d is connected both to controller 910 and to IGU 900c via ribbon cables 905 and corresponding connectors in IGU 900d. In turn, each of IGUs 900b and 900c also contain two connectors to which ribbon cables 905 are connected in order to continue the chain of electrical communication. The IGU 900a has at least one connector in order to electrically connect to IGU 900b via ribbon cable 905. The IGU 900a may also have additional connectors, e.g., if it is convenient to produce IGU 900a in the same manner as IGUs 900b-d, but this is optional, as in this example IGU 900a need only have one associated connector.

In this example, independent control of the electrochromic panes in IGUs 900a-d is accomplished by connecting the IGUs to the window controller in series. Each of ribbon cables 905 has an appropriate number of wires and associated contacts to accommodate electrical communication, and thus independent control, from controller 910. In certain embodiments, the ribbon cable may include any number of different wires, depending on the IGUs to be controlled, the window controller specifications, the manner in which the IGUs are coupled and, optionally, sensors and also any associated movement mechanisms that must be controlled via the electrical communication lines through the IGUs. In some embodiments, the ribbon cable may include 4, 8, 18, 24, or even more wires. For example, the ribbon cable may include two wires if a number of IGUs are coupled to one another in series and there are not any sensors associated with the IGUs. As another example, the ribbon cable may include four wires if two IGUs are coupled to one another and both IGUs are directly coupled to a window controller.

FIG. 9C shows an example of a window unit, 915, incorporating an IGU, 900, including an electrochromic pane. Window unit 915 includes a frame, 920, in which a movable frame, 925, which holds an IGU 900, is mounted. Movable frame 925 may be movably mounted in frame 920 so that it may rotate along an axis of rotation, 917, from a closed position to an open position, for example. In the window industry, window unit 915 may be referred to as a casement window and frame 920 may be referred to as a hinged sash. Movable frame 925 may include IGU 900 including an electrochromic pane (not shown), with electrical connection of the electrochromic pane to a window controller being provided through a ribbon cable, 905. Ribbon cable 905 may allow for rotation of movable frame 925 with respect to frame 920. In some cases, the window controller may not only control the optical transitions of IGU 900, but also, optionally, control a movement mechanism for the window to open and close and related intermediate positioning.

In the illustrated example, ribbon cable 905 includes two male connectors, 907 and 909, for coupling IGU 900 in movable frame 925 to a window controller coupled to frame 920. Many other different types of connectors may be used for a ribbon cable, however. For example, in some other embodiments, the ribbon cable may include a male connector and a female connector, two female connectors, and/or a connector including one or more ferromagnetic elements as described herein.

In some embodiments, the ribbon cable may be a commercially available ribbon cable, and in some embodiments, the ribbon cable may be a specially fabricated ribbon cable having specific connectors. The ribbon cable may include any number of different wires, depending on the IGU 900 and the window controller. For example, the ribbon cable may include up to 4, 8, 18, 24, or even more wires. Two wires may be used to connect a window controller to the bus bars of the electrochromic pane, and the further wires may be used to connect the window controller to sensors, for example, associated with the IGU 900. FIG. 9C depicts a rather simple window movement mechanism, i.e., rotating on an axis in order to open and close. There are more complicated movement mechanisms for which controllers described herein may control and for which more sophisticated wiring assemblies are configured. Some of these are further described below.

FIG. 9D shows schematic diagrams of a window unit, 930, incorporating an IGU, 900, including an electrochromic pane (not specifically depicted). Window unit 930 includes a frame, 932, in which a movable frame, 935, is mounted. Movable frame 935 is movably mounted in frame 932 so that it may rotate and translate via a movement mechanism, 937, from a closed position to an open position, for example. Although shown with three arms, mechanism 937 may include any number of arms that allow for this rotation and translation. In this example, movement mechanism 937 is a manually operated mechanism, but in other embodiments, the mechanism is driven electrically and, optionally, the controller that controls the transitions of the electrochromic pane(s) in the IGU 900 also controls movement mechanism 937 for a prescribed rotation and translation.

The electrochromic pane(s) of the IGU 900 is in electrical communication with a window controller through a ribbon cable, 940. By virtue of its configuration, ribbon cable 940 allows for rotation and translation of movable frame 935, with respect to frame 932, without becoming entangled in mechanism 937 and also while being aesthetically unobtrusive (i.e. it is at least partially hidden to the user by mechanism 937). Ribbon cable 940 may include two connectors 941 and 943, similar to ribbon cable 905, for coupling the electrochromic pane in IGU 900 in movable frame 935 to a window controller, e.g., via wiring through frame 932. Again, many different types of connectors may be used for the ribbon cable 940. In some embodiments, ribbon cable 940 may be partially or fully attached to an arm or arms of mechanism 937. Ribbon cable 940 may be attached to an arm of movement mechanism 937 with an adhesive, 945, for example. Other ways of attaching the ribbon cable to a component of mechanism 937 are possible, however, including brackets, clips and Velcro, for example. As shown, ribbon cable 940 may include one or more folds such that it conforms to accommodate the configuration of mechanism 937. For example, ribbon cable 940 may include the folds shown in the two illustrations in FIG. 9D, right-most portion. Ribbon cables are well suited for such applications because they are relatively flat and can be folded without breaking the wires within the ribbon.

In certain embodiments, a ribbon cable similar to the ribbon cable 905 or 940 is used for a window or door unit including a movable frame that translates, which is typically referred to as a “slider” in the window and door industry. In these embodiments, the slider unit (also called a sliding door assembly) may comprise a fixed outer frame and a movable window or door frame sliding coupled within the fixed outer frame. The slider further comprises a fixed window or door frame, which is mounted to the fixed outer frame. The movable frame may include an IGU including a pane with an optical device such as an electrochromic pane. The movable frame may be movably coupled within the fixed outer frame so that it may translate, generally, but not necessarily, in a horizontal translation. For example, a “double hung” window could also be considered a slider in this context, and thus would be configured for vertical translation. A ribbon cable allows for translation of the movable frame with respect to the fixed frame, while maintaining electrical communication between a controller and the optical device in the movable door or window.

FIG. 9E depicts a schematic including an embodiment of a sliding door assembly, 950. Assembly 950 includes a fixed door, 900f, and a movable door, 900m. Movable door 900m is slidably engaged with a guide, 955, e.g., a track in which a skate connected to movable door 900m can move within guide 955. Guide 955 includes a slot, 960, which allows a portion of a ribbon cable 952 (for clarity, the ribbon cable 952 and connector 965 components are shown only in detail in the bottom portion of FIG. 9E) to pass unobstructed during translation of movable door 900m. In this rendering, the front face of guide 955 is depicted as removed to reveal slot 960. In this example, movable door 900m may travel parallel to fixed door 900f, as indicated by the long dotted arrow above doors 900f and 900m. In other embodiments, movable door 900m, with appropriate configurational modifications to guide 955, may also travel orthogonally to a plane parallel to the doors, as indicated by the small dotted arrow near the bottom left corner of movable door 900m in the upper portion of FIG. 9E. For example, like doors common in Europe, the movable door 900m may also translate “in” and “out” orthogonally to the path parallel to the fixed door (or wall), such that the two doors are substantially in the same plane when the slider unit is closed, and parallel and adjacent when the slider unit is open. During this “in” and “out” motion, the face of movable door 900m may be parallel to the fixed door (or wall if there is only one door), or it may be at an angle, where one end, e.g., the top or bottom end, of the door translates in or out but the other end remains substantially in the same position, thus “tilting” doors are contemplated. In some of these embodiments with “in” and “out” motion, guide 955 may also have an additional slot (not depicted), e.g., in the (front) side depicted as open to reveal slot 960, and a portion of the base and top, to allow ribbon cable 952 to disengage with the guide 955 and travel outward with the movable door 900m. In one embodiment, there is also a mechanism to ensure that the movable door 900m can only tilt back along substantially the same path so that the cable must pass back through the additional slot in order to again be positioned within slot 960.

The bottom portion of FIG. 9E shows further detail, including ribbon cable 952 a portion of which passes through slot 960. A major portion of ribbon cable 952 resides inside a recess of the guide 955, which may be, e.g., a rectangular channel, having slot 960 at the base and running the length of the channel. Near the end portion of the ribbon cable 952 that connects to movable door 900m, a fold is made in ribbon cable 952 so that the cable’s flat portion can run parallel to (as indicated by the dotted arrow) and translate through slot 960 when movable door 900m is translated. A connector, 965, at this end of ribbon cable 952, such as, for example, a pin connector (e.g., 5-pin connector) as described herein, engages with a socket, 970, in order to deliver power and communications to the EC device(s) or other optically switchable device(s) in movable door 900m. Appropriate clips, clamps and the like may be used to ensure the fold in ribbon cable 952 remains and that the portion of ribbon cable 952 that traverses slot 960 (from inside guide 955 to outside and under in this case, guide 955) does not rub against the edges of slot 960. Guide 955 may support the weight of movable door 900m via a skate or other mechanism; there may be a mechanism (not shown), e.g., rollers, under movable door 900m, or both. Movable door 900m may be driven by an electric drive, which also may be part of the window control system, 910. In one embodiment, the face of ribbon cable 952 is configured substantially horizontal inside guide 960. In another embodiment, the face of ribbon cable 952 is configured substantially vertical inside guide 960. It has been found that ribbon cable 952, by virtue of is inherently serpentine and flexible nature, remains inside the body of guide 955 and does not pass through slot 960 when oriented vertically. That is, the bottom edge of the major portion of ribbon cable 952 may rest on the base of guide 955 during translation of movable door 900m and not pass through slot 960 because the serpentine nature of the ribbon cable ensures that its bottom edge only crosses slot 960, it does not align parallel with the slot and therefore fall through slot 960. Thus the portion of ribbon cable 952 that passes through slot 960 in order to engage with connector 965 is the only portion that passes through slot 960. Because of this, and the relatively light and robust construction of the ribbon cable, generally very little, if any, wear to the ribbon cable occurs, as a result of using the slider mechanism.

In one embodiment, the ribbon cable exits the guide through one of the ends of the guide. For example, as depicted in FIG. 9E, ribbon cable 952 exits channel 955 at the end distal to movable door 900m, and is configured appropriately in the wall, and connects to controller 910. The other end of ribbon cable 952 bears a connector, similar if not the same as connector 965, in order to connect with controller 910.

FIG. 9F is a schematic drawing depicting an embodiment including a sliding door assembly, 950a, comprising an electrical connection system. Although this example and others are described with reference to a movable door, a movable window may be used. Sliding door assembly 950a comprises a fixed door, 900f, and a movable door, 900m. Movable door 900m is slidably engaged with a guide, 955, e.g., a track in which a shuttle, 980, slidably connected to movable door 900m, can move within guide 955. Guide 955 includes a lengthwise slot, 960, which allows a portion of a ribbon cable 955 (for clarity, the ribbon cable 955 and connector 965 components are shown only in detail in the bottom portion of FIG. 9F) to pass unobstructed during translation of movable door 900m. In the top portion of FIG. 9F, the front face and top of guide 955 are depicted as removed to reveal slot 960. In this example, movable door 900m may travel parallel to fixed door 900f, as indicated by the long dotted arrow above doors 900f and 900m. In other embodiments, movable door 900m, with appropriate configurational modifications to guide 955, may also travel orthogonally to a plane parallel to the doors, as indicated by the small dotted arrow near the bottom left corner of door 900m in the upper portion of FIG. 9F. For example, like doors common in Europe, the movable door 900m may also translate “in” and “out” orthogonally to the path parallel to the fixed door (or wall), such that the two doors are substantially in the same plane when movable door 900m is closed, parallel and adjacent when movable door 900m is open. During this “in” and “out” motion, the face of movable door 900m may be parallel to the fixed door (or wall if there is only one door), or it may be at an angle, where one end, e.g., the top or bottom end, of the door translates in or out but the other end remains substantially in the same position, thus “tilting” doors are contemplated. In some of these embodiments, guide 955 may also have an additional slot (not depicted), e.g., in the (front) side depicted as open to reveal slot 960, and a portion of the base and top, to allow ribbon cable 952, along with shuttle 980, to disengage with the guide 955 and travel outward with the movable door 900m. In one embodiment, there is also a mechanism to ensure that the movable door 900m can only tilt back along substantially the same path so that the cable and shuttle 980 must pass back through the additional slot in order to again be positioned within slot 960 of guide 955. During movement of the sliding door or window, the one or more wires are configured with the other components of the movable door 900m to try to avoid interaction of the one or more wires with the guide and/or with the moving components of the sliding door assembly, 950a. In this case, the interaction being avoided may refer to, for example, the one or more wires contacting and located between two or more moving components, or the one or more wires contacting the guide and/or contacting one or more moving components.

The bottom portion of FIG. 9F shows further detail, including a ribbon cable, 952, a portion of which passes through shuttle 980 in order to deliver power and communications to the EC device(s) or other optically switchable device(s) in movable door 900m. A major portion of ribbon cable 952 resides in a recess inside guide 955. The guide 955 may be, for example, a rectangular channel and the ribbon cable 952 may reside within the recess of the rectangular channel section. The guide 955 comprises a slot 960 at the base and running the length of the channel. In this illustrated example, ribbon cable 952 is electrically connected to a connector cable, 972, which includes a connector for mating with a connector of ribbon cable 952. The connector cable 972 goes to a round cable having five wires that terminates in a 5-pin connector (not shown) for mating with the connector (e.g., a pigtail connector) at an end the IGU wiring to the bus bars of the EC device(s) or to other optically switchable device(s) of the movable door900m. In other embodiments, the connector cable 972 connects directly to ribbon cable 952. Connector cable similar to connector cable 972 may also be used at the other end of ribbon cable 952 after it exits guide 955, and/or may also be used within guide 955 and then exits guide 955.

Referring to the detailed, lower portion of FIG. 9F, only the rear side of slot 960 is depicted so that details of a shuttle, 980, are shown. Near an end portion of the ribbon cable 952 that connects to the movable door 900m, shuttle 980 includes a horizontal top surface onto which a portion of a flexible tape, 975, is affixed. Ribbon cable 952 is affixed to flexible tape 975. Ribbon cable 952 is affixed to the top surface of the portion of the flexible tape 975 that is affixed to the top of shuttle 980. Flexible tape 975 is bent back forming a bend portion, along a curve (indicated by the curved double headed arrow). This bending allows flexible tape 975 and the ribbon cable 952 affixed thereon to pass back over itself and reside substantially parallel to itself and to the top surface of guide 955 where it is affixed, e.g., at the distal end of guide 955. In addition, this bending allows the flexible tape 975 and the ribbon cable 952 affixed thereon to extend inside guide 955 and parallel to the top surface of guide 955. Thus ribbon cable 952 is affixed to the underside of that portion of flexible tape 975 (as indicated by the dotted lines). Ribbon cable 952 extends along the top surface of shuttle 980, and a fold is made in cable 952 so that a portion of the ribbon cable’s flat portion is substantially vertical to pass through a vertical channel 981 in shuttle 980 and through an aperture in a base plate, 965, for shuttle 980. Base plate 965 is affixed to door 900m e.g., via a screw (depicted) and a tab, 966, that inserts into a portion of movable door 900m in order to secure that end of base plate 965. A cover, 985, may be used to secure the vertical portion of ribbon cable 952 that passes through the vertical channel 981 in the body of the shuttle 980. In this illustrated example, a vertical portion of the shuttle body with vertical channel 981 passes through an aperture in base plate 965, so that shuttle 980 can be moved vertically within the aperture for ease in installing the shuttle 980 into slot 960 of guide 955 (e.g., guide 955 is open on the end so that shuttle 980 may be inserted into slot 960 and then an end cap installed on guide 955).

The body of shuttle 980 is configured to couple to movable door 900m and slidably engage with slot 960 in guide 955. A top portion of the body of shuttle 980 prevents shuttle 980 from passing vertically downward through slot 960, and a bottom portion of the body of shuttle 980 prevents shuttle 980 from passing vertically upward through the aperture in base plate 965 affixed to movable door 900m. In this way, shuttle 980 may slidably engage with movable door 900m while movement of the shuttle 980 in the vertical direction may be restricted. The body of the shuttle 980 is also configured to slidably engage within slot 960 to slide in the horizontal direction. That is, while engaged with movable door 900m, the shuttle 990 may slide in the horizontal direction within the slot 960. Shuttle 980 may be constructed of a plastic material so as to slide easily within slot 960, but sturdy enough to support the weight of movable door 900m.

In another embodiment, the sliding door assembly 950a may comprise another shuttle, similar to shuttle 980, at the opposite top end of movable door 900m that also resides in slot 960. This other “dummy” shuttle need not make any contact with the ribbon cable 952, but rather may serve as an additional support for the weight of movable door 900m and as a sliding mechanism for the movable door 900m. In this case, the first shuttle 980 may not need to support the full weight of movable door 900m, or may support little to no weight of movable door 900m.

Referring back to FIG. 9F, after passing through the vertical channel 981 in shuttle 980, ribbon cable 952 is folded back on itself so as pass through a guide slot, 986, on the underside of base plate 965. Ribbon cable 952 may pass through a horizontal channel in the bottom portion of shuttle 980 that prevents shuttle 980 from passing vertically through the aperture in base plate 965. Thus the ribbon cable is protected from interaction between the underside of base plate 965 and shuttle 980. Ribbon cable 952 is also protected by virtue of being affixed to flexible tape 975, which may be, e.g., a curved spring steel tape, similar to those used for tape measures. In other embodiments, the material used for the ribbon cable 952 may be sufficiently rigid, yet flexible, (e.g., similar to a curved spring steel tape) such that flexible tape 975 is not needed. In other embodiments, an energy chain is used to support wiring such as a ribbon cable 952, rather than a flexible tape. In such embodiments, the mechanisms are substantially the same, but ribbon cable 952 may be substituted for standard wires as the energy chain will both protect and support the wire(s) within its body. Energy chains are commercially available, e.g., in plastic form, by Igus, Inc. of Providence Rhode Island. Although flexible tape 975 is used in this example, other flexible members may be used.

In one embodiment, the ribbon cable exits the guide through one of the ends of the guide. For example, as depicted in FIG. 9F, ribbon cable 952 may exit guide 955 at an end distal to movable door 900m, which is configured appropriately in the wall, and ribbon cable 952. The distal end of ribbon cable 952 bears a connector, which may be similar if not the same as connector 965 (shown in FIG. 9E). The connector is used to connect with a controller 910, which is electrically connected to a power source, or to connect directly with a power source.

Certain embodiments pertain to a ribbon cable connection system for a sliding door or window. The ribbon cable connection system comprises a guide, the guide is configured to house a ribbon cable, wherein a first portion of the ribbon cable exits the guide through a slot in the guide. The first portion of the ribbon cable is configured to traverse along and within the slot during translation of a connector when the connector is affixed to the sliding door or window. In one embodiment, the slot is at the base of the guide. In one embodiment, the guide is a rectangular channel. In one embodiment, the guide further includes an aperture at one end for the ribbon cable to exit the guide. In one embodiment, the guide is configured to allow translation of the first portion of ribbon cable both parallel with the length of the guide and also perpendicular to the length of the guide. In one embodiment, the sliding door or window includes a switchable optical device. In one embodiment, the switchable optical device is an EC device. In one embodiment, the sliding door or window includes an alarm system. In some cases, a ribbon cable comprises an over-molded jacket.

Systems and apparatus described herein for sliding door and/or window applications need not be mounted and the movable door/window moved horizontally as, for example, depicted and described in relation to FIGS. 9E-9H. One of ordinary skill in the art would recognize that, e.g., vertically mounted, vertically moved and/or vertically oriented systems and apparatus are also contemplated herein. Also although FIGS. 9B-F describe apparatus that include a ribbon cable, embodiments where a non-ribbon type cable may be used are also contemplated. An example of a cable management system for sliding windows and/or door applications with, e.g., a non-ribbon type cable is described in relation to FIGS. 9G and 9H.

FIGS. 9G and 9H depict drawings of an embodiment including a cable management system, 901. Referring to FIGS. 9G and 9H, cable management system 901 can refer to a sliding IGU cable management system that provides a flexible connection for power and control to a movable door or window. FIG. 9G is an exploded view drawing of cable management system 901. FIG. 9H is a drawing of a perspective view of cable management system 901 attached to a movable (sliding) door, 921. Cable management system 901 is configured to guide movement of and protect an IGU connector cable, 918, as movable door 921 is opened and closed (as indicated by the heavy dashed arrows in FIG. 9H) e.g., past a fixed door 922. This is accomplished, in the embodiment depicted, using a connector cable carrier 923 comprising a base bracket 913, a chain guide 908, a cover plate, 911 and a frame bracket 906. The connector cable carrier 923 is mounted on one end, using frame bracket 906 to the rail or stile of the frame (door or window) of movable door 921, and on the other end, using base bracket 913, to an optional base rail, 914, that may be installed, on a door header, 919, that provides connection to an IGU controller (not shown).

A cover, also not shown, may be installed over the connector cable carrier 923 and base rail 914 to conceal the mechanism to the end user, for aesthetics, and to prevent users from interaction with the system. Although the base rail 914 is optional, it may be desirable to include this feature in the cable management system 901 since it may protect the cable running from the door header 919 into connector cable carrier 923.

In this illustrated example, connector cable carrier 923 includes a chain guide, 908. Chain guide 908 may be made of plastic, for example. Chain guide 908 may connect frame bracket 906 to base bracket 913. Connector cable carrier 923 may include a recess or other feature that can house a portion (e.g., middle portion between two opposing ends) of the IGU connector cable, 918. As movable door 921 translates, chain guide 908 protects IGU connector cable 918 while flexing and allowing free horizontal movement of the movable door 921. The IGU connector cable 918, in this example, is a 5 wire shielded cable, with 5-pin connectors at each end. A portion of IGU connector cable 918 protrudes from base bracket 913 for introduction into base rail 914 via an aperture in base rail 914. Base rail 914 is may be configured with a plurality of such apertures, as depicted in FIGS. 9G-9H, for flexibility in installation applications. Although the IGU connector cable 918 is depicted as a 5 wire shielded cable in the illustrated example, other connector cables, such as a ribbon cable, can be used.

In the illustrated example, the other end of IGU connector cable 918 is nested in a cavity of frame bracket 906. An optional cover plate, 911, may be used to enclose the cavity once the IGU connector cable 918 is connected. Base rail 914 allows a cable from a window controller to run within the base rail 914 and connect to IGU connector cable 918. Although shown as a U-channel section, the base rail 914 could also be a pipe or square channel or an angle stock, for example, where the cable rests on a horizontally configured side of the angle stock.

Although not shown, an IGU pigtail may emanate from an aperture in the door stile and pass through an aperture in mount 912, which is affixed to the door stile. That is, a cable from an IGU controller is run through base rail 914 where it connects with connector cable 918 and the other end of connector cable 918 connects to an IGU pigtail. An optional spacer, 916, may be used between mount 912 and frame bracket 906 if needed. Connector cable carrier 923 allows movement of the movable door 921 while protecting IGU connector cable 918.

In certain embodiments, cable carrier 923 does not include chain guide, 908. In one embodiment, a flexible cable conduit protects the IGU connector cable running between frame bracket 906 and base bracket 913. The flexible cable conduit may or may not be attached to the frame bracket 906 and/or the base bracket 913. In certain embodiments, the connector cable 918 itself is the only component running between frame bracket 906 and base bracket 913. In one embodiment, a ribbon cable with an over-molded jacket is used.

In certain embodiments, an electrical connection system of a sliding door assembly comprises a guide (e.g., 955) and a shuttle (e.g., 980). Although described with respect to a movable door, the electrical connection system can be used with a movable window. The guide comprises a recess within which pass one or more wires for electrical communication between at least a power source and an optically switchable device in the sliding door or window. The guide further comprises a bottom surface and a lengthwise slot in the bottom surface. The shuttle is configured to couple to the movable door or window and slidably engage with the lengthwise slot in the guide, the shuttle further configured to pass the one or more wires from the sliding door or window, through a body of the shuttle into the recess in the guide, wherein during movement of the sliding door or window, the one or more wires are protected from interaction with one or more moving components. In some cases, the electrical connection system further comprises a flexible member (e.g., (e.g., flexible tape 975 or chain guide 908) affixed at one end to the shuttle. In these cases, the one or more wires may be coupled to the flexible member and the flexible member comprises a bend portion allowing the flexible member to pass back over itself and reside substantially parallel to the length of, and inside, the guide. In one case, the one or more wires are a ribbon cable and the flexible member is a spring steel tape. In another case, the flexible member is a chain guide made of a non-electrically conducting material, and the one or more wires reside within the body of the chain guide. In either of these cases, the shuttle may be slidably engaged with the sliding door or window in the vertical direction. For example, a vertical portion of a body of the shuttle may pass through an aperture in the base plate affixed to the sliding door or window. In one case, the guide further comprises an open end so that the shuttle may be inserted into the slot through the open end of the guide during assembly of the electrical connection system.

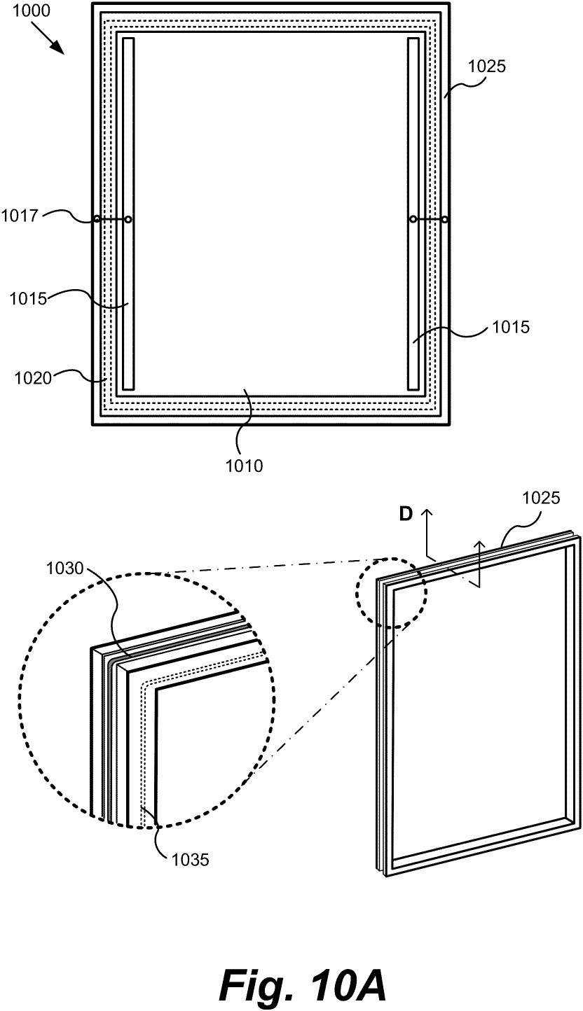

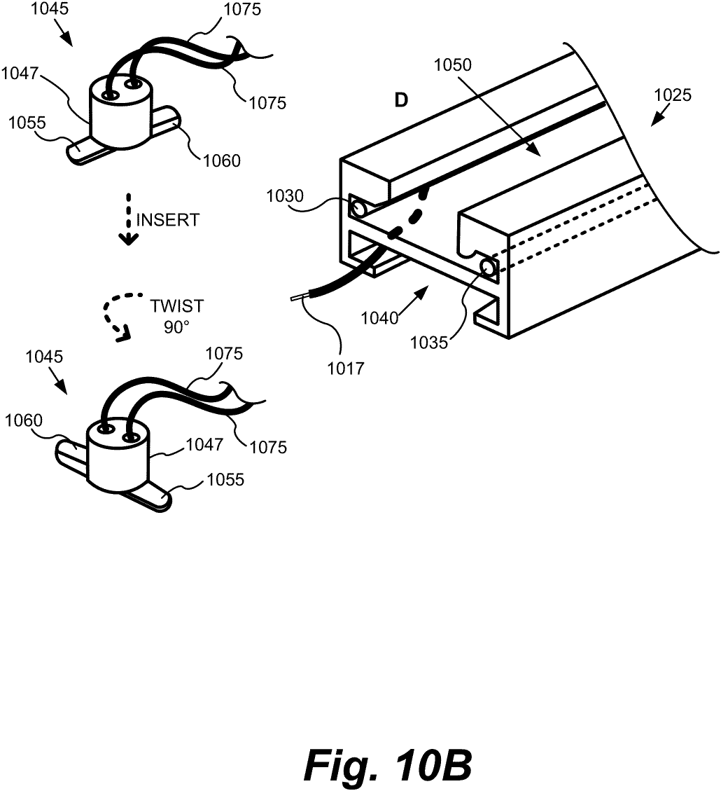

In certain embodiments, an electrical connection system of a sliding door assembly comprises a frame bracket (e.g., 906) and a base bracket (e.g., 913). The frame bracket may be configured to couple to the sliding door or window. The base bracket may be configured to couple to a header of the sliding window or door, or to a base rail. In these embodiments, the frame bracket and base bracket are configured to house opposing ends of an IGU connector cable (e.g., 918). In one embodiment, the IGU connector cable is a ribbon cable. In one example, the ribbon cable may comprise an over-molded jacket. In another embodiment, a middle portion of the IGU connector cable (i.e. a portion between the opposing ends) is housed with a flexible conduit between the frame bracket and the base bracket. In another embodiment, the electrical connection system further comprises a base rail (e.g., 914). In one example, the base rail may comprise a U-channel. In another example, the base rail may comprise comprises one or more apertures, wherein at least one aperture is configured to register with an aperture in the base bracket such that one end of the IGU connector cable passes through the aperture in the base bracket and the at least one aperture of the base rail. In another embodiment, the frame bracket comprises an aperture for receiving an IGU pigtail into a recess of the frame bracket to electrically connect to an end of the IGU connector cable housed within the recess. In one case, the aperture is in outer surface of the frame bracket coupled to a frame of the sliding door or window and/or the frame bracket further comprises a separate mounting element for coupling to a frame of the sliding door or window. In some cases, the IGU connector cable is a 5 wire cable. As described above, where a connector is configured within an IGU may be important when considering where to attach wiring connectors to the IGU. Flexibility in attaching wiring assemblies to an IGU can significantly reduce wiring complexity and length, and thus save considerable time and money, both for fabricators and installers. One embodiment is an electrical connection system including a track, the track including two or more rails that provide electrical communication, via wiring and bus bars, to the electrodes of an electrochromic device of the IGU. The track is, e.g., embedded in the secondary sealing area of the IGU. An associated connector engages the rails and thereby makes electrical connection to the rails. A non-limiting example of the track described above is described in relation to FIGS. 10A and 10B.

FIGS. 10A and 10B depict aspects of an IGU, 1000, including a track, 1025, and an associated connector, 1045. In this example, track 1025 is also a spacer that may serve as both a secondary sealing element and an electrical connector for an electrochromic pane of the IGU, although the sealing function is not necessary. In this description, “track” is used as a short hand to describe a unitary structure, e.g., where a track is formed as part of a frame made of single material having a unitary body, or a “track” is a component of an equivalent structure having a “frame” where the track is a sub-structural component thereof, e.g., made of the same or a different material. In other words a “track” is either a structural feature of a unitary body or frame, or a “track” is a component of a frame. In the context of this description, a frame may or may not serve the function of a spacer or separator for an IGU. For example, track 1025 may reside in the secondary seal region of the IGU and also serve a sealing function as between itself and the glass panels of the IGU, or track 1025 may simply be embedded in the secondary seal without also functioning as a sealing element itself.

FIG. 10A is a schematic diagram of IGU 1000 including an electrochromic pane, 1010. Electrochromic pane 1010 includes bus bars, 1015. Electrochromic pane 1010 is matched with another pane (not shown) and together the panes sandwich a separator, 1020, with a primary seal being formed between separator 1020 and the inside surfaces of the panes along with an adhesive. In this example, track 1025 is used to form a secondary seal, similar to the primary seal formed between the glass panes and separator 1020, with an adhesive between the inner surfaces of the glass panes and track 1025. Thus, in this example, the primary and secondary seals are formed in the same fashion. Track 1025 adds additional rigidity and strength to the IGU structure as well as a sealing function. In certain embodiments, the track is embedded in a secondary sealant without also serving as a sealing element itself; in these embodiments, the track need not traverse the entire perimeter of the IGU.

Track 1025 also includes rails, in this example in the form of wires, 1030 and 1035, which provide electrical communication to bus bars 1015 via wires, 1017. That is, wires 1017 connect bus bars 1015 to wires 1030 and 1035 in track 1025. Track 1025 is described further in relation to FIG. 10B. FIG. 10A, in the bottom portion, shows only track 1025. Included is an expanded view of a corner portion of track 1025, showing detail of a channel in which reside wires 1030 and 1035. In this example, wires 1030 and 1035 run all the way around the channel of track 1025. In other embodiments, wires 1030 and 1035 run only in a portion (e.g., one side, two sides, or three sides) of track 1025. The rails of the track may be other than wires, so long as they are conductive material, although wires are convenient because they are common and easily configured in a track, e.g., track 1025 may be an extruded plastic material into which wires may be molded, or the wires may be inserted into the track after extrusion or molding.

FIG. 10B shows a cross-section D, as indicated in FIG. 10A, of track 1025 showing the details of wires 1030 and 1035 and finer detail of track 1025. Track 1025 may be a non-conducting material, such as an extruded polymer, for example, that holds wires 1030 and 1035 in place. In one example, track 1025 is made of an extruded plastic channeled material. The channeled material is cut and formed, e.g., ultrasonically welded, to form a unitary body as depicted. As shown in FIG. 10B, wires 1030 and 1035 are located within recesses in track 1025 and, in this example, each wire is insulated on three sides (due to the non-conductive nature of the polymeric material which surrounds the wires on three sides). As mentioned, the wires may be inserted into the recesses after the track is fabricated. Track 1025 includes two slots or channels, 1040 and 1050. Slot 1050 allows for electrical connection of an electrical connector, e.g., from a window controller to IGU 1000. Wires 1017 from bus bars 1015 of the electrochromic pane 1010 may be housed in slot 1040. Wires 1017 may pass though the material of track 1025, e.g., passing from slot 1040 through an aperture and into slot 1050, so that the each of the wires 1017 may contact its respective wire 1030 or 1035 (one wire 1017 depicted, aperture through track not shown). In this context, “wires” 1017 may be other means of electrical communication through the track’s body, such as metal bars, tabs, shunts, and the like. The aperture through which wires 1017 pass may be sealed prior to fabrication of the IGU, or during fabrication of the IGU, e.g., using adhesive sealant residing in slot 1040. In one example, a sealant is applied to the gap between the wire and the aperture. When made of polymeric material, wires that lead from the bus bar to the rails of the track may be formed in the molded polymer, so that they are sealed by virtue of being integrated into the polymeric material, e.g., cast into or included in an extrusion process.

Slot 1040 also may allow for additional wires and/or interconnections to be made to the IGU as well as housing electrochromic controller components. In one embodiment, slot 1040 houses electrochromic controller components. In one embodiment, the electrochromic controller components are entirely housed in the track body, whether in slot 1040 or not. In other embodiments, where no track is used, the electrochromic controller is housed in the spacer, at least in part, in some embodiments the electrochromic controller is wholly within the spacer (separator). Controller embodiments with relation to spacers are described in more detail below.

In one example, track 1025 is assembled with wires 1017 being attached to rails 1030 and 1035 prior to being attached to bus bars 1015. That is, one embodiment is a track including rails and wires connected to the rails, the wires passing through the track such that the track, once sandwiched between two panes of glass, optionally with an adhesive sealant, forms a hermetic seal. In one such embodiment, assembly of the IGU includes 1) attaching wires 1017 to the bus bars, and 2) then simultaneously forming the primary and the secondary seal using separator 1020 and track 1025.

Electrical connections may be made to electrochromic pane 1010 with connector 1045. Connector 1045 may include a non-conducting body 1047 with two conducting tabs, 1055 and 1060. In this example, each of the two conducting tabs 1055 and 1060 is connected to a single incoming wire, 1075. Each of the single wires may be coupled to a connector, as described herein, and ultimately connected to a window controller. In this example, to establish electrical connection, connector 1045 is inserted into slot 1050 and then twisted about 90 degrees so that each of the conducting tabs, 1055 and 1060, makes contact with a wire, 1035 and 1030, respectively. In some embodiments, to ensure that a correct wire is in contact with the correct tab, tabs 1055 and 1060 and the recesses housing wires 1030 and 1035 are asymmetrical. As shown in FIG. 10B, tab 1060 is thicker than tab 1055. Further, the recess housing wire 1030 is smaller than the recess housing wire 1035. Connector 1045 enters slot 1050 and then, by virtue of the configuration of the recesses and tabs, the connector can be turned only so that tab 1060 contacts wire 1030 and tab 1055 contacts wire 1035. Varying tab thickness and recess size is one way to help to insure that the connector 1045 is in contact with the correct wires, but other mechanisms to achieve this are also possible.

In another embodiment, track 1025 is metal and the wires and/or rails of the system are insulated. Tabs 1055 and 1060 of connector 1045 are configured to penetrate the insulation on the rails or wires in order to establish electrical connection. Track 1025 may be a hybrid of materials, for example, a metal frame with a polymeric insert for the portion that houses the rails or wires 1030 and 1035. One of ordinary skill in the art would appreciate that the rails must be insulated from the body of the track otherwise a short circuit would occur. There are various configurations in which to achieve this result. In another embodiment, the body of the frame portion is an electrically insulating foam material and the portion which houses the rails is a rigid polymeric material. Spacers and/or frames described herein may also be fabricated from fiber glass.

One embodiment is an electrical connection system for an IGU including an optical device requiring electrical powering, the electrical connection system including: a frame, the frame having a unitary body and including; a track including two or more rails, each of the two or more rails in electrical communication with; a wire configured to pass through the frame for connection to an electrical power distribution component of the optical device; and a connector configured to establish electrical connection to the two or more rails and supply electrical power to each of the two or more rails. In one embodiment, the frame includes an electrically insulating conductive polymeric material. In one embodiment, the track includes an electrically insulating conductive polymeric material and each of said two or more rails comprise copper. The electrical connection system can be configured for use as the only spacer for the IGU (i.e. a structural component that forms the primary seal). In one embodiment, the connector is a twist-type connector that fits into a recess in the track, and upon twisting, engages with the two or more rails in order to establish electrical communication. The optical device may be an electrochromic device. In certain embodiments, the frame comprises at least some of the electrical components of a controller configured to control the optical device. The electrical connection system may be configured as a secondary sealing element in the IGU.

One of ordinary skill in the art would appreciate that other configurations of track 1025 are possible. For example, in one embodiment, track 1025 is a linear track that is inserted along one side of the IGU in the secondary sealing area. Depending upon the need, one, two, three or four such linear tracks, each along an independent side of the IGU, are installed in the IGU. In another embodiment, track 1025 is U-shaped, so that when installed in the secondary sealing area of the IGU, it allows electrical connection via at least three sides of the IGU.

As described above, in certain embodiments, track 1025 can itself serve as the IGU spacer (forming the primary seal), rather than as a complimentary structure to a spacer as described above (serving as a secondary sealing element or not). When used as the only spacer, the frame of the track can be wider than a spacer for an IGU might be. That is, certain IGU spacers are approximately 6 millimeters in width (along the primary sealing surface). The spacers described herein, may be of this width or up to about two times to about two and one half times (about 2× to about 2.5×) that width. For example, spacers described herein may be about 10 millimeters to about 25 millimeters wide, about 10 millimeters to about 15 millimeters wide, and in one embodiment about 10 millimeters to about 12 millimeters wide. This additional width may provide a greater margin of error in a sealing operation as compared to a spacer with approximately 6 millimeters in width . This provides a more robust seal between the spacer and the glass lites of the IGU. In certain embodiments, when wires for the bus bars run through the spacer itself, rather than through the primary seal, this makes for an even more robust primary sealing area.

One embodiment is an electrical connection system for an IGU including an optical device requiring electrical powering. The electrical connection system includes a frame having a unitary body and including a track including two or more rails. Each of the two or more rails is in electrical communication with a wire configured to pass through the frame for connection to an electrical power distribution component of the optical device and with a connector configured to establish electrical connection to the two or more rails and supply electrical power to each of the two or more rails. The electrical power distribution component of the optical device may be a bus bar. In one embodiment, the frame includes an electrically insulating conductive polymeric material. In certain embodiments, the track includes an electrically insulating conductive polymeric material and each of said two or more rails include copper. In one embodiment, the connection system is configured for use as the only spacer for the IGU. In one embodiment, the connector is a twist-type connector that fits into a recess in the track, and upon twisting, engages with the two or more rails in order to establish electrical communication. The optical device may be an electrochromic device, a photovoltaic device, a suspended particle device, a liquid crystal device and the like. In one embodiment, the frame includes at least some of the electrical components of a controller configured to control the optical device. In one embodiment the frame includes an onboard controller, e.g., as described in U.S. Pat. 8,213,074. In certain embodiments, the electrical connection system is configured to be used as a secondary sealing element in the IGU. In one embodiment, the electrical connection system is configured to be used as a primary sealing element of the IGU.

Using track 1025 as a spacer for an IGU is one example of a “pre-wired” spacer embodiment. That is, wires can pass through the body of the spacer itself in order to make contact with bus bars, rather than running between the spacer and the glass, through the primary seal. Moreover the length of the wires can run through the interior of the spacer, rather than around it in the secondary sealing area. These and other embodiments are described in more detail below. Certain embodiments are described in terms of electrochromic devices; however, other optical devices are applicable.

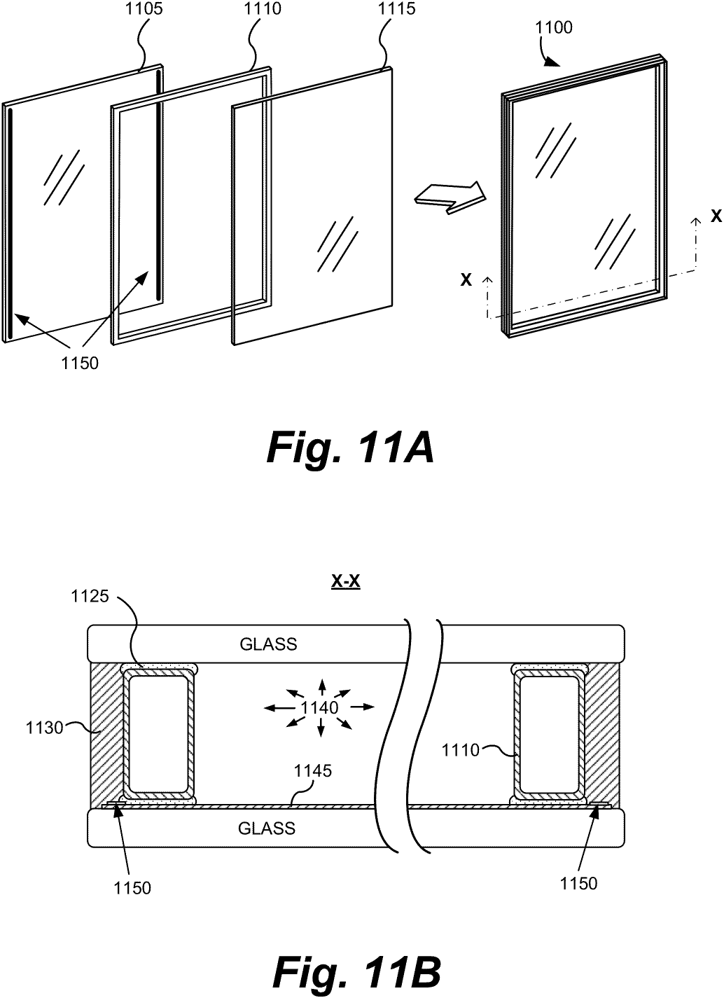

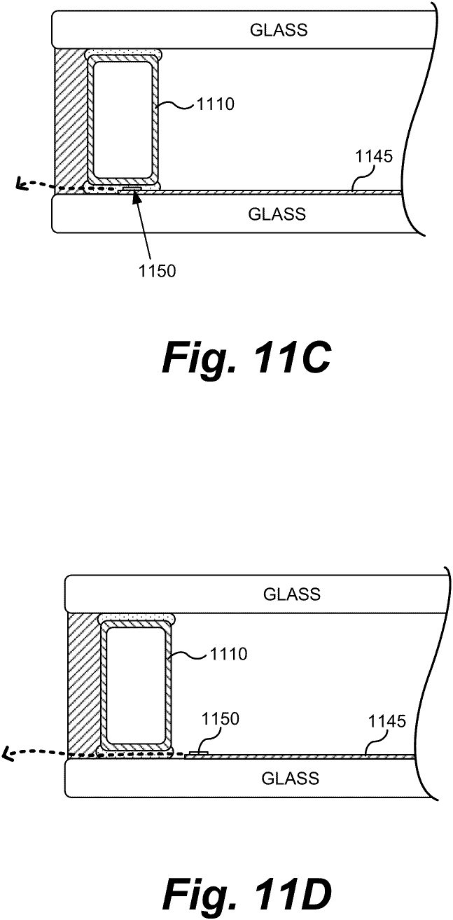

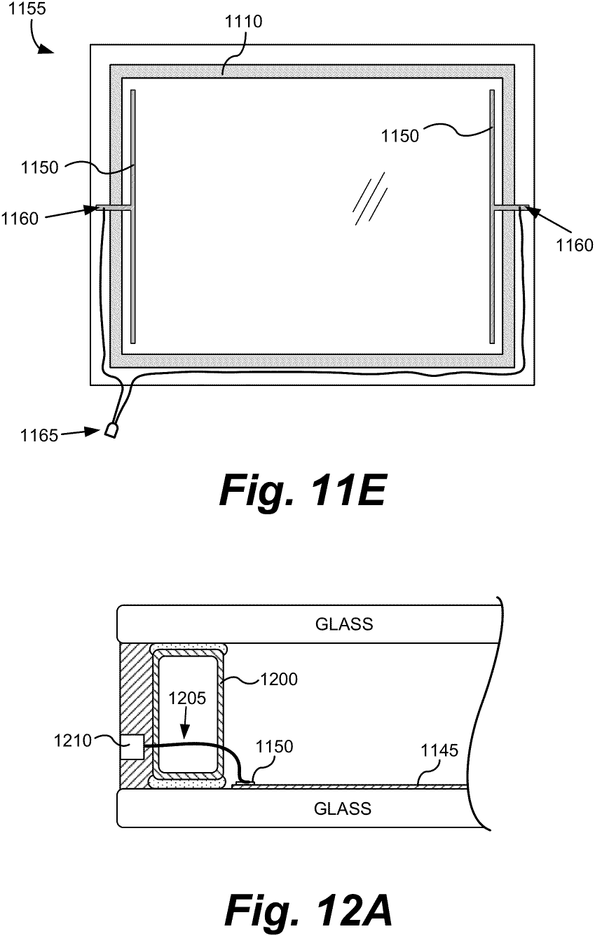

FIGS. 11A-E depict aspects of IGU wiring schemes, where the IGU includes an optical device, such as an electrochromic device. Certain embodiments described herein refer to a single optical device; however, another embodiment is where the IGU includes two or more optical devices. Electrical connection systems described herein include configurations to power one or more optical devices in a single IGU. Referring to FIG. 11A, an IGU, 1100, is constructed by mating an electrochromic lite, 1105, with a spacer, 1110, and a second lite, 1115. In this example, bus bars (an electrical power distribution component of the electrochromic device on lite 1105) 1150 are configured outside spacer 1110 in the final construct. This is described in more detail in relation to FIG. 11B.

FIG. 11B shows cross section X-X of IGU 1100. In this depiction, electrochromic lite 1105 is the lower lite and lite 1115 is the upper lite. Spacer 1110 is mated on opposite sides to the lites with an adhesive sealant, 1125, which defines the primary seal of the IGU, i.e., the top and bottom (as depicted) surfaces of spacer 1110 define the primary sealing area of the spacer. Once mated, there is a volume, 1140, defined within the IGU; this may be filled with an inert gas or evacuated. The spacer may have desiccant inside (not shown). Outside the perimeter of spacer 1110, but may not extend beyond the edges of the glass lites, is a secondary sealant material, 1130, which defines the secondary seal of the IGU. The electrochromic device, 1145, on lite 1105 is a thin film coating, on the order of hundreds of nanometers up to a few microns thick. Bus bars 1150 supply electricity to coating 1145, each to a different transparent conductive layer so as to create a potential across layers of device 1145 and thereby drive the optical transitions. In this example, the bus bars are outside the spacer, in the secondary seal. If all the bus bars are outside the primary seal, then wiring to the bus bars does not involve nor is there a likelihood that, the wiring will interfere with the primary seal of the IGU. Embodiments described herein provide electrical powering systems to deliver electricity to the bus bars when they are either in the primary seal and/or inside the sealed volume 1140 of the IGU. One of ordinary skill in the art would appreciate that an IGU may have one bus bar in the secondary seal and, e.g., a second bus bar in the primary seal or in the sealed volume of the IGU. Embodiments include systems for delivering power to such configurations as well.

FIGS. 11C and 11D show that when the bus bar is within the primary seal, wiring to the bus bar passes through the primary seal. This is depicted by the dotted arrow in the figures. If both lites have optical devices, then the risk of a compromised primary seal is doubled, because either the wiring for each lite passes through the primary seal proximate each lite, or the wiring for both lites must pass through the primary seal proximate a single lite. FIG. 11E shows that, e.g., the conductive ink (e.g., silver-based) used for bus bars can be used as a shunt, 1160, across the primary seal and wiring connected to the shunt. This may help maintain the integrity of the primary seal somewhat, but still there is an increased likelihood of primary seal failure due to this traversal of the primary seal by the ink. That is, the primary seal is optimized for adhesion between the spacer and the material of the lite, e.g., glass. When a different material, such as wire or conductive ink is introduced, there may not be as good a seal. When this different material traverses the primary seal, there is a much greater likelihood that the primary seal will fail at that region. FIG. 11E also shows that it is common for wiring to the bus bars to run outside the spacer and within the secondary seal region to a “pigtail” connector 1165 which is a length of wire with a connector at the end.

Embodiments described herein provide for electrical connection systems for IGUs. Particularly, described embodiments include “pre-wired” spacers, that supply electricity to the bus bars (or equivalent power transfer components) of optical devices, when the bus bars are within the primary seal or within the sealed volume of the IGU. This allows for maintaining the integrity of the primary seal, as well as simplifying fabrication of the IGU. One embodiment is a spacer for an IGU, the spacer configured to supply electricity to an optical device on a lite of the IGU, via one or more electrical power distribution components of the optical device, where at least one of said one or more electrical power distribution components is either within the primary seal or within the sealed interior volume of the IGU, and where the electricity supplied to said at least one of said one or more electrical power distribution components does not traverse the primary seal of the IGU.

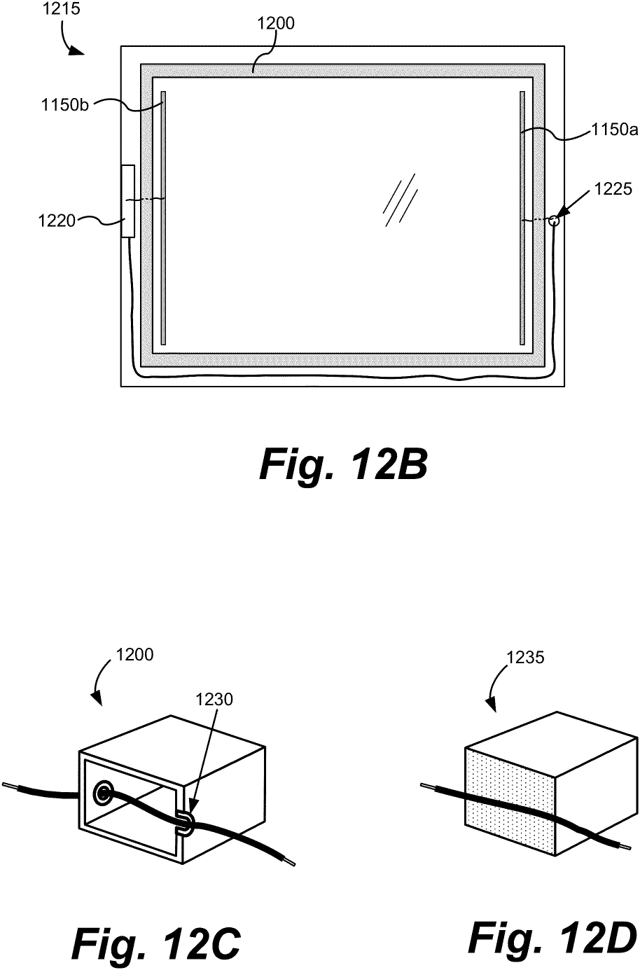

FIG. 12A is a cross-sectional drawing depicting a pre-wired spacer, 1200. Spacer 1200 has a wire, 1205, that passes through it. Wire 1205 delivers electricity from an external component, 1210, which is in the secondary seal (as depicted), outside the secondary seal, or which has portions both inside and outside secondary seal. In this example, 1210 is an electrical socket, into which a plug is configured to enter and thereby supply electricity to wire 1205. Wire 1205 is in electrical communication with bus bar 1150 (e.g., soldered to the bus bar). In one embodiment, external component 1210 is track 1025 as described in relation to FIGS. 10A and 10B, e.g., it surrounds spacer 1200 about some, or all, of the perimeter of spacer 1200. In one embodiment, spacer 1200′s structure is itself analogous to track 1025, that is, it has a track system for establishing electrical communication with the optical device via wire (or wires) 1205. In the latter embodiment, there may be no secondary seal and spacer 1200 may be wider than a spacer of approximately 6 millimeters in width, so that the primary seal is, e.g., double or more of the sealing area of a primary seal with a spacer having with approximately 6 millimeters in width.

FIG. 12B shows spacer 1200 from a top view and incorporated into an IGU 1215. In this example, spacer 1200 has wires that pass through the width of the spacer. One of these wires, attached to bus bar 1150a, is also attached to a connector, 1225, which makes electrical communication with a second wire that spans around the spacer, in the secondary seal region, and to, in this example, an onboard controller, 1220. In some embodiments, connector 1225 is not necessary because a single wire connects to bus bar 1150a, passes through spacer 1200 and connects to controller 1220. Controller 1220 is also in electrical communication with bus bar 1150b via the other wire that passes through the spacer. Pre-wired spacer 1200 has the advantage that during IGU fabrication, it can be laid down and quickly soldered to the bus bars and connector 1225, if present.

FIG. 12C shows a partial cross section of spacer 1200, showing that the spacer may be metal such as stainless steel or aluminum, with a wire passing through it. Seal 1230 ensures that there is no gas leakage from the IGU sealed volume through the aperture through which the wire passes. Seal 1230 may be a rubber grommet of sufficient tightness so as to seal as described or seal 1230 may be a polymeric or epoxy sealant added after the wire is run through the apertures in the spacer. FIG. 12D shows spacer 1235, made of a foam or solid polymeric material. A good hermetic seal is achieved since the wire is cast into the spacer or the foam is blown or formed with the wire in it.

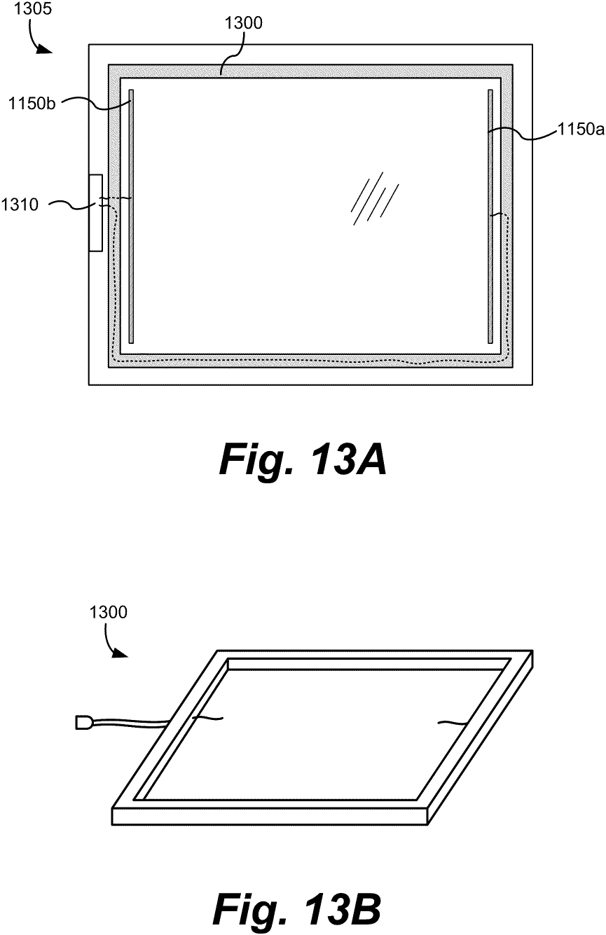

FIG. 13A depicts another IGU, 1305, having a pre-wired spacer 1300. In this example, the wires passing through spacer 1300 are almost entirely contained within the body of the spacer. That is, the wire in electrical communication with bus bar 1150a emanates from spacer 1300 only at its ends, to connect with bus bar 1150a and to connect with external component 1310, respectively. In this example, the other wire that passes through spacer 1300 is shorter and passes more or less directly through spacer 1300 in order to make electrical connection to bus bar 1150b. Also, in this example, component 1310 is a socket. Socket 1310 is configured to accept controller components, or an entire onboard controller. That is, in the latter embodiment, the controller is a “plug in” module. The IGU is constructed as depicted in FIG. 13A with socket 1310 in the secondary seal. The controller (not depicted) is a plug in module that may or may not fit entirely within the secondary seal (not beyond the edges of the IGU). In this manner, IGUs can be constructed independently of onboard controllers, and the onboard controllers can be easily upgraded and/or switched out of the IGU. This may avoid having to replace an IGU that had an onboard controller permanently affixed to the secondary sealing material. FIG. 13B depicts spacer 1300 where a pigtail connector (rather than socket 1310) is used as the common end of the wires that pass through the spacer.

In one embodiment, a pre-wired spacer as described herein may also include a controller for at least one optical device of an IGU. The controller may be exterior to the spacer, for ultimate configuration in the secondary seal or outside the IGU, or the controller may be inside the spacer itself. The spacer may be metal or a polymeric material, foam or solid.

One of ordinary skill in the art would appreciate that spacer 1300, being prewired, makes fabrication of the IGU much simpler. That is, one need only register the lites with the spacer, solder the wires to the bus bars and then seal the IGU. Depending upon which pre-wired spacer is used, one can then add the secondary sealing material, or not.

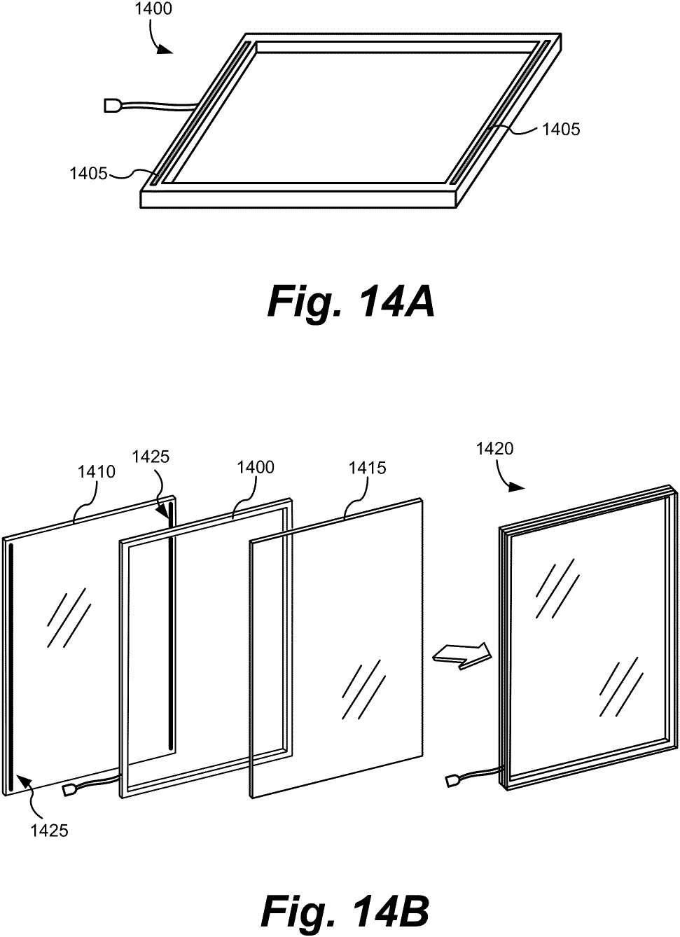

FIG. 14A depicts a pre-wired spacer, 1400. Spacer 1400 has a pigtail connector as described herein, but rather than wires emanating from the interior faces of the spacer, e.g., as spacer 1300 had, spacer 1400 has contact pads, 1405, which are in electrical communication with the wires inside the body of pre-wired spacer 1400. In one embodiment, the pre-wired spacer may be made of an electrically insulating material, such as a polymer, either solid or foam. The contact pads are metal, such as copper, but may include gold, silver or other metal for better electrical contact. Contact pads 1405 may be co-planar with the sealing surface of pre-wired spacer 1400, extend beyond the sealing surface, or be below the sealing surface, depending upon the need. Typically, but not necessarily, the contact pads do not span the width of the sealing surface of the spacer, so that there is at least some of the spacer material, e.g., on either side of the contact pad, to make a good seal with the glass. The contact pads depicted here are singular and have a generally rectangular shape, but this is not necessary. For example, there may be multiple contact pads configured to make contact with a single bus bar, e.g., circular pads arranged linearly along one side of the spacer, and similar configurations of shapes along one side of the spacer.

FIG. 14B depicts fabrication of an IGU with pre-wired spacer 1400. Contact pads 1405 (not depicted, they are on the back side of spacer 1400 as drawn) are registered with bus bars 1425 when the spacer is registered with lites 1410 and 1415. Lite 1410 has an optical device, such as an electrochromic device, on the surface that mates with the sealing surface of spacer 1400. Upon mating the lites with the spacer, electrical communication is established between the contact pads and the bus bars. If adhesive sealant is used to form the IGU, then it is applied in such a way so as not to come between (at least not entirely) the contact pad and the bus bars. In certain embodiments, the contact pads are configured so as to penetrate any sealant that comes between the contact pad and the bus bar. For example, the contact pads may have a rough surface and/or protrusions that make good electrical contact with the bus bars despite adhesive sealant coming between the two surfaces during mating. In other embodiments, the spacer is made of metal, and the contact pads are electrically insulated from the spacer body using an electrically insulating material.

In one embodiment, the pre-wired spacer is titanium and no adhesive is used to form the primary seal. That is, a hermetic seal is formed by fusing the titanium to the glass using high localized heat at the interface of the glass and titanium. In one embodiment, this bonding is achieved with a laser irradiation through the glass lite to which the spacer is to be bonded. In one embodiment, a boron compound is applied to the titanium spacer prior to laser irradiation. Titanium is used for certain hermetic sealing embodiments due to the similar coefficient of expansion of titanium and glass, e.g., float glass. Hermetic sealing with a titanium spacer may be used whether or not contact pads are used to make electrical connection to the bus bars.

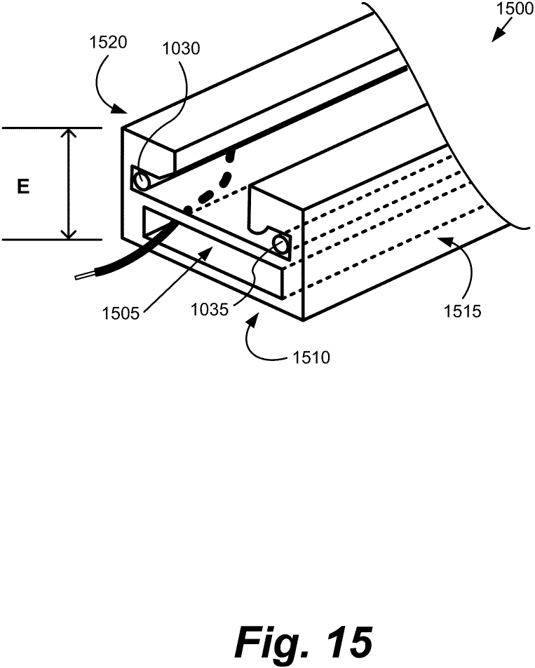

As described above, certain pre-wired spacers described herein have a track for establishing electrical communication between a connector, which mates with the track rails, and the optical device. FIG. 15 depicts a pre-wired spacer, 1500, which has a track (like track 1025, see FIGS. 10A and 10B). This figure shows that the width, E, of the spacer can be as approximately 6 millimeters in width or thicker, such as described above (up to 25 mm wide) in order to form a superior primary seal on sealing surfaces 1515 and 1520. In one embodiment, width E is between about 10 mm and about 15 mm. Spacer 1500 has passage, 1505, similar to channel 1040 of track 1025, through which wires that connect to the rails (1030 and 1035) may pass. The wires may pass through to the interior surface, 1510, of the spacer for soldering to bus bars, or may pass through to the sealing surfaces, 1515 and/or 1520 to contact pads for electrical communication thereto. In one embodiment, the spacer is made of an electrically insulating material, and rails 1030 and 1035 are un-insulated so that a connector, like connector 1045 (see FIG. 10B) can be inserted and establish electrical communication without having to pierce any insulation around the rails.

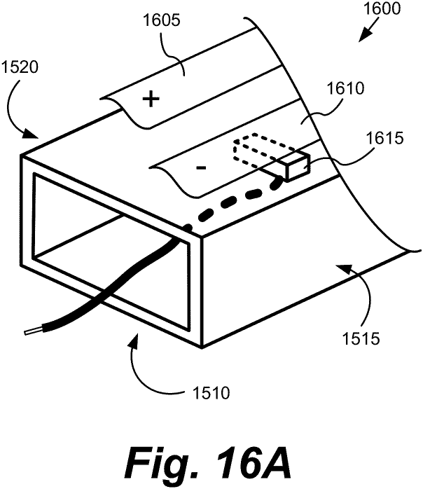

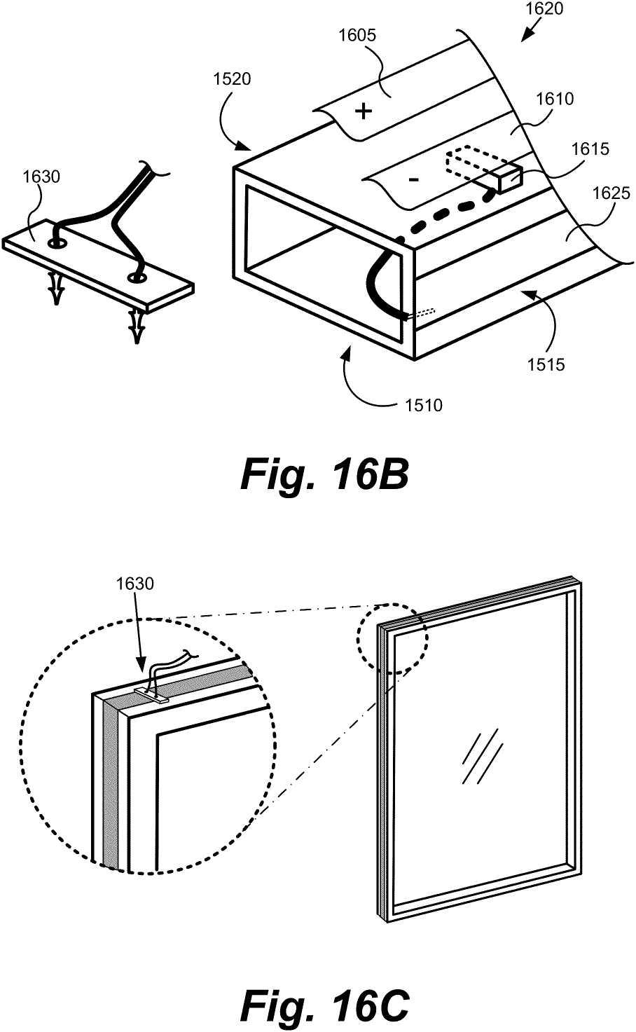

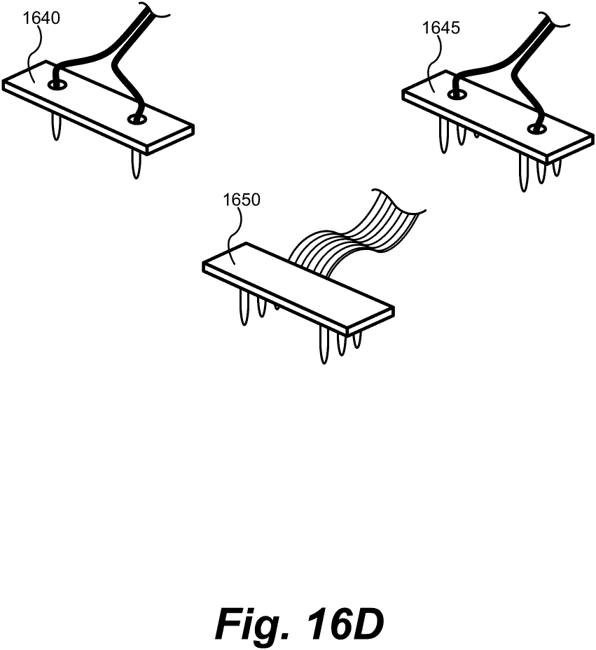

FIG. 16A is a cross-sectional perspective of another pre-wired spacer, 1600, including electrical connection about the perimeter of the spacer and through-spacer wiring. In this example, spacer 1600 is hollow, but has a wire passing through it as described above. In one embodiment, the spacer is a foam, polymeric material or fiberglass as described herein. The wire may pass through to the interior face, 1510 for soldering to a bus bar, or be connected to contact pads on the sealing surfaces, 1515 and/or 1520 (depending on if one or both lites bear optical devices). In this example, the (in this example, two) wires of the spacer are each connected to a flexible electrically conductive tape, 1605 or 1610. For example, each tape may represent the polarity of applied across an electrochromic device on one lite of the IGU. The tape may be a metal tape, such as copper or other good conductor. For example, tape 1610 is soldered or welded to a junction, 1615, that both supports the tape and makes good electrical connection to both tape 1610 and with the wire. During fabrication of the IGU, the tapes are embedded in the secondary sealant. For example, the tapes are installed, and then the secondary sealant is applied, e.g., using a tip to inject the sealant between and under the tapes, and then over the tapes to encapsulate (and suspend) the tapes in the secondary seal of the IGU. Electrical connection to the tapes is described in more detail in relation to FIGS. 16B-D.

FIGS. 16B-C show aspects of a particular embodiment in accord with the pre-wired spacer described in relation to FIG. 16A. In this example, a spacer, 1620, has conductive tapes 1605 and 1610 (same as spacer 1600). In this example, there is electrical communication between tape 1610 and a contact pad, 1625, on sealing surface 1515 of spacer 1620. Referring to FIG. 16C, the tapes are embedded in the secondary seal as described above, in this example, about the entire perimeter of the IGU. In one embodiment, the tapes span at least about 90% of the perimeter of the IGU. Electrical connection between a power source for the optical device and the tapes is made through a connector, 1630. Connector 1630 is a pin connector, the pins of the connector are pushed through the secondary sealant and thereby establish electrical communication with tapes 1605 and 1610 by touching or piercing them. In this example, the pins each have a wire connected to them from the power source and are barbed pins so that they remain solidly in the secondary sealant and electrically connected to their respective tapes. Using this electrical connection system, the installer can simply pierce the secondary seal, practically anywhere about the perimeter of the IGU (depending upon if there is also a controller embedded in the secondary seal and/or so as to avoid junction 1615) with the pin connector and establish electrical communication. In this example the body of connector 1630 is relatively flat or low profile so as not to take up too much space and also to avoid jarring loose by shearing forces when handling the IGU once the connector is installed. Another advantage of this system is that if the installer decides that placement of the connector is unsatisfactory, e.g., she wants to establish electrical communication on the other side of the IGU, she can simply cut the wires, cover the connector with electrical tape or other insulating sealant, and apply another connector where desired. If there is a controller in the secondary seal or to mark where any junctions reside, there may be color coding or other distinguishing marks applied to the secondary seal to demark that location so as not to apply the connector in that location.

FIG. 16D shows alternative piercing-type pin connectors in accord with the embodiments described in relation to FIGS. 16A-C. Connector 1640 has pins without barbs. The advantage of this configuration is that the connector pins may be inserted into the secondary sealant and removed, without damaging the conductor tapes, and reinserted at another location. Connector 1645 has multiple pins for establishing electrical connection to each conductor tape. That is, there are more than one pin so that electrical communication with each tape is assured. When the pins pass through the secondary sealant, there may remain some of the sealant on the pins, which would interfere with electrical communication. The likelihood of completely blocking electrical communication is much lower, that is, the likelihood of establishing good electrical communication is much higher, when there are more pins to pierce a particular conductor tape. In any pin connector embodiment, the pins may be coated with gold, for example. Connector 1650 has multiple pins and uses ribbon cable. In certain embodiments, the tape conductor system is used not only for electrical communication, that is, to deliver electricity, but also for communication lines. There may be two, three, four, five or more tapes and corresponding pins for piercing the tapes and establishing electrical communication.

One embodiment is a method of fabricating an IGU, the method includes registering a pre-wired spacer to a first lite including an optical device, registering a second lite with the pre-wired spacer and the first lite and affixing the pre-wired spacer to the first and second lites. The second lite optionally includes a second optical device. In one embodiment, the pre-wired spacer includes wires emanating from the interior surface of the pre-wired spacer and the wires are soldered to bus bars of the optical device prior, and the second optical device if present, prior to registering with the first or the second lite. The pre-wired spacer may include one or more contact pads on its primary sealing surface or surfaces, the contact pads configured to establish electrical communication with the optical device, the second optical device if present, or bus bars thereon, upon affixing the pre-wired spacer to the first and second lites. In one embodiment, affixing the pre-wired spacer to the first and second lites includes using an adhesive sealant between the sealing surfaces of the pre-wired spacer and the first and second lites. In another embodiment, affixing the pre-wired spacer to the first and second lites includes forming a hermetic metal-to-glass seal, where the pre-wired spacer includes a metal, at least on the sealing surfaces. The metal may be titanium.

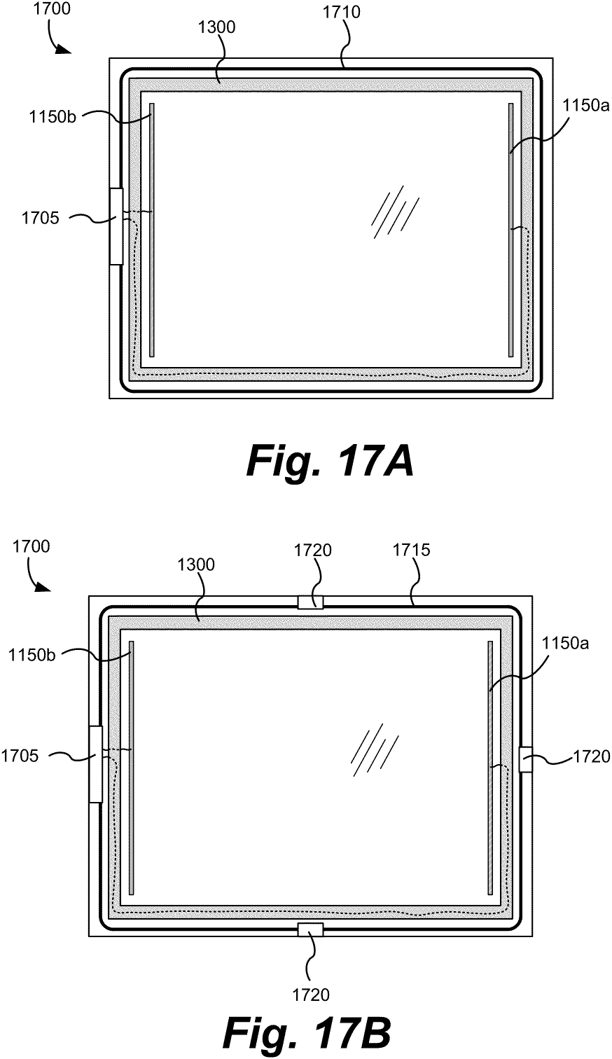

In one embodiment, an onboard controller is embedded in the secondary seal and a ribbon cable is embedded in the secondary seal. FIG. 17A depicts an electrical connection system, 1700, where ribbon cable, 1710, is used in the secondary seal in conjunction with piercing-type connectors as described herein. A controller, 1705, is also embedded in the secondary seal. Piercing type connectors are used to establish electrical communication to the two or more, e.g., conductive tapes, of the ribbon cable, the connector having one or more pins for each tape (or wire) of the ribbon cable. This electrical connection system allows flexibility in placement of the connector to the IGU.

FIG. 17B depicts an electrical connection system where ribbon cable, 1715, is used in the secondary seal, and pin sockets, 1720, are configured in the secondary seal about the perimeter of the IGU. In this embodiment, a pin connector (not shown) may be introduced into any one of pin sockets 1720, as they are redundant to the system. The pin sockets may be of the locking tab type, where once engaged with the pin connector, the tabs lock the union into place. The tabs may be manipulated to allow disengagement of the pin connector from the socket. There is little chance of secondary sealant interfering with electrical communication as the pins and corresponding sockets are free of secondary sealant. Controller 1705 may also have a pin socket 1720. In one embodiment, there is at least one pin socket on each side about the perimeter of the IGU. In certain embodiments, the controller is not embedded in the secondary seal; however, piercing and pin and socket type connections are still suitable. These embodiments are described in more detail below.

One embodiment is an electrical connection system of an IGU including an optical device requiring electrical powering, the electrical connection system including: a ribbon cable embedded in the secondary seal of the IGU and configured to supply electricity to the optical device; one or more pin sockets, also in the secondary seal, and in electrical communication with the ribbon cable, said one or more pin sockets configured in redundant form, each of the one or more pin sockets having the same electrical communication capability with the optical device; and a pin connector configured to mate with each of the one or more pin sockets and deliver electricity to the optical device. In one embodiment, the pin connector and each of the one or more pin sockets are configured to reversibly lock together when mated. In another embodiment, the electrical connection system further includes a controller configured to control the optical device, the controller may be also embedded in the secondary seal and include at least one of the one or more pin sockets. In one embodiment, the IGU includes at least four of said one or more pin sockets in the secondary seal, inclusive of the controller in the secondary seal, or if the controller is exterior to the secondary seal. In certain embodiments, when the controller is exterior to the secondary seal, the controller includes the pin connector. In one such embodiment, the pin connector is configured so that when mated to one of the one or more pin sockets, the controller is adjacent the secondary seal of the IGU. In another such embodiment, the pin connector is attached to the controller via a second ribbon cable. This allows for configuring the controller in the framing system where the controller may or may not be adjacent the edge of the IGU. In any of the above embodiments, the controller’s width may be configured so it is not greater than the width of the IGU.

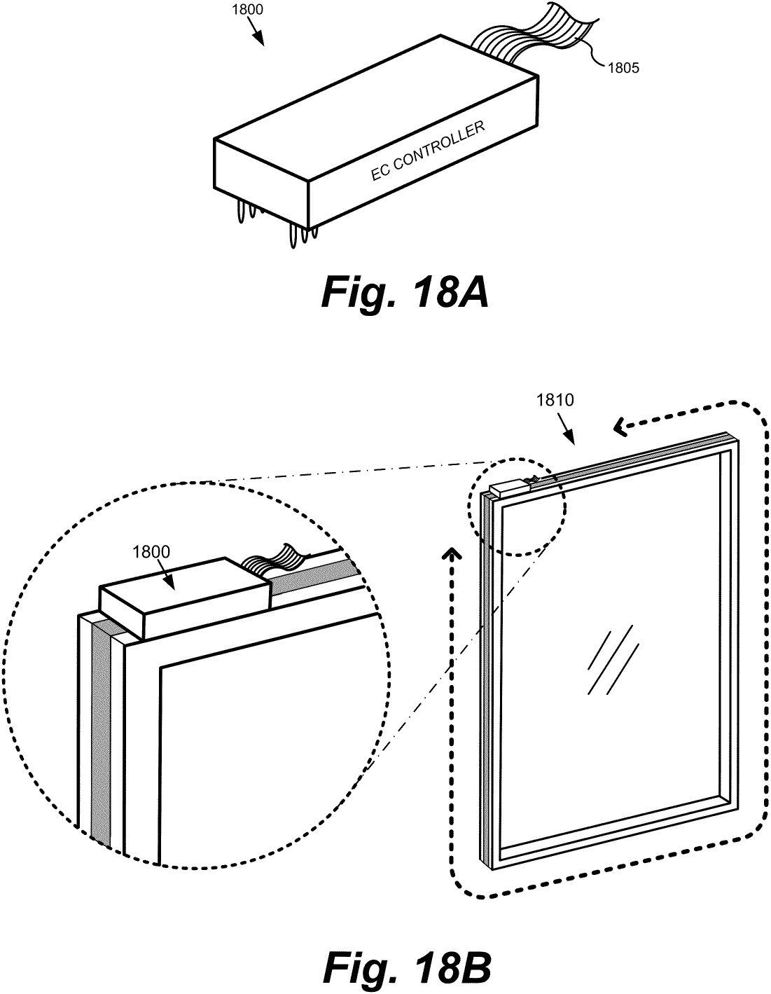

FIG. 18A depicts an electrochromic window controller, 1800, having piercing-type pin connectors as described herein. In this example, the electrochromic controller is configured such that it is not thicker than the IGU, but this is not necessary. The controller may be attached to the IGU, as depicted in FIG. 18B, at virtually any point about IGU 1810 (as indicated by the heavy dotted line). Controller 1800 interfaces with a control pad and/or a network controller via a ribbon cable, in this example. Ribbon cables are convenient for this purpose as they can carry power and communication lines while having a flat, low-profile which aides in configuring the cable in framing systems for windows. In one embodiment, controller 1800 does not use piercing type pins, but rather pin and socket type connection to the IGU; i.e., where there are pin sockets embedded in the secondary seal about the perimeter of the IGU (as in FIG. 17B, but where the controller is exterior of the secondary seal and plugs into one of the pin sockets via it’s pin connector, either directly attached to the body of the controller or at the end of a ribbon cable). Using pin sockets with locking tabs, the controller can be securely attached to the IGU without further attachment means. In certain embodiments, the controller is not thicker than the IGU on that dimension; that is, when the controller is affixed to the IGU as depicted in FIG. 18B, the faces or surfaces of the controller that are substantially parallel to the exterior major surfaces of the lites of the IGU do not extend beyond the major surfaces. In this way the controller can be accommodated more easily within the framing for the IGU. The controller may be long and thin, e.g., spanning about 6 to about 15 inches in length, and thus may attach to the IGU secondary seal at more than one region of the controller. Attachment to the secondary seal can be both with pin connectors as described to establish electrical communication, as well as with anchors that are specifically configured to attach to the secondary seal material solely for attachment purposes; that is, to affix the controller to the IGU but not to establish electrical communication with the one or more ribbon cables. In one embodiment the controller uses piercing pin-type connectors (that pierce the secondary seal material to make electrical contact to ribbon type conductors) along with these anchors configured solely for anchoring the controller to the secondary seal material. The anchors can, for example, be configured so as to penetrate the secondary seal, e.g., in between the ribbon conductors, or, e.g., through the ribbon conductors, but be made of electrically insulating material so as not to establish electrical communication with the ribbon conductors. In one embodiment, the anchors are barbed pins that do not penetrate the secondary seal deep enough to reach the ribbon conductors, for example.

One embodiment is an electrical connection system for an IGU including an optical device requiring electrical powering, the electrical connection system including: one or more ribbon conductors configured to be embedded in the secondary seal of the IGU and supply electricity to the optical device; and a pin connector configured to establish electrical connection to said one or more ribbon conductors by penetrating the secondary seal material and piercing the one or more ribbon conductors thereby establishing electrical communication with the one or more ribbon conductors. In one embodiment, the pin connector includes barbed pins configured to secure pin connector to the one or more ribbon conductors. The one or more ribbon conductors may supply electricity to the optical device via wiring through the spacer of the IGU. In one embodiment, the spacer of the IGU comprises one or more contact pads on the primary sealing surface of the spacer, said one or more contact pads configured to establish electrical communication with one or more electrical power distribution components of the optical device. The one or more electrical power distribution components of the optical device may be bus bars. The pin connector may be a component of a controller configured to control the optical device. In one embodiment, the controller’s width is not greater than the width of the IGU. In another embodiment, the one or more ribbon conductors are configured such that the controller can be affixed to the edge of the IGU about at least 90% of the perimeter of the IGU.

### Examples of Electrical Connection Systems with Chain Guides

Certain implementations of systems and apparatus described herein for sliding door/window applications have an electrical connection system that includes a chain guide (sometimes referred to herein as a “chain connector” or “chain”) connected at one end to the sliding door/window and at the other end to a frame component such as a door header or other fixed structure. The chain guide includes a recess that may run from one end to the other end, within which pass wiring and/or tubing in order to guide movement and protect the wiring/tubing while the chain guide is folding and unfolding. The wiring and/or tubing may, for example, communicate power, data, and/or fluid (e.g., hydraulic fluid). A chain guide can allow wiring/tubing to pass through and connect to one or more sliding multiple doors/windows without disrupting their mechanics. One example of a chain guide keeps a constant bend radius as it folds and unfolds to maintain the direction of the wiring and/or tubing. Some examples of commercially-available chain guides that can keep a constant bend radius include igus chains made by Ramco Innovations and the e-chain® cable carrier made by igus® inc. of East Providence, Rhode Island.

FIGS. 9G and 9H depict an example of a cable management system 901 of an electrical connection system. The cable management system 901 includes a chain guide 908 that can fold and unfold in a vertical direction along a plane parallel to the movable (sliding) door 921 as the movable door 921 slides past the fixed door 922 to protect and guide the IGU connector cable 918 housed within.

Certain implementations of systems described herein for door/window applications have an electrical connection system with a chain guide that can fold and unfold in a horizontal direction substantially along a plane orthogonal to the movable doors/windows. Folding and unfolding the chain guide along the horizontal direction may facilitate implementations having multiple movable doors/windows (e.g., 3, 4, 5, 6, 7, 8, 9, and 10) that slide along one track or along multiple parallel tracks to facilitate stacking of multiple doors/windows one behind the other. For example, two or more movable vertical doors/windows may slidably engage with parallel lengthwise slots to be able to stack the vertical doors/windows while a chain guide connected to each of the movable doors/windows folds and unfolds in the horizontal direction protecting the wiring and/or tubing housed therein.

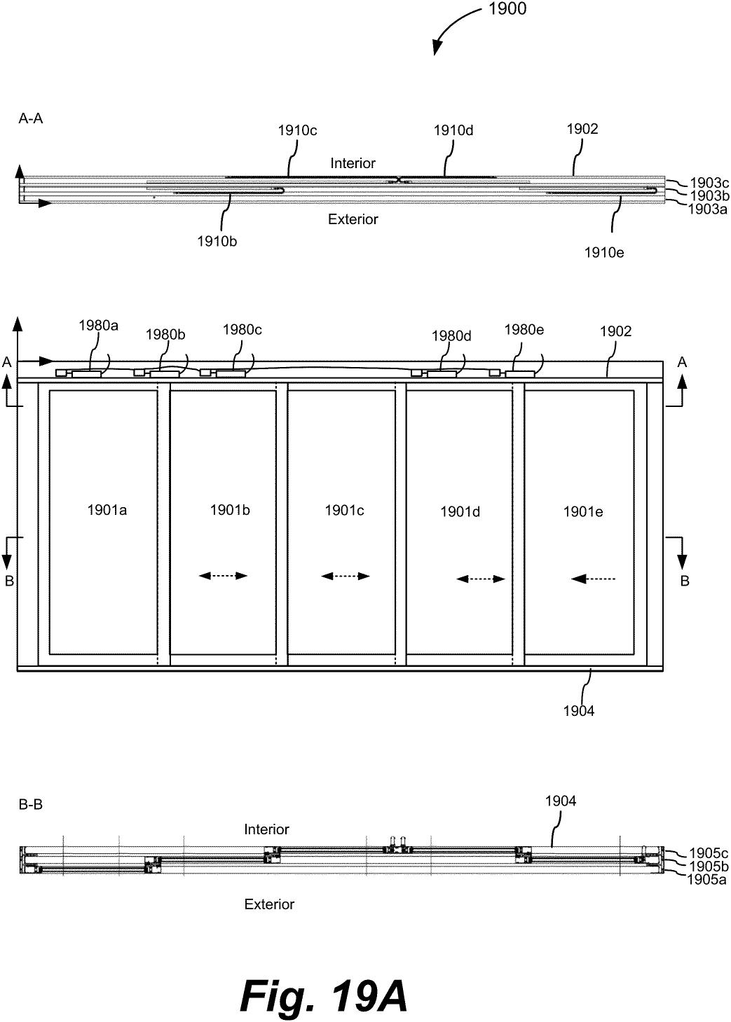

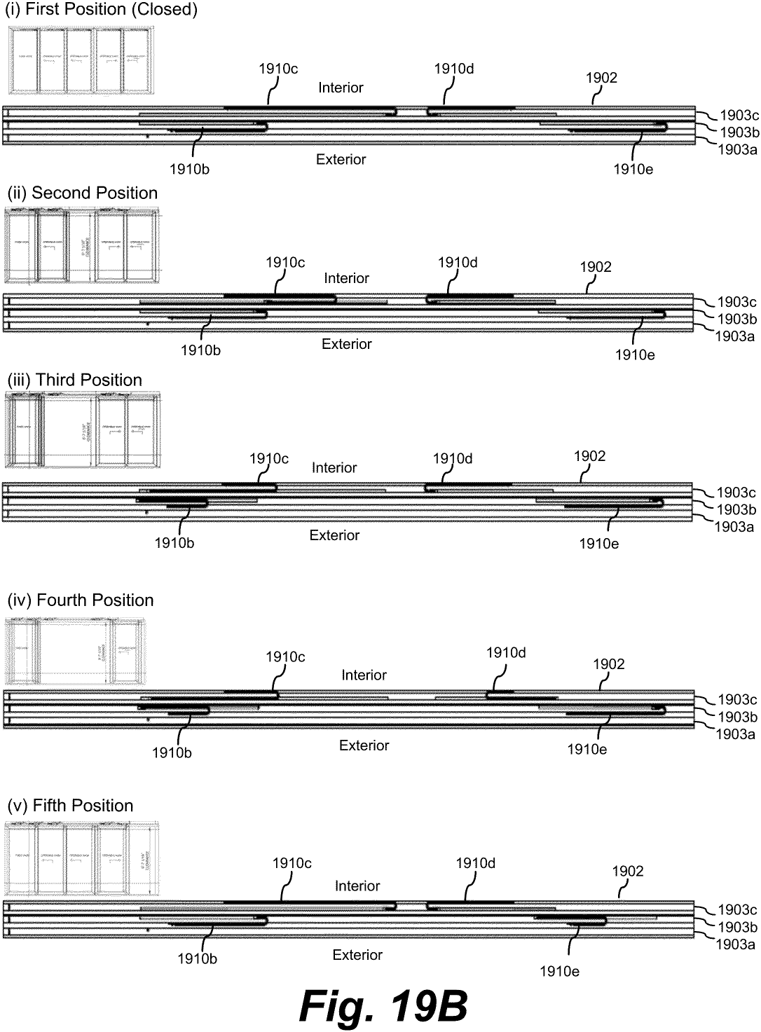

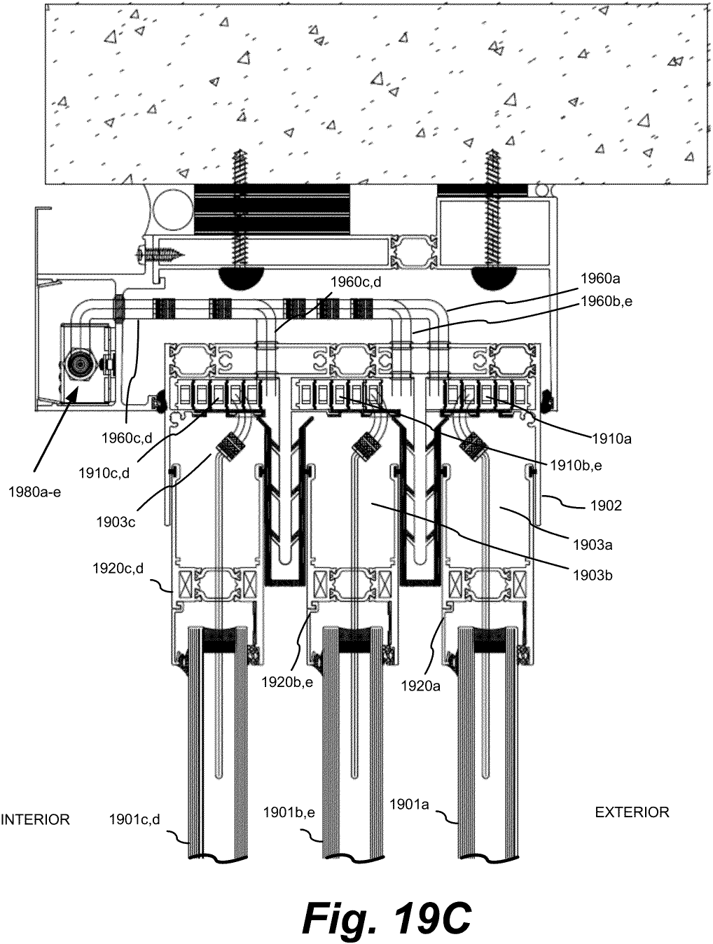

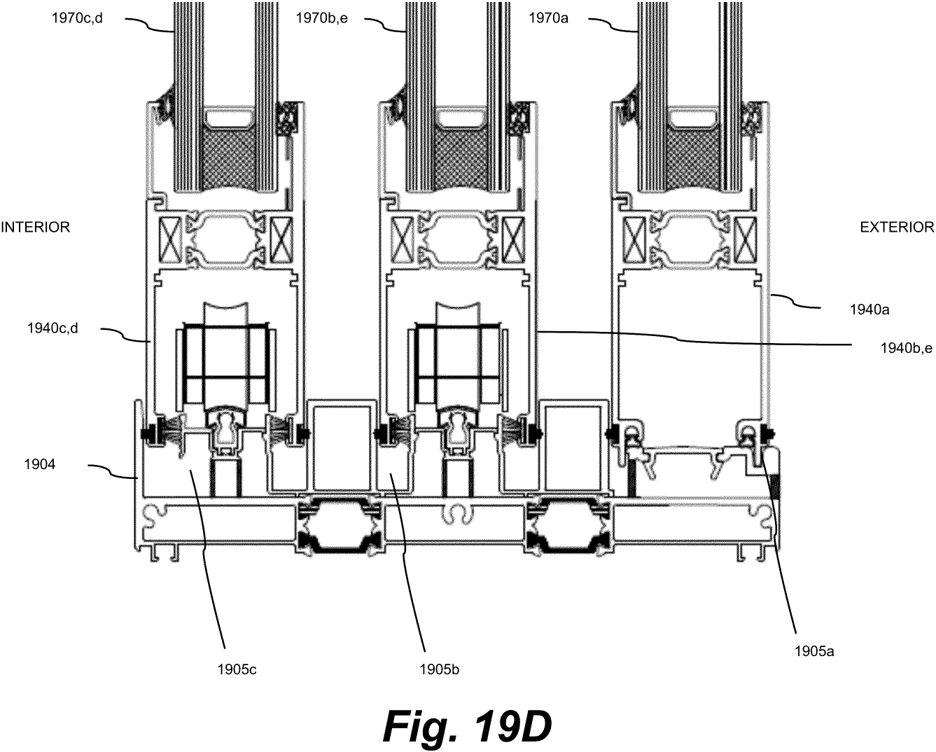

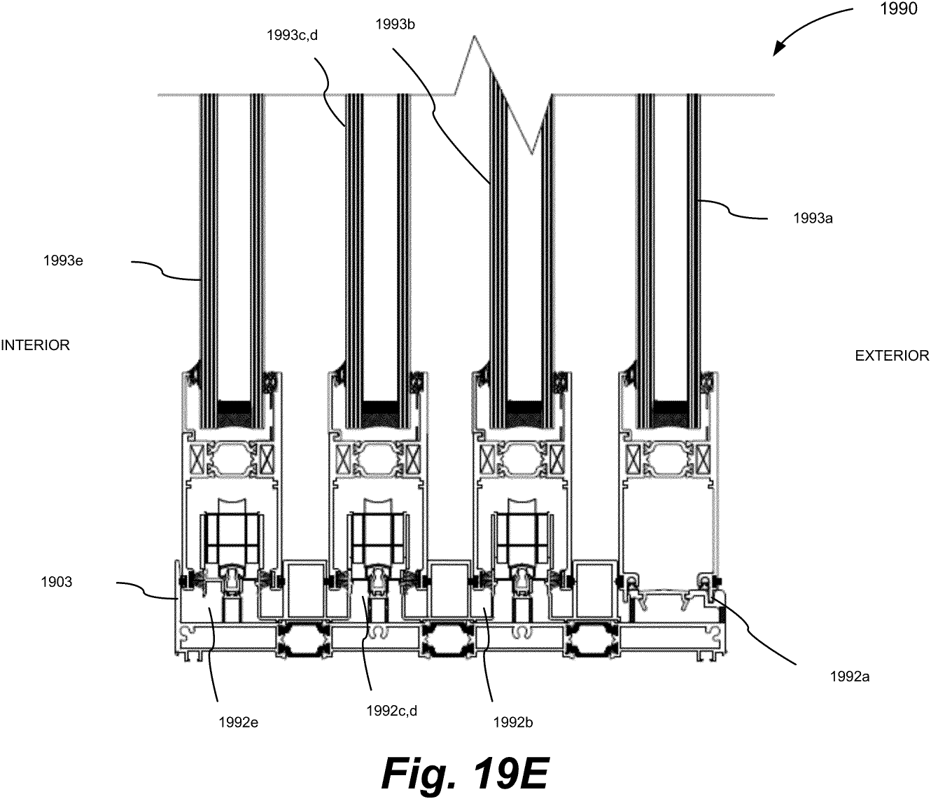

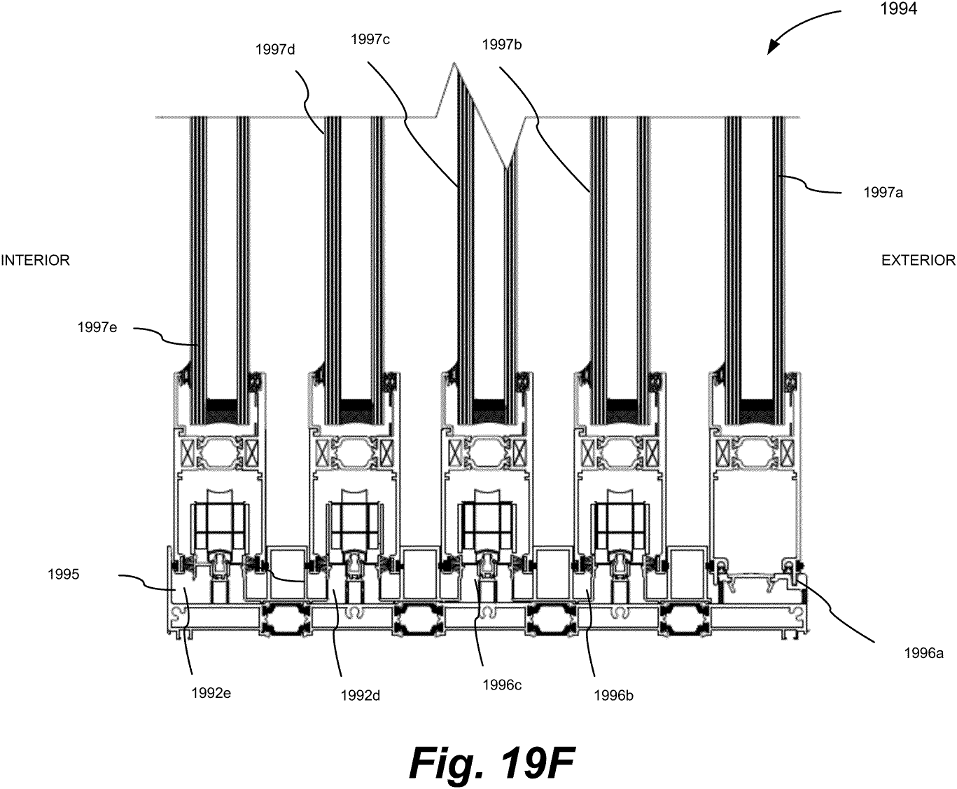

FIG. 19A depicts a schematic drawing of a front view (middle portion), a cross-sectional view facing upward (A-A section at top portion), and a cross-sectional view facing downward (B-B section at bottom portion) of components of a sliding door assembly 1900 including a fixed door 1901a and four (4) movable doors 1901b-e in a stackable configuration, according to an implementation. In FIG. 19A, the movable doors 1901b-e are shown in a first (closed) position. Dashed line arrows illustrate the direction or directions of movement of the movable doors 1901b-e from the closed position. FIG. 19B depicts the cross-sectional view facing upward of the sliding door assembly 1900 in FIG. 19A at five different positions: (i) the first position (closed position), (ii) a second position where movable door 1901c has been moved behind (from a vantage point exterior to the assembly looking into the interior) movable door 1901b (i.e. stacking movable doors 1901b and 1901c), (iii) a third position where movable doors 1901b and 1901c have been moved behind the fixed door 1901a, (iv) a fourth position where movable doors 1901b and 1901c have been moved behind fixed door 1901a and movable door 1901d has been moved behind movable door 1901e, (v) a fifth position where movable door 1901e have been moved behind movable door 1901d. Other positions for the sliding door assembly 1900 and other sliding assemblies may be implemented. FIG. 19C depicts a cross-sectional side view of a portion of the sliding door assembly 1900 showing details of the first frame guide 1902, according to an implementation. FIG. 19D depicts a cross-sectional side view of another portion of the sliding door assembly 1900 showing details of the second frame guide 1904, according to an implementation. Although this example and others are described with reference to doors, windows may be used.

Returning to FIG. 19A, the sliding door assembly 1900 includes an electrical connection system with a first frame guide 1902 having three lengthwise slots 1903a, 1903b, and 1903c and a second frame guide 1904 having three lengthwise slots 1905a, 1905b, and 1905c. In this example, movable doors 1901c and 1901d are slidably engaged with the lengthwise slot 1903c of the first frame guide 1902 and slidably engaged with the lengthwise slot 1905c of the second frame guide 1904. Movable doors 1901b and 1901e are slidably engaged with second lengthwise slot 1903b of the first frame guide 1902 and slidably engaged with the lengthwise slot 1905b of the second frame guide 1904. The electrical connection system also includes four chain guides 1910b, 1910c, 1910d, and 1910e that can fold and unfold along a horizontal direction. The chain guides 1910c and 1910d are configured to fold and unfold within the first lengthwise slot 1903c of the first frame guide 1902. The chain guides 1910b and 1910e are configured to fold and unfold within the lengthwise slot 1903b of the first frame guide 1902.

In one aspect, at least one of the lengthwise slots of the first frame guide includes a rail within which one or more chain guides folds and unfolds during operation. The chain guides are coupled at one end to the rail and at the other end to the shuttles that are slidably engaging within the lengthwise slot. The rail may include an aperture or apertures through which wiring emanating from the chain guides can pass through.

The sliding door assembly 1900 also includes five controllers 1980a-e. Controller 1980a is in electrical communication with one or more electrochromic devices of the fixed door 1901a via one or more wires. The controllers 1980b-e are in electrical communication with movable doors 1901b-e via wiring passing through respective chain guides 1910b-e. That is, controller 1980b is in electrical communication with one or more electrochromic devices of the movable door 1901b via wiring passing through chain guide 1910b, controller 1980c is in electrical communication with one or more electrochromic devices of the movable door 1901c via wiring passing through chain guide 1910c, etc. The controllers 1980a-e may be located in the header or other fixed frame element. The controllers 1980a-e may be connected to at least one power source.

The wiring passing through the chain guides 1910b-e includes one or more wires. Each of the chain guides comprises a bend portion that allows it to pass back over itself while it folds and unfolds and reside substantially parallel and inside the lengthwise slots. In one example, the one or more wires are a ribbon cable. One or more of the chain guides may be made at least partially of a non-electrically conducting material. For example, the inner surface of a chain guide may comprise a non-electrically conducting material. The one or more wires may reside with the body of the chain guide.

As shown in FIG. 19C, the electrical connection system includes four shuttles 1920b, 1920c, 1920d, 1920e connected respectively to one side of the movable doors 1901b, 1901c, 1901d, and 1901e. Each shuttle includes a connecting portion or portions, such as, e.g., the illustrated cup elements at the ends of the two opposing flanges that mate with a lengthwise bar element, that is/are configured to slidably engage with an inner surface of a lengthwise slot to allow the movable door connected to the shuttle to move along the lengthwise slot. In the illustrated example, shuttles 1920c and 1920d have connecting portion or portions tat slidably engage with an inner surface of the lengthwise slot 1903c of the first frame guide 1902 to allow the movable doors 1901c and 1901d to slide along the lengthwise slot 1903a and shuttles 1920b and 1920e have connecting portion or portions that slidably engage with an inner surface of the lengthwise slot 1903b of the first frame guide 1902 to allow the movable doors 1901b and 1901e to slide along the lengthwise slot 1903b. Although the fixed door 1901a may not move during operation of the sliding door assembly 1900, the electrical connection system also includes a shuttle 1920a for coupling the fixed door 1901a to an inner surface of the lengthwise slot 1903a of the first frame guide 1902. The chain guide 1910b is connected on one end to the shuttle 1920b of the movable door 1901b and at the other end to first frame guide 1902 or a component of the header. The chain guide 1910c is connected on one end to the shuttle 1920c of the movable door 1901c and at the other end to the first frame guide 1902 or a component of the header. The chain guide 1910d is connected on one end to the shuttle 1920d of the movable door 1901d and at the other end to the first frame guide 1902 or a component of the header. The chain guide 1910e is connected on one end to the shuttle 1920e of the movable door 1901e and at the other end to first frame guide 1902 or a component of the header.

As shown in FIG. 19D, the electrical connection system also includes another set of four shuttles 1940b, 1940c, 1940d, and 1940e connected to an opposing side of movable doors 1901b, 1901c, 1901d, and 1901e. The shuttles 1940c and 1940d have connecting portion or portions that slidably engage with an inner surface of the lengthwise slot 1905c of the second frame guide 1904 to allow the movable doors 1901c and 1901d to slide along the lengthwise slot 1905a and shuttles 1940b and 1940e have connecting portion or portions that slidably engage with an inner surface of the lengthwise slot 1905b of the second frame guide 1904 to allow the movable doors 1901b and 1901e to slide along the lengthwise slot 1905b. The electrical connection system also includes a shuttle 1940a for coupling the fixed door 1901a to an inner surface of the lengthwise slot 1905a of the second frame guide 1904.

FIG. 19E depicts a cross-sectional side view of a portion of another example of a sliding door assembly 1990 having frame guides with four lengthwise slots. The sliding door assembly 1990 includes a second frame guide 1991 having four lengthwise slots 1992a-d. In this example, movable door 1993e is slidably engaged with the lengthwise slot 1992d, movable doors 1993c and 1993d are slidably engaged with the lengthwise slot 1992c, movable door 1993b is slidably engaged with the lengthwise slot 1992b, and fixed door 1993a is fixedly coupled to lengthwise slot 1992a.

FIG. 19F depicts a cross-sectional side view of a portion of another example of a sliding door assembly 1994 having frame guides with five lengthwise slots. The sliding door assembly 1994 includes a second frame guide 1995 having five lengthwise slots 1996a-e. In this example, movable door 1997e is slidably engaged with the lengthwise slot 1996e, movable door 1997d is slidably engaged with the lengthwise slot 1996d, movable door 1997c is slidably engaged with the lengthwise slot 1996d, movable door 1996b is slidably engaged with the lengthwise slot 1997b, and fixed door 1996a is fixedly coupled to lengthwise slot 1997a.

In one aspect, a door/window assembly includes a strain relief mechanism between a chain guide and the frame or header to which it is attached. The strain relieve mechanism is configured to minimize any strain on the one or more wires residing in the chain guide. An example of a strain relief mechanism is a rubber grommet.

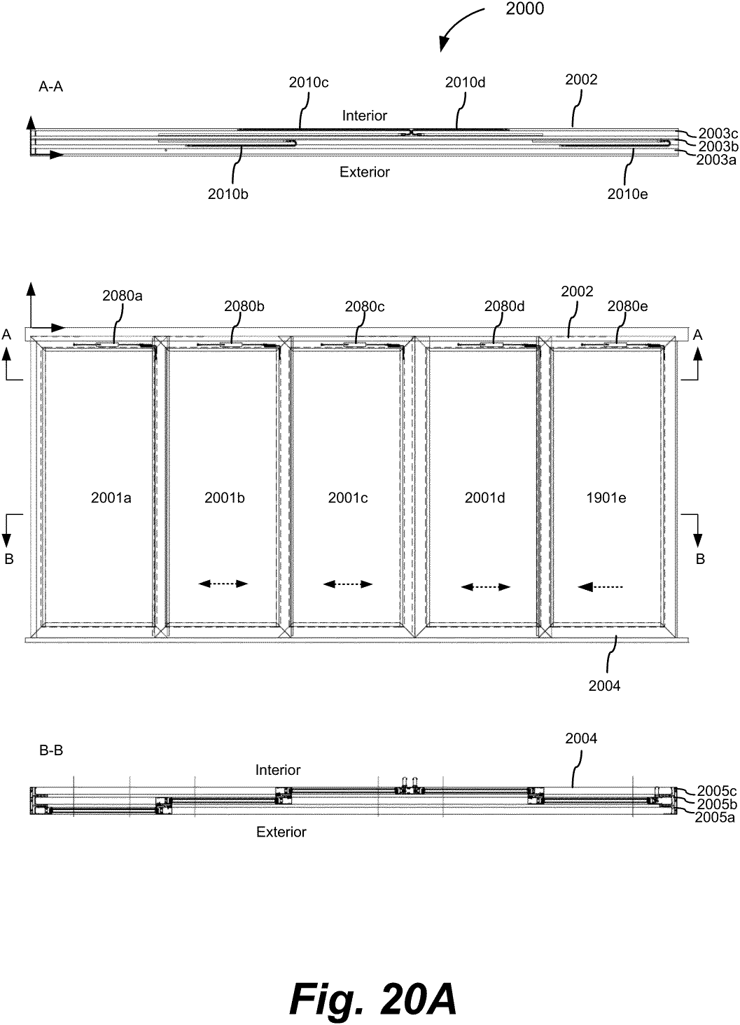

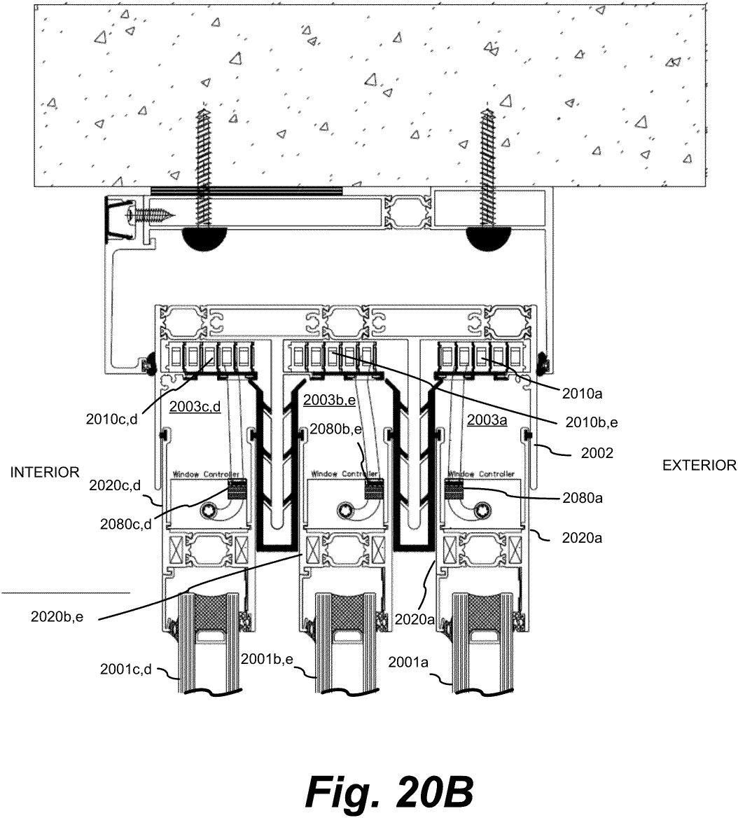

In some stackable configurations, a door/window assembly includes controllers that are onboard controllers or located in the shuttles to move along with the movable doors/windows. FIGS. 20A and 20B depict schematic drawings of a sliding door assembly 2000 with controllers 2080a-e that are housed in shuttles 2080a-e, according to an aspect. FIG. 20A depicts a front view (middle portion), a cross-sectional view facing upward (A-A section at top portion), and a cross-sectional view facing downward (B-B section at bottom portion) of components of the sliding door assembly 2000 including a fixed door 2001a and four (4) movable doors 2001b-e in a stackable configuration, according to an implementation. In FIG. 20A, the movable doors 2001b-e are shown in a first (closed) position. Dashed line arrows illustrate the direction or directions of movement of the movable doors 2001b-e from the closed position. The movable doors 2001b-e can be moved to at least the five positions depicted in FIG. 19B, including: (i) the first position (closed position), (ii) a second position where movable door 2001c has been moved behind (from a vantage point exterior to the assembly looking into the interior) movable door 2001b (i.e. stacking movable doors 2001b and 2001c), (iii) a third position where movable doors 2001b and 1901c have been moved behind the fixed door 2001a, (iv) a fourth position where movable doors 2001b and 2001c have been moved behind fixed door 2001a and movable door 2001d has been moved behind movable door 2001e, (v) a fifth position where movable door 2001e have been moved behind movable door 2001d. FIG. 20B depicts a cross-sectional side view of a portion of the sliding door assembly 2000 showing details of the first frame guide 2002, according to an implementation. Although this example and others are described with reference to doors, windows may be used.

Returning to FIG. 20A, the sliding door assembly 2000 includes an electrical connection system with a first frame guide 2002 having three lengthwise slots 2003a, 2003b, and 2003c and a second frame guide (not shown) having three lengthwise slots. In this example, movable doors 2001c and 2001d are slidably engaged with the lengthwise slot 2003c of the first frame guide 2002 and slidably engaged with an opposing lengthwise slot of the second frame guide. Movable doors 2001b and 2001e are slidably engaged with lengthwise slot 2003b of the first frame guide 2002 and slidably engaged with an opposing lengthwise slot of the second frame guide. The electrical connection system also includes four chain guides 2010b, 2010c, 2010d, and 2010e that can fold and unfold along a horizontal direction. The chain guides 2010c and 2010d are configured to fold and unfold within the first lengthwise slot 2003c of the first frame guide 2002. The chain guides 2010b and 2010e are configured to fold and unfold within the lengthwise slot 2003b of the first frame guide 2002.

Returning to FIG. 20B, the sliding door assembly 2000 also includes five controllers 2080a-e. Controller 2080a is housed in a shuttle 2020a, which is coupled to fixed door 2001a. Controllers 2080b and 2080e are housed respectively in shuttles 2020b and 2020e, which are coupled respectively to movable doors 2001b and 2001e. Controllers 2080c and 2080d are housed respectively in shuttles 2020c and 2020d, which are coupled respectively to movable doors 2001c and 2001d. In this implementation, the controllers 2080b-e move along with the movable doors 2001b-e. Controller 2080a is in electrical communication with one or more electrochromic devices of the fixed door 2001a via one or more wires. The controllers 2080b-e are in electrical communication with one or more of the electrochromic devise of respective movable doors 2001b-e via one or more wires. The controllers 2080b-e are in electrical communication with at least a power source via wiring passing through respective chain guides 2010b-e. The wiring passing through the chain guides 2010b-e includes one or more wires (e.g., a ribbon cable). Each of the chain guides comprises a bend portion that allows it to pass back over itself while it folds and unfolds and reside substantially parallel and inside the lengthwise slots. One or more of the chain guides may be made at least partially of a non-electrically conducting material. For example, the inner surface of a chain guide may comprise a non-electrically conducting material. The one or more wires may reside with the body of the chain guide.

As shown in FIG. 20B, the electrical connection system includes four shuttles 2020b, 2020c, 2020d, and 2020e connected respectively to one side of the movable doors 2001b, 2001c, 2001d, and 2001e. Each shuttle includes a connecting portion or portions, such as, e.g., the illustrated cup elements at the ends of the two opposing flanges that mate with a lengthwise bar element, that is/are configured to slidably engage with an inner surface of a lengthwise slot to allow the movable door connected to the shuttle to move along the lengthwise slot. In the illustrated example, shuttles 2020c and 2020d have connecting portion or portions that slidably engage with an inner surface of the lengthwise slot 2003c of the first frame guide 2002 to allow the movable doors 2001c and 2001d to slide along the lengthwise slot 2003a and shuttles 2020b and 2020e have connecting portion or portions that slidably engage with an inner surface of the lengthwise slot 2003b of the first frame guide 2002 to allow the movable doors 2001b and 2001e to slide along the lengthwise slot 2003b. Although the fixed door 2001a may not move during operation of the sliding door assembly 2000, the electrical connection system also includes a shuttle 2020a for coupling the fixed door 2001a to an inner surface of the lengthwise slot 2003a of the first frame guide 2002.

The chain guide 2010b is connected on one end to the shuttle 2020b of the movable door 2001b and at the other end to first frame guide 2002 or a component of the header. The chain guide 2010c is connected on one end to the shuttle 2020c of the movable door 2001c and at the other end to the first frame guide 2002 or a component of the header. The chain guide 2010d is connected on one end to the shuttle 2020d of the movable door 2001d and at the other end to the first frame guide 2002 or a component of the header. The chain guide 2010e is connected on one end to the shuttle 2020e of the movable door 2001e and at the other end to first frame guide 2002 or a component of the door header.

Although not shown in FIGS. 20A and 20B, the electrical connection system also includes another set of four shuttles connected to an opposing side of movable doors 2001b, 2001c, 2001d, and 2001e and having have connecting portion or portions that slidably engage with an inner surface of lengthwise slots of a second frame guide to allow the movable doors 2001b-e to slide along the lengthwise slots. The electrical connection system also includes a shuttle for coupling the fixed door 2001a to an inner surface of a lengthwise slot of the second frame guide.

### Magnetic Power Transfer Connectors

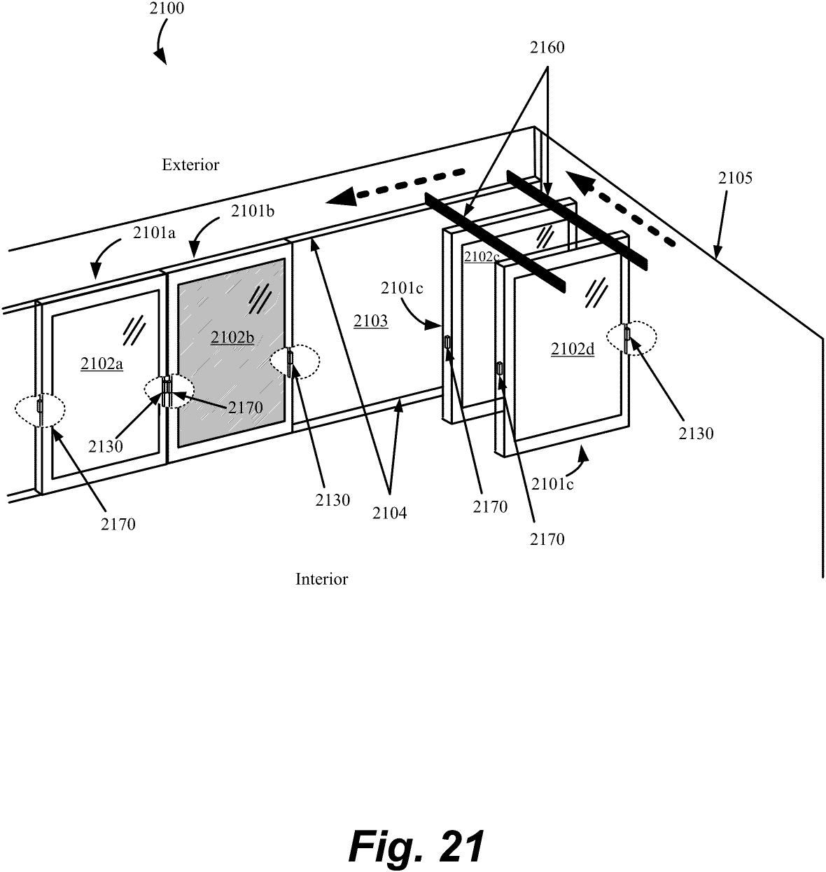

In certain aspects, a movable window or door may include one or more electrical connectors that can connect to other windows or doors in series or in parallel, for example, to connect a section or run of a trunk line system that provides power and/or communications to the windows and/or doors. In certain implementations, a movable door or window may include an electrical connection system with one or more magnetic power transfer (MPT) connectors that employ magnetic actuation to establish electrical connection. The magnetic components may include shielding function to prevent magnetic interference with the power and/or communication running through the electrical connection established via the MPT. Such MPT connectors may be employed, for example, in an assembly of two or more detachable moving doors or windows where the range of travel of the doors or windows (such as, e.g., when detachable doors are disconnected and moved off the rails of the frame) may not easily support sliding cables or other fixed electrical connections. FIG. 21 depicts an example of a system 2100 that includes a plurality of four detachable doors 2101a-d, each including an IGU, with four IGUs 2102a-d respectively. Although depicted with four detachable doors 2101a-d and four IGUs 2102a-d, in other implementations, the detachable system 2100 may include additional or fewer doors and/or IGUs. Alternatively, the detachable system 2100 may include detachable windows or a combination of detachable windows and doors. In certain embodiments, magnetic power transfer connectors are used in door and window systems such as those described in relation to FIGS. 9B, 9C and 20A for example. The MPT connectors described in relation to FIG. 21 may be used in any operable window or door application where two surfaces reversibly abut, e.g., an accordion door system as in FIG. 9B, a movable window as in FIG. 9C, or a sliding door system as in FIG. 20A. Systems described herein such as MPT connectors allow for cabling (e.g., trunk line, drop cable from trunk to window controller, etc.) to be embedded in window and door framing, sash, sill, transom, header, etc. so as to obscure it from sight and provide a clean installation with no wires showing in some embodiments. The MPT connector male and female components are flush or recess mounted on the abutting surfaces. As the surfaces move toward each other, magnetic elements of the connector components attract each other and engage to make the electrical connection. Sufficient movement degrees of freedom are provided in certain engagement subcomponents so that precise alignment of the abutting surfaces is not necessary, and, the surfaces may not actually touch, as weather seals may serve the purpose of sealing any gap between the surfaces. As such, these improved systems provide more leeway for the installer and are thus more desirable.

In certain implementations of a detachable system, one or more of the detachable doors or windows may be disconnected from the rails of the frame upon which the doors or windows slide along and moved to a supporting structure to, for example, adjust the size of an opening. Such systems are becoming more common in high-end residential and commercial applications. For example, as depicted in FIG. 21, detachable doors 2101c-d are shown located on one or more supporting beams 2160 to provide an opening 2103 between a wall 2105 and the detachable doors 2101a-b. In another instance, the detachable doors 2101a-b may be moved to or near the wall 2105 to provide an opening 2103 away from the wall 2105. In the illustrated example, the two detachable doors 2101c-d located on the one or more supporting beams 2160 may be translated (as indicated by the heavy dashed arrow) from the one or more supporting beams 2160 to a rail of a frame 2104 and electrically connected to each other and/or to another connector at the wall 2105 or in frame 2104 by implementing a first component 2130 and second component 2170 in each of the detachable doors 2101c-d. In detachable system 2100, one or more of the detachable doors 2101a-d may be disconnected from the rail of the frame 2104 and moved onto the one or more supporting beams 2160 and moved from the one or more supporting beams 2160 and connected to the rail of the frame 2104. The door opening 2013 can be customized by moving the detachable doors 2101a-b onto or off the one or more supporting beams 2160 as desired. In another implementation, the detachable system 2100 may also include one or more hinged doors. For example, detachable system 2100 may includes a hinged door with a hinge at the wall 2105 that when opened allows movement of the detachable doors 2101a-d to and from the supporting beams 2160.

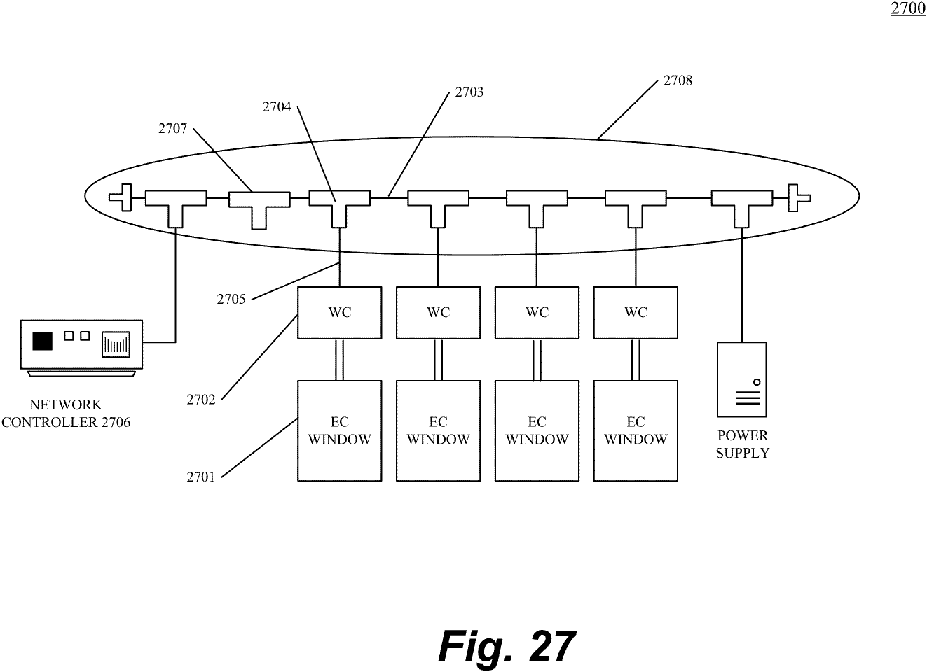

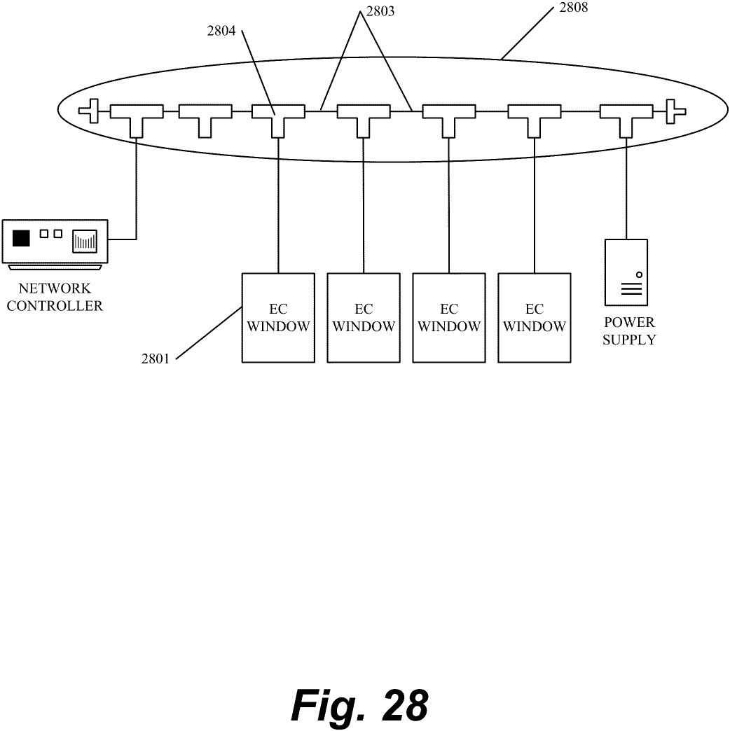

In FIG. 21, each detachable door 2101a-d includes the first component 2130 and second component 2170 on two opposing sides. The first component 2130 and second component 2170 can establish electrical connection between adjacent detachable doors (e.g., detachable doors 2202a and 2102a), for example, to connect a section or run of a trunk line system (e.g., trunk lines 2708 and 2808 shown in FIGS. 27 and 28) or one or more drop lines. In the illustrated example, the first component 2130 and second component 2170 are located on opposing sides of each detachable door 2101a-d and are directed outward from the sides to connect to another second component 2170 and another first component 2130 respectively of another inline (jam to jam) detachable door and/or of a wall 2105 or in the frame 2104. For example, the first component 2130 of detachable door 2101a may connect the second component 2170 of detachable door 2101b where both detachable door 2101a-b slide inline along a single rail of the frame 2104. In another implementation, a first component 2130 and a second component 2170 may be directed outward from opposing faces of each detachable door 2101a-d where the detachable doors 2101a-d are sliding laterally past one another along parallel rails in the frame 2104 and when the detachable door 2101a-d are closed the mullions overlap. For example, a first component 2130 may be outward-facing (facing toward exterior) on detachable door 2101b which slides along an outer track and a second component 2170 may be inwardfacing on detachable door 2101a which slides along an inner track parallel to the outer track. As the detachable doors 2101a-b slide along parallel tracks, the first and second components 2130, 2170 can connect between the detachable doors 2101a-b.

In certain aspects, the IGUs 2102a-b of the detachable doors 2101a-b include one or more optically switchable devices such as electrochromic devices. The control of the detachable doors 2101a-d such as, for example, the movement of the detachable doors 2101a-d and the tinting of the optically switchable devices may be controlled by one or more controllers. In one aspect, the one or more controllers may control transitioning tint of the optically switchable devices as well as translation of the detachable doors 2101a-b to and from the one or more supporting beams 2160.

The electrical connection of the IGUs 2102a-b to one or more controllers may be established by connecting the first component 2130 and second component 2170 of one or more of the detachable doors 2101a-d located on the rail or rails of the frame 2104 in series. In one aspect, the first component 2130 of at least one of the detachable doors 2101a-d may establish electrical connection to a second component 2170 to connect a section or a run of a trunk line system such as trunk line 2708 or 2808 in FIGS. 27 and 28 or one or more drop lines from the trunk line to one or more window controllers. The cabling for the trunk line or drop lines may be embedded in the window and door framing, sash, sill, transom and/or other framing structure.

In certain implementations of a magnetic power transfer connector, the first component includes pins and the second component includes opposing pads that can connect with each other to establish electrical communication. Alternatively, the first component includes pads and the second component includes pins. The pins and/or pads may be gold plated, include pogo pins (spring loaded and/or magnetically engaged) as described herein for other embodiments. The first component and second component of the MPT connector may include any number of connecting pins and opposing pads, depending on the devices being controller in the windows or doors, the controller specifications, the manner in which the windows or doors are coupled and, optionally, sensors and also any associated movement mechanisms that must be controlled via the electrical communication lines through the doors or windows. In certain implementations, the first component and second component include 4, 5, 8, 18, 24, or even more pins and opposing pads respectively. For example, the first component and second component may include two pins and pads if a number of IGUs are coupled to one another in series and there are not any sensors associated with the IGUs. In another example, the first component and second component may include five pins and pads to provide, for example, two electrical conductors for two power signals electrical, two electrical conductors for communication signals, and one electrical conductor for a shielding connection (providing ground). In one aspect, a spring connector and pad are implemented.

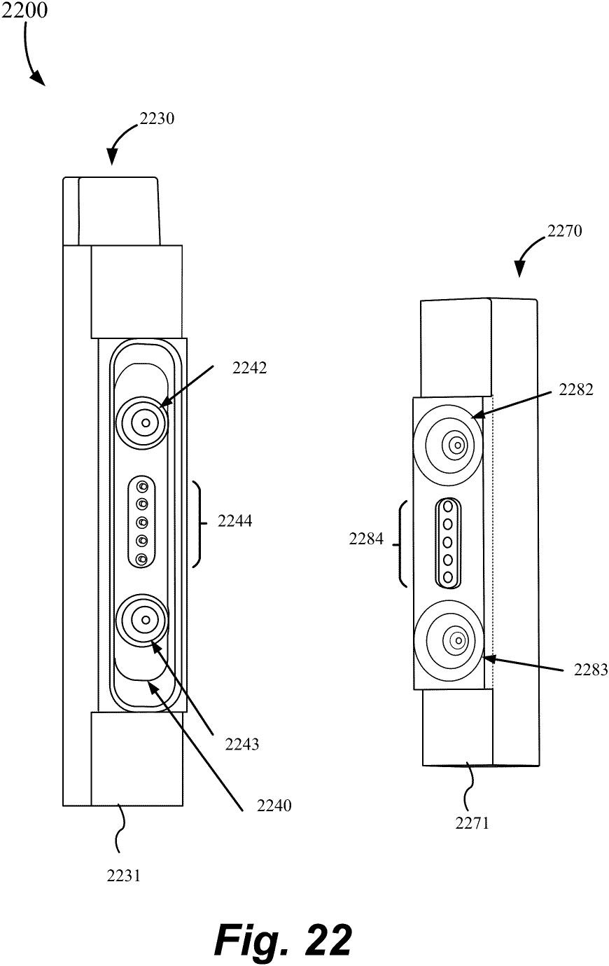

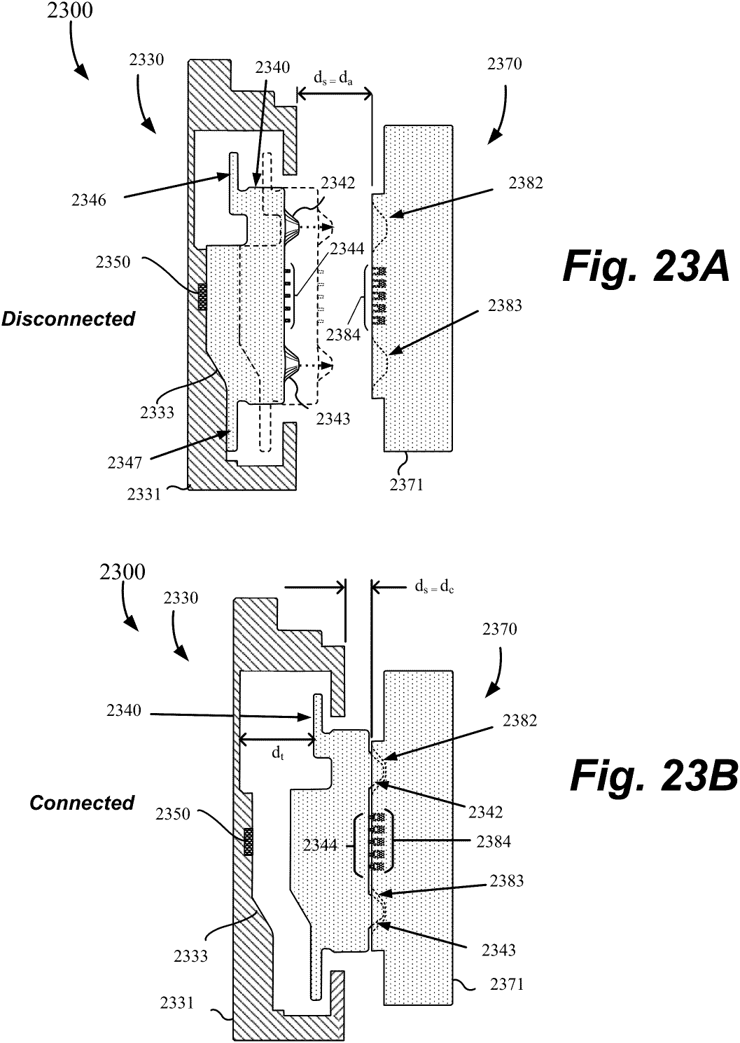

FIG. 22 depicts a schematic illustration of an isometric view of an example of a magnetic power transfer connector 2200, according to embodiments. The magnetic power transfer connector 2200 includes a first component 2230 and a second component 2270 that can be used to establish electrical connection between adjacent doors or windows or between a door or window and a connector in a frame such as in a truck line. The first component 2230 and second component 2270 are opposing connectors that can be placed on similarly located (e.g., horizontally and vertically) portions of adjacent doors or windows. For example, the first component 2230 may be located on a side of detachable door 2012a and second component 2270 may be located on an opposing side of detachable door 2012b in FIG. 21. The first component 2230 includes a housing 2231 and a floating portion 2240 that can float (i.e. translate or rotate freely to at least a certain extent) within the housing 2231. For example, the floating portion 2240 in FIG. 22 can move with six degrees of freedom within the housing 2231 to a certain extent. In other implementations, the floating portion 2240 may have fewer degrees of freedom. The floating portion 2240 can move through an opening in the housing 2231 until a portion of the first component 2230 restricts movement such as by the retaining arms 2346, 2347 shown in FIGS. 23A and 23B.

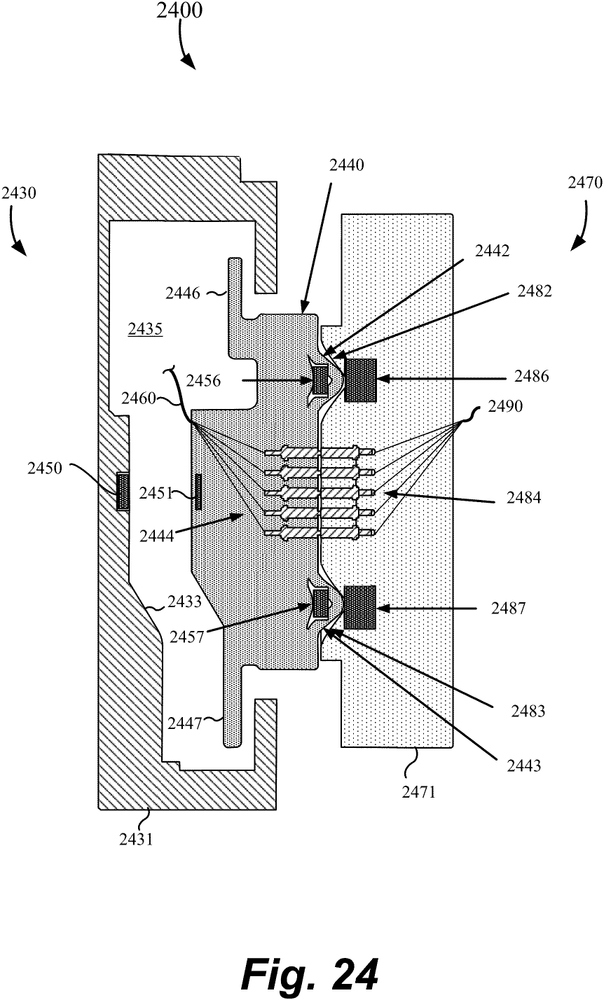

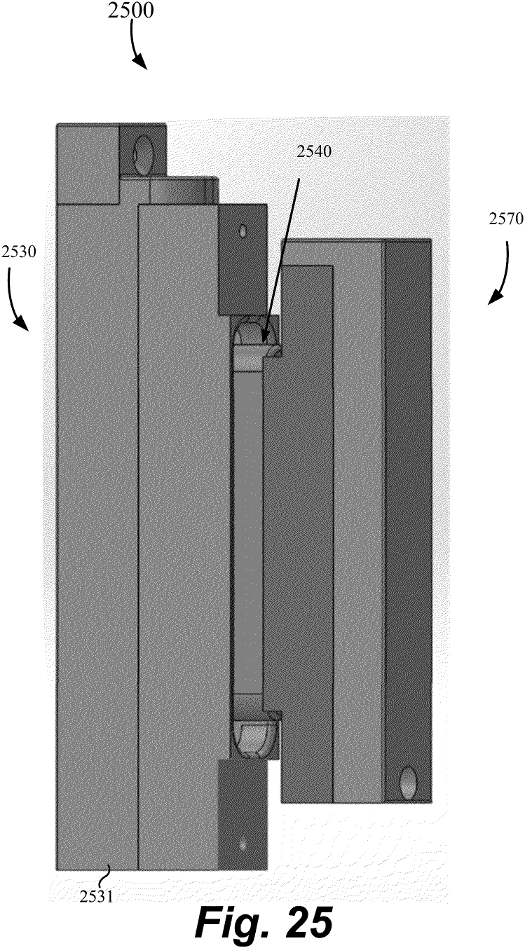

The floating portion 2240 of the first component 2230 also includes a first cone 2242, a second cone 2243, and one or more magnets (e.g., cone magnets 2486, 2487 in FIG. 24). The housing 2231 may also include a retention magnet (e.g., retention magnet 2350 in FIG. 23A) that can hold the floating portion 2240 within the housing 2231 until the first component 2230 is within the actuation distance from the second component 2270. The first component 2230 also includes a plurality of pins 2244. The plurality of pins 2244 may be electrically connected to one or more wires (e.g., wiring 2460 in FIG. 24 or wiring 2560 in FIG. 25A) that may be used to establish electrical communication with one or more devices (e.g., electrochromic devices and/or a window controller). In certain aspects, the one or more wires may be a flexible cable such as a ribbon cable or may be a rigid cable. In one aspect, the one or more wires may be a segment of a trunk line or one or more drop lines. In one aspect, one or more of the magnets of the component 2200 may be neodymium magnets.

The second component 2270 includes a housing 2271 with a first cup 2282 and a second cup 2283. The housing 2271 may also includes one or more magnets (e.g., cup magnets 2456, 2457 in FIG. 24) with opposing polarity to the one or more respective magnets in the floating portion 2240 of the first component 2230. Cups 2282 and 2283 are configured for engagement and alignment to guide the cones of the first component to the magnets within the base of the cup. Cone and cup pairs as described herein may have only one magnet and e.g., a steel counterpart for establishing attractive force, although each having a magnet makes for stronger connection, e.g., neodymium magnets of opposite polarity. The second component 2270 also includes a plurality of pads 2284 that can connect to respective pins 2242 of the first component 2230. The plurality of pads 2284 may be in electrical communication with one or more window controllers. In one aspect, the connection of the plurality of pins 2244 to the plurality of pads 2284 may connect a section or run of a trunk line system (e.g., trunk line 2708 in FIG. 27 or trunk line 2808 in FIG. 28) or drop lines from a trunk to one or more window controllers. In certain aspects, the one or more wires may be a flexible cable such as a ribbon cable or may be a rigid cable. In another implementation, the floating portion 2240 of the first component 2230 may have the plurality of pads 2284 and the second component 2270 may have the plurality of pins 2244. Although the illustrated example depicts the plurality of pins 2244 having five pins and the plurality of pads 2284, in other implementations, more or fewer pins and pads can be used.

In certain implementations, the first and second cones (e.g., first and second cones 2242, 2243) and the first and second cups (e.g., first and second cups 2282, 2283) of the component have curvature that can enable self alignment of the first and second cones within the first and second cups during magnetic actuation. For example, the first and second cups may have a wider maximum (slope) angle at their base than the maximum angle at the base of the first and second cones. That is, the first and second cups may be more open, i.e. a wider cross sectional angle than the first and second cones to allow the first and second cones to self-align with the first and second cups during magnetic actuation. In one aspect, the angle at the base on the first and second cups is equal to or greater than 75 degrees where the angle at the base of the first and second cones is no greater than 50 degrees. In one aspect, the angle at the base on the first and second cups is equal to or greater than 60 degrees where the angle at the base of the first and second cones is no greater than 40 degrees. In one aspect, the angle at the base on the first and second cups is equal to or greater than 45 degrees where the angle at the base of the first and second cones is no greater than 30 degrees. In one embodiment, the cross sectional angle of the cup is at least 5 degrees larger than that of the cone. In one embodiment, the cross sectional angle of the cup is at least 10 degrees larger than that of the cone. In one embodiment, the cross sectional angle of the cup is at least 15 degrees larger than that of the cone. In one embodiment, the cross sectional angle of the cup is at least 20 degrees larger than that of the cone. In one aspect, the angle of the cones and cups may facilitate disconnection in any direction. Although the embodiments described in relation to FIG. 21 have a floating and a fixed component, the cup and/or cone may be on a floating element.

In certain embodiments, a ball and socket are used analogously to the cone and cup, respectively. In one embodiment, the ball is a hemisphere and the socket is a hemispherical depression (concavity). The ball may be at the end of a moveable shaft, or, as described herein part of a floating element. In one embodiment, the circumference of the socket is at least 5% greater than that of the ball. In one embodiment, the circumference of the socket is at least 10% greater than that of the ball. In one embodiment, the circumference of the socket is at least 15% greater than that of the ball. In such embodiments, the ball is configured to be able to make contact with the base of the socket for the magnetic engagement.

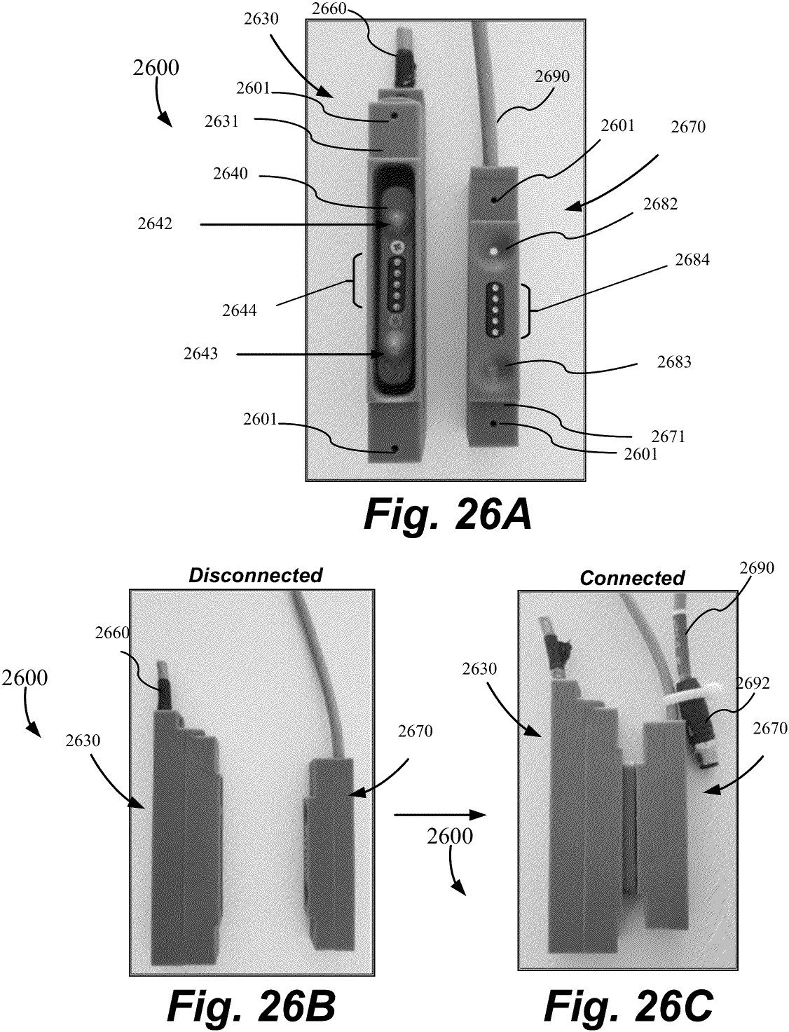

One or both of the first component and second component of an component may be located in a secondary seal of an insulated glass unit. Alternatively, one or both of the component and second component may be located in a movable frame around an insulated glass unit. In one aspect, the one or both of the first component or second component may have one or more apertures (e.g., apertures 2601 in FIGS. 26A-26C) for set fasteners such as set screws for adjusting their location, for example, to be able to mate with an opposing component. Although some examples are described with respect to the first component being located in a movable frame or insulated glass unit of the door or window and a second component being located in a wall or in a movable frame of the door or window, in another implementation, the first component may located in the wall or movable frame of the door or window and the second component may be located in the movable frame or insulated glass unit of the door or window.

FIGS. 23A and 23B depict schematic illustrations of an isometric view of an example of an magnetic power transfer connector 2400 in a disconnected position and a connected position respectively, according to embodiments. The magnetic power transfer connector 2300 includes a first component 2330 and a second component 2370 that can be used to establish electrical connection, e.g., between adjacent doors or windows or between a door or window and a connector in a frame such as in a truck line. The first component 2330 and second component 2370 may be similar to the first component 2230 and second component 2270 in FIG. 22.

The first component 2330 includes a housing 2331 and a floating portion 2340. The floating portion 2340 includes a first cone 2342, a second cone 2343, a first retainer arm 2346, a second retainer arm 2347, and a plurality of pins 2344. The floating portion 2340 can float within an internal space of the housing 2331. For example, the floating portion 2340 may be able to move with six degrees of freedom within the housing 2331 until the first retainer arm 2346 and second retainer arm 2347 restrict the movement of floating portion 2340. In other implementations, the floating portion 2340 may have fewer degrees of freedom. The floating portion 2340 also includes one or more magnets at or near the cones (e.g., cone magnets 2486, 2487 in FIG. 24). The housing 2331 also includes a first retention magnet 2350. The floating portion 2340 may also include a metal piece or a second retention magnet (e.g., second retention magnet 2451 in FIG. 24) with opposite polarity from the first retention magnet 2350. The first retention magnet 2350 and the second retention magnet or metal may hold the floating portion 2340 within the housing 2331 while the first component 2430 is within the actuation distance from the second component 2470. Retaining the floating portion 2340 within the housing 2331 may help protect the plurality of pins 2344. The plurality of pins 2344 may be electrically connected to one or more wires (e.g., wiring 2460 in FIG. 24 or wiring 2560 in FIG. 25A) that may be used to establish electrical communication with one or more devices (e.g., electrochromic devices in an IGU and/or a window controller). In certain aspects, the one or more wires may be a flexible cable such as a ribbon cable or may be a rigid cable. In one aspect, the one or more wires may be a segment of a trunk line or one or more drop lines.

The housing 2331 also includes a ramp 2333 that may help center the floating portion 2340 during disconnection. When the first component 2330 is moved away from the second component 2370 by more than the magnetic actuation distance, the floating portion 2340 is released and a magnetic retention by the first retention magnet 2350 retracts the floating portion 2340 back into the housing 2331. The ramp 2333 can center the floating portion 2340 within the housing 2331 during disconnection. In other implementations, the first component 2330 omits the ramp 2333.

The second component 2370 includes a housing 2371 with a first cup 2382 and a second cup 2383 that has a flatter curvature than the curvature of the first cone 2342 and the second cone 2343 respectively. The housing 2371 also includes one or more magnets (e.g., cup magnets 2456, 2457 in FIG. 24) with opposing polarity to the one or more respective magnets in the floating portion 2340 of the first component 2330. The second component 2370 also includes a plurality of pads 2384 that can connect to respective pins 2344 of the first component 2330. The plurality of pads 2384 may be in electrical communication with one or more window controllers. In one aspect, the connection of the plurality of pins 2344 to the plurality of pads 2384 may connect a section or run of a trunk line system (e.g., trunk line 2708 in FIG. 27 or trunk line 2808 in FIG. 28) or one or more drop lines. As such, MPT connectors as described herein allow flexibility in connecting trunk line power and communication networks, e.g., the trunk line is reversibly engaged via operables such as windows and doors. In certain aspects, the one or more wires may be a flexible cable such as a ribbon cable or may be a rigid cable. In another implementation, the floating portion 2340 of the first component 2330 may have the plurality of pads 2384 and the second component 2370 may have the plurality of pins 2344. Although the illustrated example depicts the plurality of pins 2344 having five pins and the plurality of pads 2384 having five pads, in other implementations, more or fewer pins and pads can be used.

In FIGS. 23A and 23B, the distance of separation between the front of the housing 2331 of the first component 2230 and the front of the housing 2371 of the second component is the separation distance, dₛ. FIG. 23A depicts the magnetic power transfer connector 2300 in a disconnected state as the first component 2330 is being brought within an actuation distance, dₐ, of the second component 2380. Once the first component 2230 is within the actuation distance, dₐ, of the second component 2370, the magnetic force between the one or more magnets at or near the first cone 2342 and second cone 2343 (e.g., first and second cone magnets 2456 and 2457) and the one or more magnets at or near the first cup 2382 and second cone 2384 (e.g., first and second cup magnets 2486 and 2487) is greater than the magnetic force between the first retention magnet 2350 and the metal or second retention magnet in the floating portion 2240 releasing the floating portion 2240 from the first retention magnet 2350. The magnetic force can also move the floating portion 2240 at least partially through the opening in the housing 2331 until movement is restricted by the first retainer arm 2346 and second retainer arm 2347 contacting the inner lip of the housing 2331. As the first component 2330 is being brought closer to the second component 2380 at a distance of less than the actuation distance, dₐ, the first cone 2342 and second cone 2343 self align to the first cup 2382 and to the second cup 2383 respectively, which aligns the plurality of pins 2344 with the plurality of pads 2384. The magnetic force between the one or more magnets at or near the first cone 2342 and second cone 2343 and the one or more magnets at or near the first cup 2382 and second cup 2383 causes the plurality of pins 2344 to engage with the plurality of pads 2384. In one aspect, one or more of the magnets of the magnetic power transfer connector 2300 may be neodymium magnets. In one embodiment, the actuation distance is 2 inches or less. In one embodiment, the actuation distance is 1.5 inches or less. In one embodiment, the actuation distance is 1 inch or less. In one embodiment, the actuation distance is 0.75 inches or less. In one embodiment, the actuation distance is 0.5 inches or less. In one embodiment, the actuation distance is 0.25 inches or less.

FIG. 23B depicts the magnetic power transfer connector in a connected position. Engagement of the pins with the pads may occur when the separation distance dₛ between the MPT connector components is equal to or less than the connection distance, d_{c}. In one aspect, connection between the pins and the pads may occur when the separation distance dₛ is equal to, or less than, a connection distance, d_{c}, of 4.5 mm. The distance that the floating portion 2340 translates to connect engage pins with pads is a travel distance, dₜ. The first retainer arm and second retainer arm may restrict the travel distance, dₜ, of the floating portion to a maximum distance at which point the first component and second component disengage (disconnect) the pins from the pads. The distance of separation between the front of the housing of the first component and the front of the housing of the second component before the first retainer arm and second retainer arm disconnect the first component from the second component is the disconnection distance, d_{d}. Disconnection may occur when the separation between the front of the housing of the first component and the front of the housing of the second component is equal to or greater than the disconnection distance, d_{d}. In one aspect, disconnection between the pins and the pads may occur when the separation distance dₛ is equal to or greater than a disconnection distance d_{d}, of 8 mm. In one aspect, the disconnection distance d_{d}, may be the maximum distance the retaining arms can travel within the housing of the first component.

FIG. 24 is a sectional view of an example of a magnetic power transfer connector 2400 in a connected position, according to embodiments. The magnetic power transfer connector 2300 includes a first component 2430 and a second component 2470 that can be used to establish electrical connection, e.g., between adjacent doors or windows or between a door or window and a connector in a frame such as in a truck line. The first component 2430 and second component 2470 may be similar to the first component 2330 and second component 2370 in FIG. 23.

The first component 2430 includes a housing 2431 and a floating portion 2440. The floating portion 2440 includes a first cone 2442, a second cone 2443, a first retainer arm 2446, a second retainer arm 2447, and a plurality of pins 2444. The floating portion 2440 can float within an internal space 2435 of the housing 2431. For example, the floating portion 2440 may be able to move with six degrees of freedom within the housing 2431 until the first retainer arm 2446 and second retainer arm 2447 restrict the travel distance, dₜ, of floating portion 2440. In other implementations, the floating portion 2440 may have fewer degrees of freedom. The floating portion 2440 also includes a first cone magnet 2486 and a second cone magnet 2487 in respective cones. The housing 2431 also includes a first retention magnet 2450 and the floating portion 2440 includes a second retention magnet 2451 with opposite polarity from the first retention magnet 2450. The first retention magnet 2450 and the second retention magnet 2451 may hold the floating portion 2440 within the housing 2431 while the first component 2430 is within the actuation distance from the second component 2470. The plurality of pins 2444 are electrically connected to wiring 2460 that may be used to establish electrical communication with one or more devices (e.g., electrochromic devices in an IGU and/or a window controller). In certain aspects, the wiring 2460 may be a flexible cable such as a ribbon cable or may be a rigid cable. In one aspect, the one or more wires may be a segment of a trunk line or one or more drop lines.

When the first component 2430 and the second component 2470 are moved away from each other by more than the disconnect distance, d_{d}, the first retainer arm 2446 and the second retainer arm 2447 hold the floating portion 2440 in place and the plurality of pins 2444 disengage with the plurality of pads 2484. The magnetic force between the first retention magnet 2450 and the second retention magnet 2451 bring the floating portion 2440 back within the housing 2431 in a magnetic return. The housing 2431 also includes a ramp 2433 and the floating portion 2430 includes an opposing ramp that may facilitate centering the floating portion 2440 during disconnection and magnetic return. In other implementations, the first component 2430 omits the ramp 2433.

The second component 2470 includes a housing 2471 with a first cup 2482 and a second cup 2483 that have flatter curvature than the curvature of the first cone 2442 and the second cone 2443 respectively for self-alignment during magnetic actuation. The housing 2471 also includes a first cup magnet 2456 and a second cup magnet 2457 of opposite polarity from the first cone magnet 2456 and second cone magnet 2457. The second component 2470 also includes a plurality of pads 2484 that can connect to respective pins 2444 of the first component 2430. The plurality of pads 2484 are electrically connected to wiring 2490 that may be in electrical communication with one or more window controllers and/or may be a segment of a trunk line or a drop line. In one aspect, the connection of the plurality of pins 2444 and the plurality of pads 2484 may connect a section or run of a trunk line system (e.g., trunk line 2708 in FIG. 27 or trunk line 2808 in FIG. 28) or one or more drop lines. In certain aspects, the wiring 2490 may be a flexible cable such as a ribbon cable or may be a rigid cable. In another implementation, the floating portion 2440 of the first component 2430 may have the plurality of pads 2484 and the second component 2470 may have the plurality of pins 2444. Although the illustrated example depicts the plurality of pins 2444 having five pins and the plurality of pads 2484 having five pads, in other implementations, more or fewer pins and pads can be used. In one aspect, one or more of the magnets of the magnetic power transfer connector 2400 may be neodymium magnets.

FIG. 25 depicts a schematic illustration of an isometric view of an example of a magnetic power transfer connector 2500, according to embodiments. The magnetic power transfer connector 2500 includes a first component 2530 and a second component 2570. The first component 2530 and second component 2570 may have features similar to those described with respect to the first component 2430 and a second component 2470 in FIG. 24. The first component 2530 includes a housing 2531 and a floating portion 2540. The magnetic power transfer connector 2500 is depicted in a connected position with the floating portion 2540 partially located outside the housing 2571.

FIGS. 26A-26B depict photographs of an example of a magnetic power transfer connector 2600 according to embodiments. FIG. 26B depicts the magnetic power transfer connector 2600 in a disconnected position and FIG. 26C depicts the magnetic power transfer connector 2600 in a connected position. The magnetic power transfer connector 2600 includes a first component 2630 and a second component 2670. The first component 2630 and second component 2670 may be similar to the first component 2430 and second component 2470 in FIG. 24.

The first component 2630 includes a housing 2631 and a floating portion 2640. The floating portion 2640 includes a first cone 2642, a second cone 2643, and a plurality of pins 2644. The floating portion 2640 can float within an internal space of the housing 2631. For example, the floating portion 2640 may be able to move with six degrees of freedom within the housing 2631 until one or more retainer arms or other structure restricts movement. In other implementations, the floating portion 2640 may have fewer degrees of freedom. The floating portion 2640 also includes one or more magnets at or near the cones (e.g., cone magnets 2486, 2487 in FIG. 24). The housing 2631 also includes a first retention magnet 2650. The floating portion 2640 may also include a metal piece or a second retention magnet (e.g., second retention magnet 2451 in FIG. 24) with opposite polarity from the first retention magnet 2650. The first component 2630 also includes wiring 2660 electrically connected to the plurality of pins 2644. In this example, the wiring 2660 is a cable. In another implementation, the wiring 2660 may be a flexible cable such as a ribbon cable. The second component 2670 includes a housing 2671 with a first cup 2682 and a second cup 2683 that has a flatter curvature than the curvature of the first cone 2642 and the second cone 2643 respectively. The housing 2671 also includes one or more magnets (e.g., cup magnets 2456, 2457 in FIG. 24) with opposing polarity to the one or more respective magnets in the floating portion 2640 of the first component 2630. The second component 2670 also includes a plurality of pads 2684 that can connect to respective pins 2644 of the first component 2630. The second component 2670 also includes wiring 2690 electrically connected to the plurality of pads 2684. In this example, the wiring 2690 is a cable. In another implementation, the wiring 2690 may be a flexible cable such as a ribbon cable. Although the illustrated example depicts the plurality of pins 2644 having five pins and the plurality of pads 2684 having five pads, in other implementations, more or fewer pins and pads can be used. The first and second components 2630 and 2670 also have apertures 2601 for an adjustment fastener such as a set screw for adjusting their position.

In one implementation, a sliding door or window (e.g., detachable doors 2101a-c shown in FIG. 21) includes an insulated glass unit, a movable frame incorporating the insulated glass unit, and a first component (e.g., first component 2430) and a second component (e.g., first MPT component 2470) of an MPT connector on opposite sides of a movable frame. The first component and second component of the MPT connector may be located within the movable frame or within the secondary seal of the insulated glass unit. When the first component is located at a greater than actuation distance from a second component, the first and second components of the MPT connector remain disconnected and flush with the edge of the movable frame. When the detachable door is moved within the actuation distance of another opposing component of an MPT connector, the magnetic force from magnets in the opposing component pulls the floating portion to engage the pins and pads of the first and second components establishing electrical connection. The first component and second component of an MPT connector may remain connected at a distance equal to the connection distance, d_{c}, without direct contact between the housing of the first component and the housing of the second component. The magnetic actuation of the floating portion bridges the connection distance to engage the pins with the pads. The magnetic actuation of the floating portion may also allow the pins to remain within the housing when in the disconnected state which may protect the exposed contacts and/or may maintain a flush surface with the movable frame. Only when the door is closed such that the first and second components are within actuation distance does the floating portion with the plurality of pins protrude from the movable frame to engage the pins with the pads. The cones and cups may guide the pins into the correspond position to engage with the pads.

In certain implementations, an MPT connector can be implemented in either inline or in parallel (stacking) sliding doors or windows. For example, the first component of an MPT connector of a door or window may connect the second component of an MPT connector in another door or window where both are sliding inline. In a stacking example, a first component and second component of an MPT connector may be directed outward from opposing faces of the doors or windows sliding laterally past one another such that when the doors or windows are closed the mullions overlap and the first and second components connect. When sliding past one another, the floating portion of the first component is retained within the housing and housings of the first and second components of the MPT connector are flush or within the movable frame to allow the doors or windows to slide over the MPT connector components. In addition, if a pad is pulled laterally, the cones may push the pin back into the housing, and may disconnect the first component from the second component, which may facilitate use in parallel sliding doors.

FIG. 27 depicts a network of electrochromic windows or doors and controllers. In network 2700, a bus enables setting and monitoring individual window 2701 parameters and relaying that information to a network controller 2706. In one embodiment, the bus includes a trunk line 2708 and electrical connectors 2704 (which may e.g., take the form of “T” or “Y” connectors). In one embodiment, the trunk line includes a 5-conductor cable with two electrical conductors that provide power signals, two electrical conductors that provide communication signals, and one conductor that provides ground. In other embodiments, a cable with fewer or more electrical conductors can be used if so desired or needed. In one embodiment, the connectors 2704 are MPT connectors as described herein. In one embodiment, connectors 2704 physically and electrically connect trunk line segments 2703 together to form trunk line 2708. In one embodiment, signals carried by trunk line 2708 are distributed to respective window controllers (WC) 2702 via respective connectors 2704 and respective drop lines 2705 connected to the connectors. Although FIG. 27 represents controllers 2702 as being spatially separated from respective windows or doors 2701, it is to be understood that in other embodiments, one or more of the controllers could be integrated in or as part of a respective window or door. In one embodiment, during initial installation or after installation of the trunk line, one or more additional connector 2707 is connected to form trunk line 2708. After installation, additional connector 2707 can be left unconnected until needed, for example, for use with a drop line, a controller, a power supply, or with a tester. Correct operation and connection of an installed network of electrochromic windows or doors, controllers, connectors, and trunk and drop lines can be verified during commissioning.

FIG. 28 depicts an example of a trunk line 2808. In other implementations, a trunk line includes trunk line segments joined by electrical connectors coupled to window controllers by drop lines. In FIG. 28, the trunk line 2808 includes trunk line segments 2803 coupled in series by electrical connectors 2804 that include or are coupled directly to window controllers, each of which in turn is connected to a window 2801 or door. In one embodiment, electrical connectors 2804 contain a window controller. In one embodiment, electrical connectors 2804 are MPT connectors and contain a window controller. In the latter case, not every connector 2804 need have a window controller as a single window controller may control up to, e.g., four or more windows. Use of electrical connectors 2804 can facilitate quicker installation and commissioning of windows in a building because it obviates the time needed to connect a controller to the drop line as shown in FIG. 28. Although the illustrated examples in FIGS. 27 and 28 are describe with respect to windows, it would be understood that, doors or a combination of one or more doors and one or more windows may be implemented. Other examples of trunk lines and window controller may be found in international PCT application PCT/US2020/070427, titled “TRUNK LINE WINDOW CONTROLLERS” and filed on Aug. 18, 2020, which is hereby incorporated by reference in its entirety.

In one aspect, there is no wiring to individual framed electrochromic doors or windows in a trunk line system. Instead, MPT connectors embedded in the doors or window frames are used to connect a section or a run of the trunk line system. For instance, a trunk line system may have a run that goes around a portion of the floor of a building. At a section along a wall with doors such as depicted in FIG. 21 and/or no room in the ceiling for a trunk line, the trunk line may have a run through the frames of the doors and MPT connectors may be used connect the trunk line segments in the doors or windows. In another embodiment, the window controller drop lines (e.g., cables) for a series of windows or doors enter at one end of a first window, then progressively there is one less drop line in each frame until the last frame where there is only one drop line and MPT connector. The first in the series of frames may have multiple MPT connectors, e.g., one for each drop line, or, a single MPT connector may accommodate many drop lines.

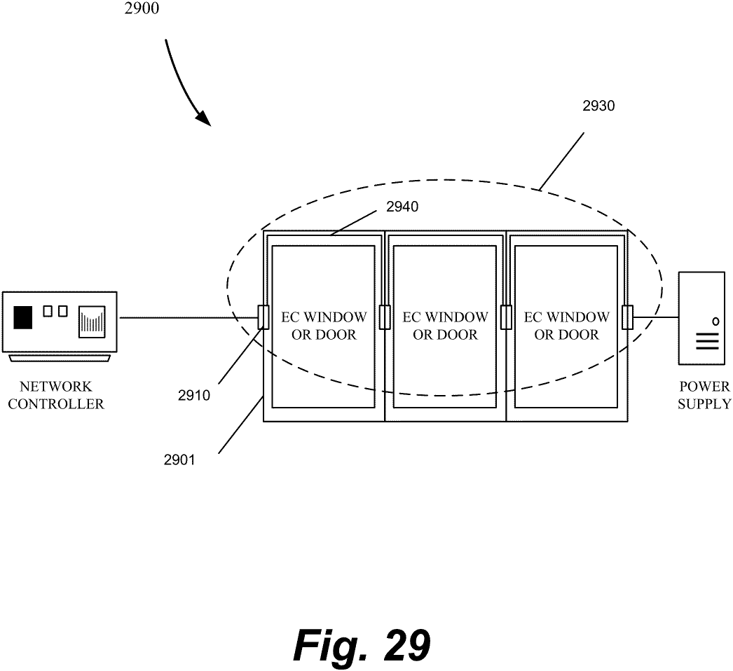

FIG. 29 is a schematic drawing of a trunk line system 2900, according to an implementation. The trunk line system 2900 includes a plurality of electrochromic windows or doors 2901. Each electrochromic windows or doors 2901 has a first component of an MPT connector 2910 and a second component of an MPT connector embedded in a door frame on opposite sides to abut with and connect to opposing components of an adjacent electrochromic door or window. The MPT connectors 2910 may be similar to the MPT connectors described with respect to any one of FIGS. 21-28. The MPT connectors 2910 between adjacent electrochromic windows or doors 2901 establish a connection between trunk line segments 2940 in a run of a trunk line 2930. The trunk line segments are within the frame of the electrochromic windows or doors 2901. In one example, the trunk line segments 2930 may include a 5-conductor cable with two electrical conductors that provide power signals, two electrical conductors that provide communication signals, and one conductor that provides ground. The power supply in FIG. 29 is depicted as downstream of the network controller, but it also may be on the same side of the bank of windows as the network controller. Window controllers in such systems embedded in the operable door or window may include an onboard battery, wireless power and/or communication capability for when the operable is disengaged from the MPT connector.

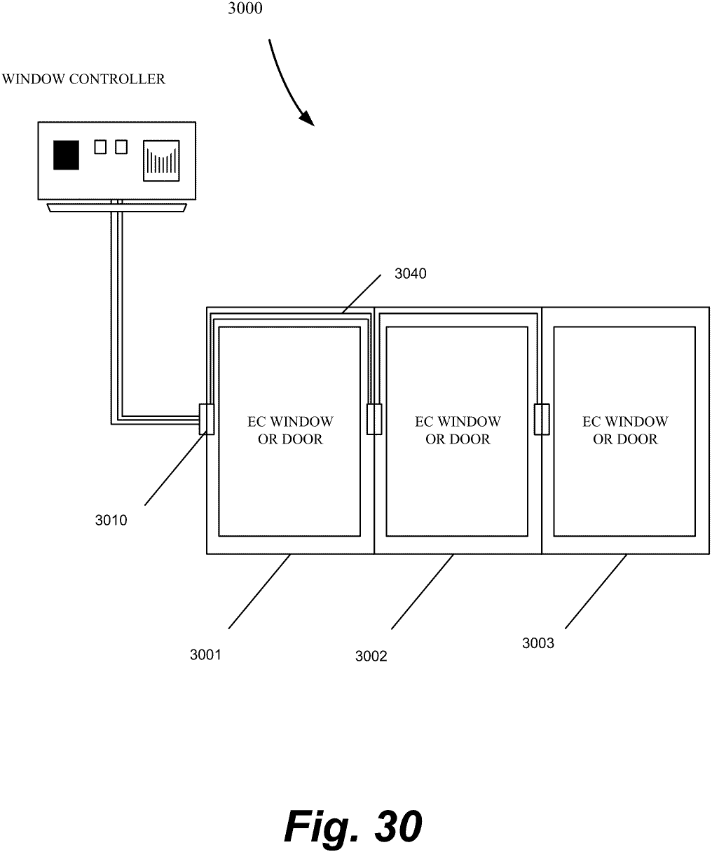

FIG. 30 is a schematic drawing of a trunk line system 3000, according to an implementation. The trunk line system 3000 includes a first electrochromic window or door 3001, a second electrochromic window or door 3002, and a third electrochromic window or door 3003. Each of the electrochromic windows or doors 3001, 3002, 3003 has a first component of an MPT connector 3010 embedded in a door frame. The first and second electrochromic windows or doors 3001, 3002 also have a second component of an MPT connector 3010 embedded in a door frame. The MPT connectors 3010 may be similar to the MPT connectors described with respect to any one of FIGS. 21-28. In the illustrated example, all the drop lines 3040 from the window controller for the electrochromic windows or doors 3001, 3002, 3003 enter at one end of the first electrochromic window or door 3001. The drop lines 3040 pass through the frame between components of the MPT connector 3010 within the frame. Progressively there is one less drop line 3040 in each frame until the last frame of the third door where there is only one drop line 3040 and MPT connector component. In the illustrated example, the first window or door 3001 include a single MPT connector that accommodates all the drop lines 3040 of the plurality of electrochromic windows or doors. In another implementation, the first window or door 3001 may have multiple MPT connectors, e.g., one for each drop line. Window controllers in such systems may include an onboard battery, wireless power and/or communication capability for when the operable is disengaged from the MPT connector.

### Detachable Power Transfer (DPT) Connectors

In certain implementations, a movable window or door (e.g., movable door 900m, detachable doors 2101a-d, movable frame 705, movable frames 805, 807, movable frame 925, movable frame 935, movable door 921, movable doors 1901b-e, movable doors 1993b-e, movable doors 1997b-e, movable doors 2001b-e, EC windows 2701, EC windows 2801, EC windows 2901, and EC window/door 3001, 3002, and 3003, etc.) may have an electrical connector that can establish electrical connection when the window or door is closed and break the electrical connection when opened. The electrical connector may be used to provide electrical connectivity between the movable door or window and another electrical connector in a building such as in a truck line (e.g., trunk lines 2708 and 2808 shown in FIGS. 27 and 28) or between adjacent doors (e.g., detachable doors 2102a-d in FIG. 21) or windows. In some cases, the electrical connector may have five (5) electrical contacts that connect to five electrical conductors: two electrical conductors for providing power, two electrical conductors for data transfer, and one electrical conductor for a shielding or other grounding connection. For example, an electrical connector may have five (5) electrical contacts in electrical communication with two voltage wires (a V- voltage wire and a V+ voltage wire) to provide power, one shielding or other grounding wire, one wire employed to determine wire length between the electrical connector and a movable window or door, and one wire for data transfer, e.g., from a memory chip attached to the movable window or door. In one aspect, a wire of the electrical connector is configured to determine the wire length between the electrical connector and the movable window or door. For example, the wire may be in electrical connection with a memory chip at the window or door and loop back to the window controller. A test voltage may be sent through this wire to determine a voltage drop in order to determine impedance associated with the wire length. The impedance may be used to determine an appropriate offset voltage to apply to one or more devices in or on the movable window or door such as, for example, when tinting an electrochromic device. Some examples of electrical connectors have five active electrical contacts that include magnetic power transfer connector 2200 in FIG. 24 with five pins 2244 (e.g., pogo pins) and corresponding pads 2284, magnetic power transfer connector 2300 in FIGS. 23A and 23B with five pins 2344 and corresponding pads 2384, magnetic power transfer connector 2400 in FIG. 24 with five pins 2444 and corresponding pads 2484, and magnetic power transfer connector 2600 shown in FIG. 26A with five pins 2644 and corresponding pads 2684. Electrical connectors with five active conductor contacts can sometimes have a large footprint that may make them difficult to install in, for example, a movable window or door.

Certain embodiments pertain to detachable power transfer (DPT) connectors that include only two active contacts (e.g., a V- voltage contact and a V+ voltage contact) for providing power to a movable window or a movable door. With only two active contacts, DPT connectors allow for a narrower footprint, which makes them easier to install in a wider variety of movable window or door configurations. In addition, such a mechanism that can establish electrical contact at only two active contacts can be simpler and less expensive to fabricate than an electrical connector having more active contacts.

A DPT connector may be employed, for example, to establish electrical connection between the movable door or window and another electrical connector in a frame of a building such as, e.g., a connector to a trunk line or a connector to an adjacent door or window. A DPT connector typically has a narrow footprint and the window or door side component can be installed, for example, in a recess within an IGU of the window or door. In one aspect, a DPT connector is between 0.25 inches and 1.5 inches wide. In another aspect, a DPT connector is between 0.50 inches and 1.5 inches wide. In another aspect, a DPT connector is between 0.25 inches and 3.0 inches wide. In one aspect, a DPT connector is about 0.25 inches wide.

In certain implementations, a DPT connector includes two halves: (i) a frame-side component attached to a frame structure of a building such as, e.g., a sash, sill, transom, etc. and (ii) a door side or window side component attached to a movable door or window. An example of a frame-side component is attached to a sash of a building (also referred to as a sash-side component. Each half of the DPT connector may include only two active conductive elements. The two active conductive elements of the frame-side component are configured to contact the two active conductive elements of the door or window side component when the door or window is in the closed position. When these active conductive elements contact each other in the closed position, power is provided to the door or window. For example, both the frame-side component and the door or window side component may have a first conductive element in electrical communication with a positive voltage potential conductor (e.g., a V+ voltage wire in electrical communication with a power supply) and a second conductive element in electrical communication with a negative voltage potential conductor (e.g., a V- voltage wire in electrical communication with a power supply). The first conductive element on the frame-side component may contact the first conductive element on the door window side component and the second conductive element on the frame-side component may contact the second conductive element on the door or window side component when in the closed position. When the window door moves into the closed position, the two halves contact each other at their respective conductive elements establishing electrically connection to the power supply.

The frame-side component (e.g., a sash-side component) of the DPT connector may be configured to attach to framing of a building or other structure. For example, a frame-side component may include a housing that fits at least partially into, e.g., into a recess of, a sash or other framing structure of a building. In another example, a frame-side component may attach to an outside surface of the framing structure. The housing and other components of a frame-side component may be made of, or coated by, an electrically insulating material such as an electrically insulating foam.

The door window side component of the DPT connector may be configured to attach to the movable door or window. For example, the door window side component may include a housing that fits at least partially into, e.g., into a recess of, a frame around the door or window. As another example, a housing of the door window side component may attach to the outside of the frame. The housing and other components of the window/door side component may be made of, or coated by, an electrically insulating material such as an electrically insulating foam. In one implementation, the components of the frame-side component and window or door side component are made of, or coated by, an electrically insulating material except for the two active conductive elements.

In some cases, a DPT connector includes a memory chip or an integrated circuit device (sometimes referred herein to as “memory”). In one example, the memory chip or integrated circuit device is located outside the housing of the frame-side component within the framing structure (e.g., a sash) of a building. In another example, the memory chip or an integrated circuit device may be housed within the frame-side component. The memory chip or integrated circuit device may be programmed to store the wire length between the DPT connector and an IGU of the movable window/door. Additionally or alternatively, the memory or integrated circuit device may be programmed with other window/door information or logic that, e.g., identifies the window/door or IGU, the optically switchable device architecture, the drive parameters, the window/door geometry, etc.

The memory chip or integrated circuit device may be programmed using, for example, a programming tool. The memory chip or integrated circuit device may be programmed, for example, on-site (e.g., at the site of the building in which the window or door is installed). The memory or integrated circuit device may be programmed when the window/door is being installed in the building during or after commissioning. Alternatively, the memory or integrated circuit device may be programmed at the factory during assembly of the DPT connector.

For example, at the site of a building, a programmer may use a programming tool to connect to an electrical connector attached to the window or door that has, or is in communication with, a memory chip or integrated circuit in order to read the window or door identification and other window characteristics from memory. The programmer can then connect the programming tool to another electrical connector in communication with another memory chip attached to, or in, the frame-side component of the DPT connector to program window characteristics into memory at the at the frame-side component. For example, the wire length associated with the window or door may be programmed into memory at the frame-side component to determine the corresponding voltage or current to provide to the window or door. As another example, the frame-side component of the DPT connector may have a field settable resistor that can be set (e.g., using a switch) to a resistance level that corresponds to the length of the wire connection between the frame-side component and the insulated glass unit. For instance, the field settable resistor may have a plurality of settings of different resistance levels that correspond to different wire lengths (e.g., 1 foot, 2 feet, 3 feet, etc.).

In some cases, the frame-side component may have two active spring-loaded conductive elements that are electrically connected (e.g., via pogo pins and other electrically conductive elements) to two electrical conductors (e.g., wires) in electrical communication with one or more devices. For example, the two active spring-loaded conductive elements may be in electrical communication with a memory chip or integrated circuit device and one or more window controllers in electrical communication (e.g., via one or more electrical conductors such as wires and electrical connectors) with a power supply. In some instances, a memory chip or integrated circuit may be embedded in an electrical connector such as, for example, a M8K connector.

In one implementation, the frame-side component includes two spring-loaded articulating tabs of electrically conductive material. In some cases, the two spring-loaded articulating tabs are electrically connected to a power source in order to provide positive voltage and negative voltage potentials respectively to, e.g., two bus bars of opposite polarity of an electrochromic device. The two spring-loaded articulating tabs may include rollers or wheels at their distal ends. Each spring-loaded articulating tab is in contact with one or more springs. When the door or window is in a closed position, the one or more springs are compressed providing a force to the spring-loaded articulating tabs that provides a pressure at the rollers or wheels to facilitate maintaining electrical contact with the electrical contacts at the window or door side component of the DPT connector.

In another implementation, the frame-side component includes two spring-loaded rollers or wheels of electrically conductive material. Each spring-loaded wheel/roller is in contact with one or more springs. When the door or window is a closed position, the one or more springs are compressed providing a force to the spring-loaded rollers or wheels that provides a pressure at the rollers or wheels to facilitate maintaining electrical contact with the contacts at the window or door side component of the DPT connector.

In some cases, the door side or window side component has two active conductive elements electrically connected (e.g., with pogo pins and other electrically conductive elements) to electrical conductors (e.g., wires and/or electrical connectors) in electrical communication with one or more devices at an insulated glass unit of the movable door or window. For example, a DPT connector may have two active conductive elements in the form of two contact pads of electrically conductive material. In one aspect, the two pads fit within one or more recesses in a housing. In some cases, one or more contact pads of a DPT connector may be made of metal (e.g., copper, nickel, gold, or silver) or plated with metal (e.g., gold-plated, silver-plated, nickel-plated, copper-plated, etc.). In other cases, the contact pads may be made of carbon or (e.g., carbon brushes or woven carbon fibers, e.g., in the form of a compressible tube) or other conductive material.

In certain implementations, the spring-loaded conductive elements (e.g., articulating arms, wheels or rollers, etc.) on the frame-side component of a DPT connector may be made of metal (e.g., copper, nickel, gold, or silver) or may be plated with metal (e.g., gold-plated, silver-plated, nickel-plated, copper-plated, etc.). In other embodiments, the spring-loaded conductive elements may be made of carbon (e.g., carbon brushes or woven carbon fibers such as, e.g., in the form of compressible carbon tubes) or other conductive material.

In one implementation, the contact pads and/or spring-loaded conductive elements of a DPT connector include carbon brushes at least at an interfacing surface between the components. The motion of the movable window or door can serve to clean the interfacing surfaces between the contact pads and the spring-loaded conductive elements to maintain electrical connectivity at the interface.

In some cases, the contact pads of a DPT connector may be made of a compliant material that can be conformal to provide sufficient contact surface area for electrical connectivity. Some examples of compliant materials include a woven metallic fabric, materials including conductive elastomers, thin metal foil, and like materials with electrically conductive and conformal properties. In addition, or alternatively, the contact pads may include one or more structures that aid in providing electrically conductive contact surfaces. Some examples of such structures are carbon bristles and one or more springs.

In certain spring-loaded implementations, the door side or window side component may have at least one ramp that facilitates the displacement of the springs in the spring-loaded conductive elements (e.g., articulating tabs, rollers, or wheels) of the frame-side component to aid in making contact, and/or disengaging from contact, with contact pads on the door side or window side component. For example, when the two halves of the DPT connector come together as the window or door moves from an open position to a closed position, the spring-loaded conductive elements may move up a leading edge ramp allowing springs to gradually compress. In another example, when the two halves move apart as the window or door moves from the closed position to the open position, the spring-loaded conductive elements move down a trailing edge ramp allowing the springs to gradually expand. In one implementation, the frame-side component may have a housing that includes a leading edge ramp and/or a trailing edge ramp. The housing may also have one or more recesses within which one or more contact pads are located. As the window or door moves to a closed position, the spring-loaded conductive elements of the frame-side component move (e.g., roll or slide) up the leading edge ramp, which compresses the springs and provides a force at the distal ends of the spring-loaded conductive elements to facilitate making contact with contact pads on the door side or window side component. When the window or door is in the closed position, the spring-loaded conductive elements contact the two contact pads, and the springs provide pressure to the distal ends of the spring-loaded conductive elements to maintain electrical connectivity with the contact pads.

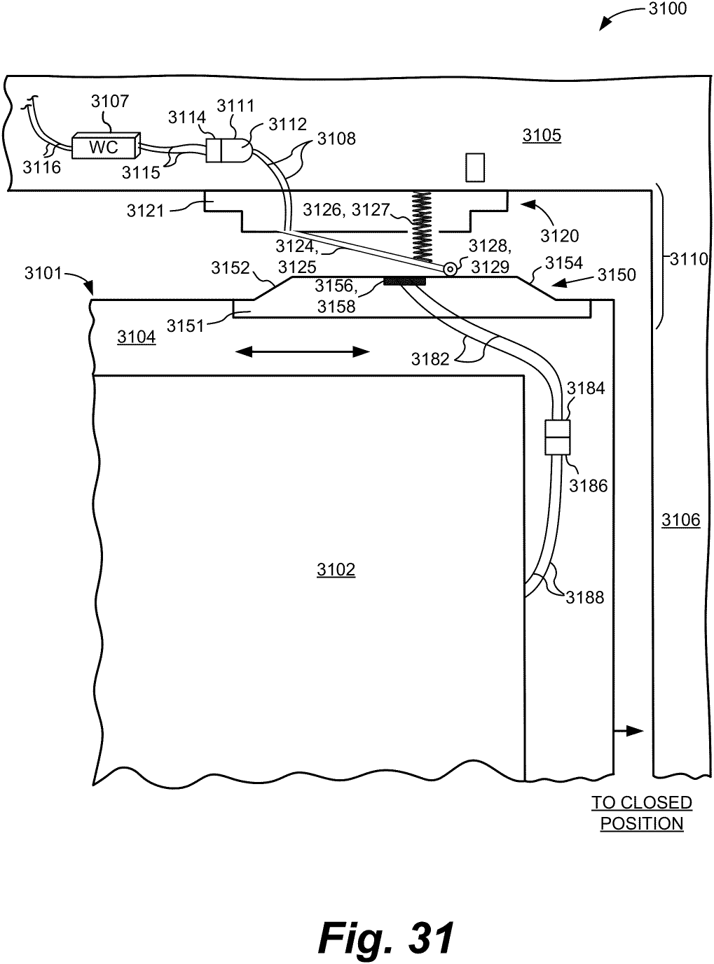

FIG. 31 is a schematic drawing depicting a cross-sectional view of components of a movable door system 3100 including a movable door 3101 with an insulated glass unit (IGU) 3102 having at least one optically switchable device (e.g., electrochromic device) and an example of a detachable power transfer (DPT) connector 3110, according to certain embodiments. Movable door 3101 includes IGU 3102 and a door frame 3104 within which the IGU 3102 is installed. Movable door 3101 is configured to move, as denoted by a double sided arrow, within a building frame including a sash 3105 and a side frame 3106. Movable door 3101 is shown in a nearly closed position where the movement to the closed position at the side frame 3106 as denoted by a single side arrow. According to one aspect, IGU 3102 may have similar components to those of IGU 325 described with respect to FIG. 3. Although DPT connector 3110 is described with respect to providing power to movable door 3101, alternatively or additionally, DPT connector 3110 may be implemented to provide power to one or more other movable doors/windows. While FIG. 31 shows an example of components of DPT connector 3110, any number of these components may be included in DPT connector 3110, or any of the components may be omitted in other implementations. In alternative configurations, different or additional components may be included in DPT connector 3110.

DPT connector 3110 includes a frame-side (first) component 3120 attached to sash 3105 and a door side (second) component 3150 attached to door frame 3104. A frame-side component attached to a sash is sometimes referred to herein as a sash-side component. Frame-side component 3120 includes a housing 3121 and two spring-loaded articulating tabs 3124, 3125 connected to housing 3121. Frame-side component 3120 also includes two springs 3126, 3127 attached to housing 3121 and in contact with two spring-loaded articulating tabs 3124, 3125 respectively. Frame-side component 3120 also includes two wheels or rollers 3128, 3129 attached to the respective distal ends of spring-loaded articulating tabs 3124, 3125. The wheels or rollers 3128, 3129 are made of an electrically conductive material. Housing 3121 and other components of the frame-side component 3120 may be made of, or coated by, a non-conductive or electrically insulative material.

In the illustrated example, the spring-loaded articulating tabs (arms) 3124, 3125 are positioned side by side in a direction perpendicular to the plane of the illustrated cross-section view. In another implementation, spring-loaded articulating tabs 3124, 3125 may be located one behind the other, or staggered, along the length of frame-side (first) component 3120. In yet another implementation, the DPT connector 3110 may have a single articulating arm with two contacts electrically connected respectively to two conductors.

Spring-loaded articulating tabs 3124, 3125 are in contact with springs 3126, 3127 to provide pressure to wheels or rollers 3128, 3129 when springs 3126, 3127 are compressed. Spring-loaded articulating tabs 3124, 3125 are made of an electrically conductive material. Housing 3121 and other components of the frame-side component 3120 may be made of, or coated by, a non-conductive or electrically insulative material.

Spring-loaded articulating tabs 3124, 3125 are in electrical communication with a window controller 3107 via a wiring assembly. The wire assembly includes wires 3108 electrically connected to a first electrical connector 3111 having a memory chip or integrated circuit 3112, a second electrical connector 3114 electrically connected to first electrical connector 3111, and wires 3115. Second electrical connector 3114 is electrically connected to window controller 3107 via wires 3115. Window controller 3107 may be electrically connected via wiring 3116 to a power source and/or one or more sensors. Memory chip 3112 may be programmable with window data such as, e.g., the length of wire between the IGU 3102 and window controller 3107. Spring-loaded articulating tabs 3124, 3125 provide a positive voltage (e.g., V+) contact and a negative voltage (e.g., V-) contact respectively. While wires 3108 are depicted in FIG. 31 as connected at a first end of spring-loaded articulating tabs 3124, 3125, in another implementation, wires 3108 may pass along the length of spring-loaded articulating tabs 3124, 3125 to electrically connect to wheels or rollers 3128, 3129.

Door side component 3150 includes a housing 3151 with a leading edge ramp 3152 and a trailing edge ramp 3154. Door side component 3150 also includes two contact pads 3156, 3158 of an electrically conductive material: a first contact pad 3156 that can establish an electrical connection when in contact with spring-loaded articulating tab 3124 having a positive voltage (e.g., V+) and a second contact pad 3158 that can establish electrically connection when in contact with spring-loaded articulating tab 3125 having a negative voltage (e.g., V-). Contact pads 3156, 3158 are electrically connected to wiring 3182, e.g., via pogo pins and/or other electrically conductive connections. Wiring 3182 is electrically connected to a third electrical connector 3184 which is connected to a fourth electrical connector 3186. Fourth electrical connector 3186 is electrically connected via two wires 3188 (e.g., a V+ voltage wire and a V-voltage wire) and/or other conductive connections to one or more devices of IGU 3102. For example, a first voltage wire (V+ voltage wire) may be connected electrically to a first bus bar of at least one optically switchable device and second voltage wire (V- voltage) may be connected electrically to a second bus bar with opposing polarity of the at least one optically switchable device. Contact pads 3156, 3158 are made of an electrically conductive material. Other components of the door side component 3150 may be made of, or coated by, a non-conductive or electrically insulative material.

In another implementation, frame-side component 3120 may be located within a recess of sash 3105. For example, the outer surface of frame-side component 3120 may be flush with the outer surface of sash 3105.

When movable door 3101 is moved from an open position to a closed position, the wheels or rollers 3128, 3129 roll up the leading edge ramp 3152 compressing springs 3126, 3127 and locating wheels or rollers 3128, 3129 in contact with contact pads 3156, 3158 respectively. The compression of springs 3126, 3127 provide pressure on the wheels or rollers 3128, 3129 to help maintain electrical contact with contact pads 3156, 3158 when movable door 3101 is in the closed position.

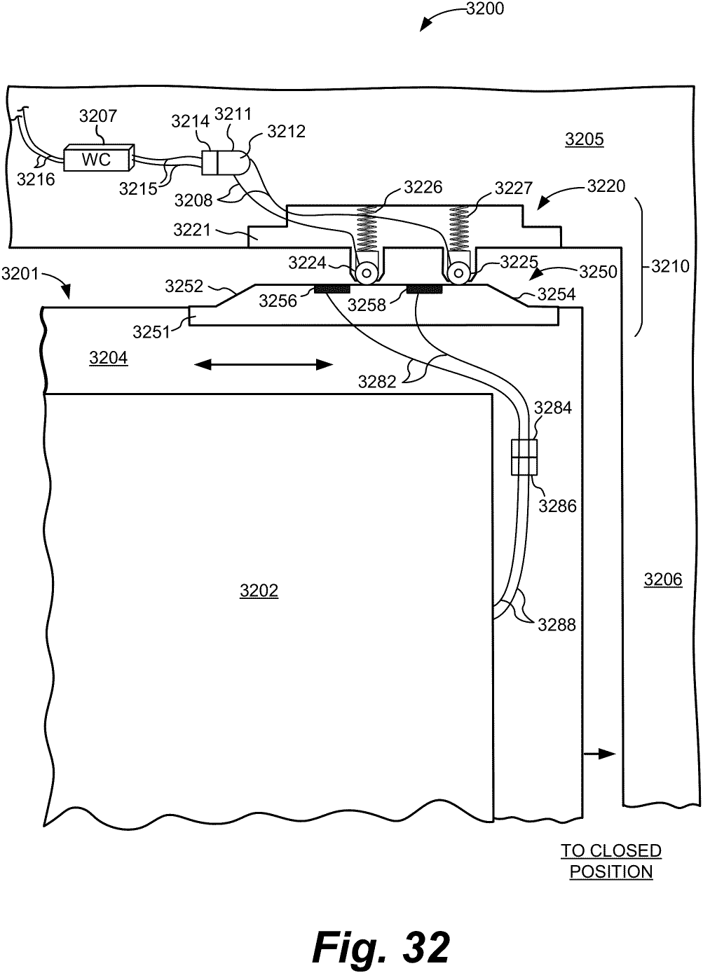

FIG. 32 is a schematic drawing depicting a cross-sectional view of components of a movable door system 3200 including a movable door 3201 with an insulated glass unit (IGU) 3202 having at least one optically switchable device (e.g., electrochromic device) and an example of a detachable power transfer (DPT) connector 3210, according to certain embodiments. Movable door 3201 includes IGU 3202 and a door frame 3204 within which the IGU 3202 is installed. Movable door 3201 is configured to move, as denoted by a double sided arrow, within a building frame including a sash 3205 and a side frame 3206. Movable door 3201 is shown in a nearly closed position where the movement to the closed position at the side frame 3206 as denoted by a single side arrow. According to one aspect, IGU 3202 may have similar components to those of IGU 325 described with respect to FIG. 3. Although DPT connector 3210 is described with respect to providing power to movable door 3201, alternatively or additionally, DPT connector 3210 may be implemented to provide power to other movable doors and to movable windows. While FIG. 32 shows an example of components of DPT connector 3210, any number of these components may be included in DPT connector 3210, or any of the components may be omitted in other implementations. In alternative configurations, different or additional components may be included in DPT connector 3210.

DPT connector 3210 includes a frame-side (first) component 3220 attached to sash 3205 and a door side (second) component 3250 attached to door frame 3204. The frame-side component 3220 attached to sash 3205 is also sometimes referred to as a sash-side component. Frame-side component 3220 includes a housing 3221 and two spring-loaded rollers 3224, 3225 connected respectively to two springs 3226, 3227 that are attached to housing 3221. Spring-loaded rollers 3224, 3225 are made of an electrically conductive material. Housing 3221 and other components of the frame-side component 3220 may be made of, or coated by, a non-conductive or electrically insulative material. Spring-loaded rollers 3224, 3225 are in electrical communication with a window controller 3207 via a wiring assembly. The wire assembly includes wires 3208 electrically connected to a first electrical connector 3211 having a memory chip or integrated circuit 3212, a second electrical connector 3214 electrically connected to first electrical connector 3211, and wires 3215 Memory chip 3212 may be programmable with window data such as, e.g., the length of wire between the IGU 3202 and window controller 3107. Second electrical connector 3214 is electrically connected to window controller 3207 via wires 3215. Window controller 3207 may be electrically connected via wiring 3216 to a power source and/or one or more sensors. Spring-loaded rollers 3224, 3225 provide a positive voltage (e.g., V+) contact and a negative voltage (e.g., V-) contact respectively.

Door side component 3250 includes a housing 3251 with a leading edge ramp 3252 and a trailing edge ramp 3254. Door side component 3250 also includes two contact pads 3256, 3258 of an electrically conductive material: a first contact pad 3256 that can establish an electrical connection when in contact with spring-loaded roller or wheel 3224 having a positive voltage (e.g., V+) and a second contact pad 3258 that can establish an electrical connection when in contact with spring-loaded roller 3225 having a negative voltage (e.g., V-). Contact pads 3256, 3258 are electrically connected to wiring 3282, e.g., via pogo pins and/or other electrically conductive connections. Wiring 3282 is electrically connected to a third electrical connector 3284 which is connected to a fourth electrical connector 3286. Fourth electrical connector 3286 is electrically connected via two wires 3288 (e.g., a V+ voltage wire and a V- voltage wire) and/or other conductive connections to one or more devices of IGU 3202. For example, a first voltage wire (V+ voltage wire) may be connected electrically to a first bus bar of at least one optically switchable device and second voltage wire (V- voltage) may be connected electrically to a second bus bar with opposing polarity of the at least one optically switchable device. Contact pads 3256, 3258 are made of an electrically conductive material. Other components of the door side component 3250 may be made of, or coated by, a non-conductive or electrically insulative material.

When movable door 3201 is moved from an open position to a closed position, the spring-loaded rollers 3224, 3225 roll up the leading edge ramp 3252 compressing springs 3226, 3227 and locating spring-loaded rollers 3224, 3225 in contact with contact pads 3256, 3258 respectively. The compression of springs 3226, 3227 places pressure spring-loaded rollers 3224, 3225 and may help maintain electrical contact with contact pads 3256, 3258 when movable door 3201 is in the closed position.

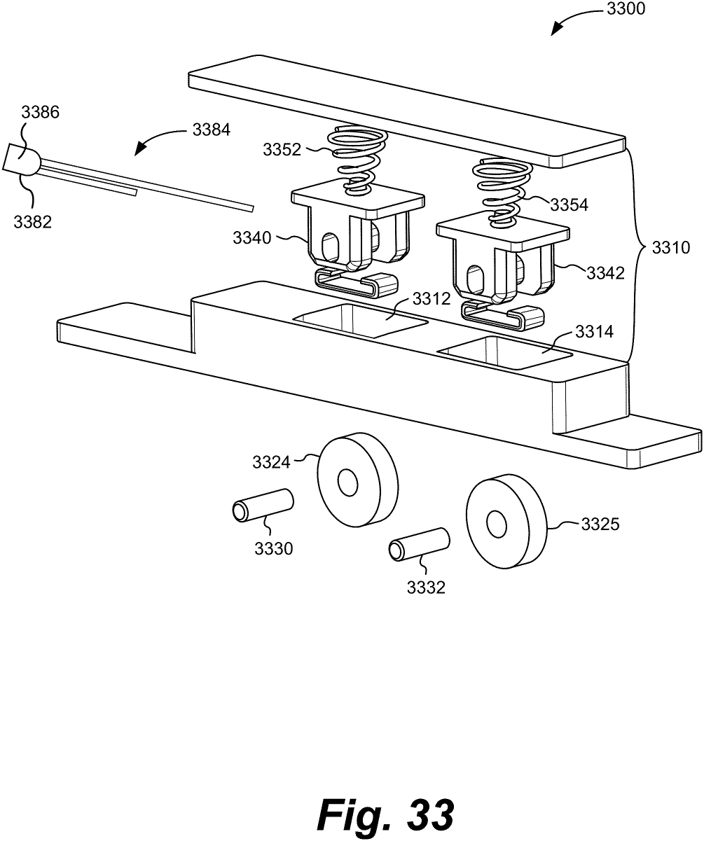

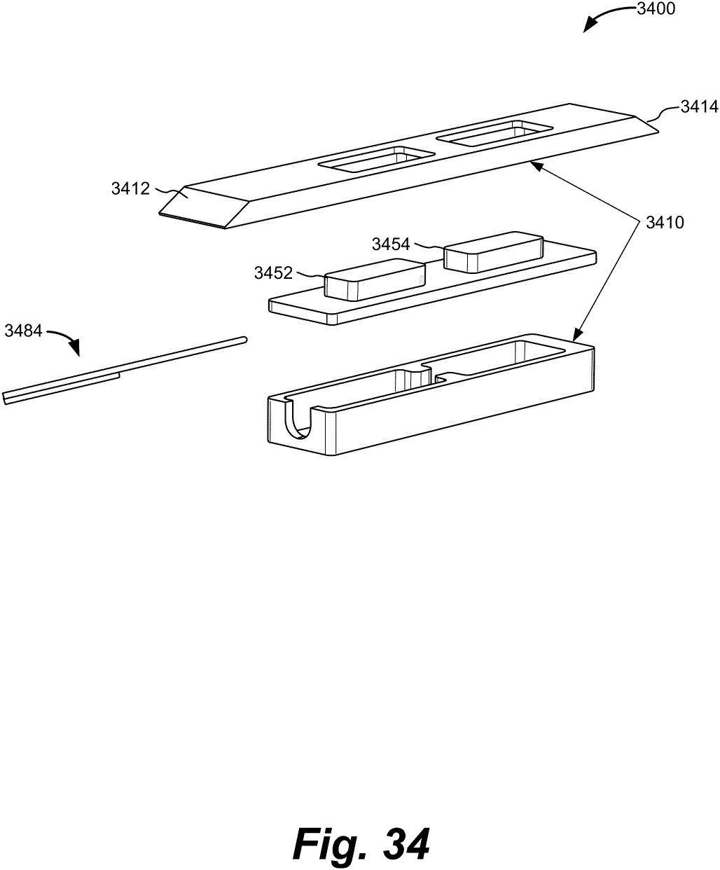

FIGS. 33 and 34 illustrate a frame-side component 3300 and a door or window side component 3400 of an example of a detachable power transfer (DPT) connector according to embodiments. The DPT connector may be employed with a movable window or a movable door. FIG. 33 is a drawing of an exploded view of the frame-side component 3300. Frame-side component 3300 may be a sash-side component attached to a sash of a building in one implementation. While FIGS. 33 and 34 shows an example of subcomponents of frame side and door side components of a DPT connector, any number of these subcomponents may be included in the DPT connector, or any of the subcomponents may be omitted. In alternative configurations, different or additional components may be included in the DPT connector. According to one aspect, frame-side component 3300 may have similar features to those of frame-side component 3220 described with respect to FIG. 32.

Frame-side component 3300 includes a housing 3310 with two recesses 3312, 3314 and first and second spring-loaded rollers 3324, 3325 that can move within respective recesses 3312, 3314. First spring-loaded roller 3324 is connected to an axle 3300 that can rotate within a slot of a portion 3340 attached to a first spring 3352, which is attached to housing 3310. Second spring-loaded roller 3325 is connected to an axle 3332 that can rotate within a slot of a portion 3342 attached to a second spring 3354, which is attached to housing 3310. Spring-loaded rollers 3324, 3325 are made of an electrically conductive material. Housing 3310 and other components of the frame-side component 3300 may be made of, or coated by, a non-conductive or electrically insulative material.

Spring-loaded rollers 3324, 3325 are in electrical communication with an electrical connector 3382 via wiring 3384. Electrical connector 3382 includes a memory chip 3386, which may be programmable with information or logic associated with a window or door. Electrical connector 3382 may also be in electrical communication with a window controller via a wiring assembly. The window controller may be electrically connected to a power source and/or one or more sensors. Spring-loaded rollers 3324, 3325 may provide a positive voltage (e.g., V+) contact and a negative voltage (e.g., V-) contact.

FIG. 34 is a drawing of an exploded view of a window or door side component 3400 associated with the frame-side component 3300 in FIG. 33. According to one aspect, window or door side component 3400 may have similar features to those of door side component 3250 described with respect to FIG. 32.

Window or door side component 3400 includes a housing 3410 with a leading edge ramp 3412 and a trailing edge ramp 3414. Door side component 3400 also includes a first pad 3452 for electrically contacting to establish an electrical connection with spring-loaded roller 3424 (shown in FIG. 33) and a second pad 3454 for electrically contacting to establish an electrical connection with spring-loaded roller 3425 (shown in FIG. 33).

Pads 3452, 3454 are in electrical communication with one or more devices in an IGU of a movable window or a movable door. For example, the pads 3452, 3454 are in be connected electrically via wires 3484 and/or other electrically conductive elements to a first bus bar of an electrochromic device and to a second bus bar of the electrochromic device with opposing polarity. Pads 3452, 3454 are made of an electrically conductive material. Other components of the door side component 3400 may be made of, or coated by, a non-conductive or electrically insulative material.

In some cases, a frame-side component (e.g., frame side component 3120 in FIG. 31, frame-side component 3220 in FIG. 32, or frame-side component 3300 in FIG. 33) may be attached to the side frame (e.g., side frame 3106 in FIG. 31 or side frame 3206 in FIG. 32). In these cases, the frame-side component and window or door side component may butt up against each other to make contact.

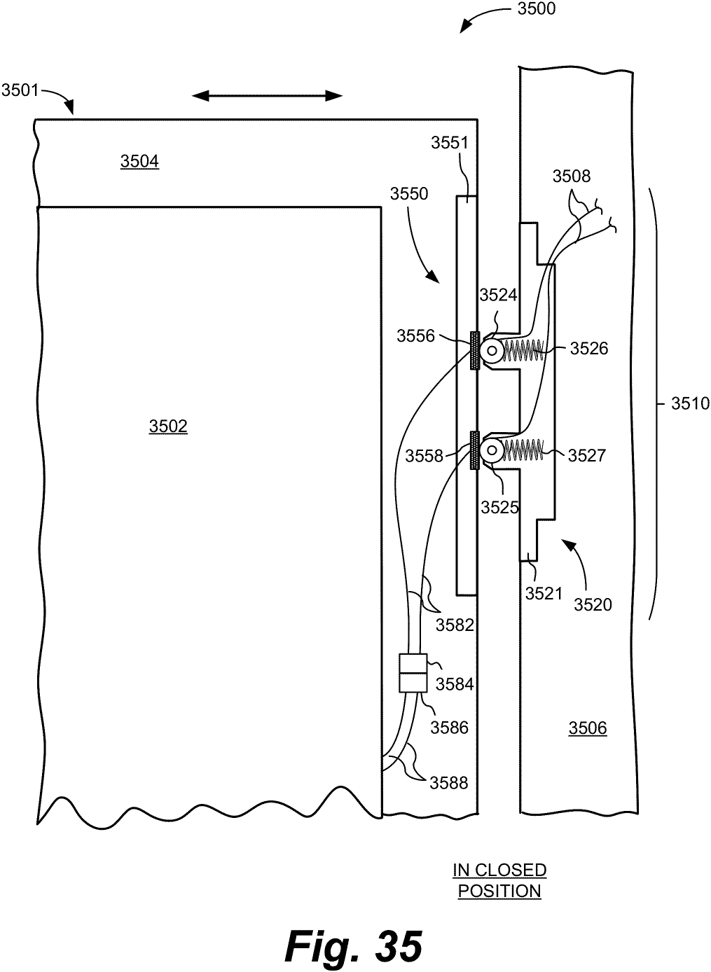

FIG. 35 is a schematic drawing depicting a cross-sectional view of components of a movable door system 3500 including a movable door 3501 with an insulated glass unit (IGU) 3502 having at least one optically switchable device (e.g., electrochromic device) and an example of a detachable power transfer (DPT) connector 3510 with a frame-side component 3520 attached to a side frame 3506, according to certain embodiments. Movable door 3501 includes IGU 3502 and a door frame 3504 within which the IGU 3502 is installed. Movable door 3501 is configured to move, as denoted by a double sided arrow, within a building frame. Movable door 3501 is shown in a closed position. According to one aspect, IGU 3502 may have similar components to those of IGU 325 described with respect to FIG. 3. Although DPT connector 3510 is described with respect to providing power to movable door 3501, alternatively or additionally, DPT connector 3510 may be implemented to provide power to other movable doors and to movable windows. While FIG. 35 shows an example of components of DPT connector 3510, any number of these components may be included in DPT connector 3510, or any of the components may be omitted in other implementations. In alternative configurations, different or additional components may be included in DPT connector 3510.

DPT connector 3510 includes a frame-side (first) component 3520 attached to side frame 3206 and a window or door side (second) component 3550 attached to door frame 3504. Frame-side component 3520 includes a housing 3521 and two spring-loaded rollers 3524, 3525 connected respectively to two springs 3526, 3527 that are attached to housing 3521. Spring-loaded rollers 3524, 3525 are made of an electrically conductive material. Housing 3521 and other components of the frame-side component 3520 may be made of, or coated by, a non-conductive or electrically insulative material. Spring-loaded rollers 3524, 3525 may be in electrical communication with a window controller and or an electrical connector having a memory chip via wiring 3508.

Window or door side component 3550 includes a housing 3551 and two contact pads 3556, 3558 of an electrically conductive material: a first contact pad 3556 that can establish an electrical connection when in contact with spring-loaded roller 3524 having a positive voltage (e.g., V+) and a second contact pad 3558 that can establish an electrical connection when in contact with spring-loaded roller 3525 having a negative voltage (e.g., V-). Contact pads 3556, 3558 are electrically connected to wiring 3582, e.g., via pogo pins and/or other electrically conductive connections. Wiring 3582 is electrically connected to a third electrical connector 3584 which is connected to a fourth electrical connector 3586. Fourth electrical connector 3586 is electrically connected via two wires 3588 (e.g., V+ voltage wire and V- voltage wire) and/or other conductive connections to one or more devices of IGU 3502. For example, a first voltage wire (a V+ voltage wire) may be connected electrically to a first bus bar of the at least one optically switchable device and second voltage wire (a V- voltage wire) may be connected electrically to a second bus bar with opposing polarity to the at least one optically switchable device. Contact pads 3556, 3558 are made of an electrically conductive material. Other components of window or door side component 3550 may be made of, or coated by, a non-conductive or electrically insulative material.

When movable door 3501 is moved to the closed position, the spring-loaded rollers 3524, 3525 contact pads 3556, 3558 respectively and springs 3526, 3527 compress causing pressure to be applied to spring-loaded rollers 3524, 3525, which may help maintain electrical contact with contact pads 3556, 3558. In one implementation, frame-side component 3520 includes a first set of magnets and the door side component 3550 has a second set of magnets of opposing polarity. The magnetic elements of the connector components may attract each other and engage to make the electrical connection and/or to maintain movable door 3501 in the closed position.

In another implementation, DPT connector 3510 shown in FIG. 35 may be employed to establish electrical connection between a movable frame and second mounted frame such as shown in FIG. 8. In this case, frame-side component 3520 of DPT connector 3510 may be located in the frame 810 at an edge to the bottom of the drawing.

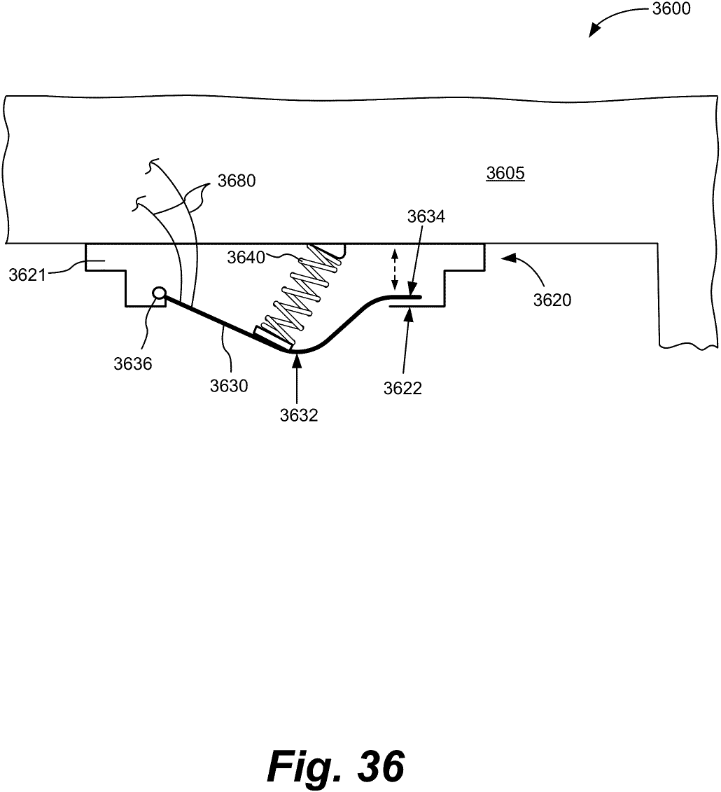

FIG. 36 is a schematic drawing depicting a cross-sectional view of components of a movable door system 3600 with an example of frame-side component 3620 attached to a sash 3605 (also referred to as a sash-side component) of a detachable power transfer (DPT). While FIG. 36 shows an example of components of DPT connector, any number of these components may be included in DPT connector, or any of the components may be omitted. In alternative configurations, different or additional components may be included in DPT connector.

Frame-side component 3620 includes a housing 3621 with a lip 3622. The frame-side component 3620 also includes one or more spring-loaded articulating tabs 3630 with one or more distal ends 3634 that contact the lip 3622 when the door or window is in the open position. The one or more spring-loaded articulating tabs 3630 rotate about a pivot 3636. The frame-side component 3620 also includes one or more springs 3640 attached to housing 3621 at one end and in contact with an inside surface of the one or more spring-loaded articulating tabs 3630 at the other end.

The one or more spring-loaded articulating tabs 3630 are in contact with one or more springs 3640 to provide pressure when the one or more springs 3640 are compressed. Movement of the one or more spring-loaded articulating tabs 3630 is stopped when the one or more distal ends 3634 contact lip 3622. A mid portion 3632 of the one or more spring-loaded articulating tabs 3630 may contact respective one or more contact pads on a door side or window side component of the DPT connector. At least the mid portion 3632 of the one or more spring-loaded articulating tabs 3630 is made of an electrically conductive material. Housing 3621 and other components of frame-side component 3620 may be made of, or coated by, a non-conductive or electrically insulative material.

The one or more spring-loaded articulating tabs 3630 may be in electrical communication with a window controller and/or a memory chip via wiring 3680. Although wiring 3680 is depicted as connected at a first proximal end of one or more spring-loaded articulating tabs 3630, in another implementation, wiring 3680 may pass along the one or more spring-loaded articulating tabs 3630 to the mid portion 3632.

In one implementation, the one or more spring-loaded articulating tabs 3630 may include two spring-loaded articulating tabs 3630 that are positioned side by side along the width or offset from each other, e.g., along the length of the frame-side component 3620. In another implementation, the one or more single spring-loaded articulating tabs 3630 may be a single spring-loaded articulating tab with two contacts electrically connected respectively to two conductors (e.g., wires).

In one implementation, frame-side component 3620 also includes one or more wheels or rollers attached to the respective one or more distal ends 3634 of the one or more spring-loaded articulating tabs 3630.

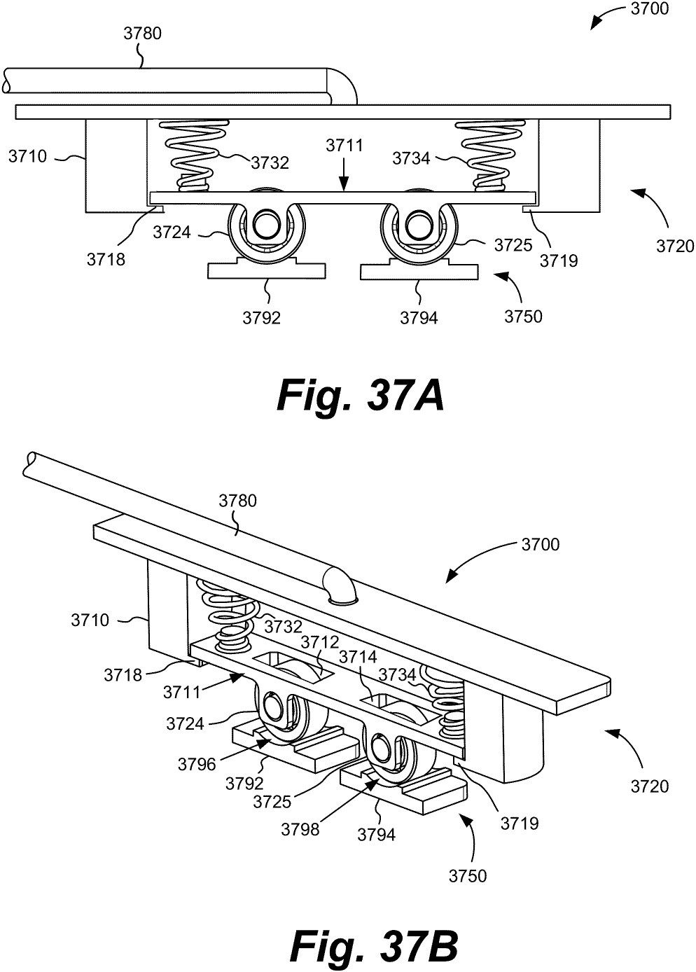

FIG. 37A is a schematic drawing depicting a cross-sectional view of components of a detachable power transfer (DPT) connector 3700, according to certain embodiments. FIG. 37B is a schematic drawing depicting an isometric view of components of the detachable power transfer (DPT) connector 3700 in FIG. 37A. While FIGS. 37A and 37B show an example of components of DPT connector 3700, any number of these components may be included in DPT connector 3700, or any of the components may be omitted. In alternative configurations, different or additional components may be included in DPT connector 3700.

DPT connector 3700 includes a frame-side (first) component 3720 and contact pads 3792, 3794 of a window or door side (second) component 3750. According to one aspect, frame-side component 3720 may have similar features to those of frame-side component 3300 described with respect to FIG. 33.

In FIGS. 37A and 37B, frame-side component 3720 includes a housing 3710 with a slidable portion having two openings 3712, 3714. The slidable portion 3711 can slide along the inner surfaces of walls of another portion of the housing 3710 until movement is restricted when contacting the inner surfaces of lips 3718, 3719 of housing 3710. Frame-side component 3700 also includes first and second spring-loaded rollers 3724, 3725 that can move within respective openings 3712, 3714 of the slidable portion 3711 of housing 3710. The first spring-loaded roller 3724 is connected to an axle that can rotate within a first slot of slidable portion 3711. The second spring-loaded roller 3725 is connected to another axle that can rotate within a second slot of slidable portion 3711. Frame-side component 3720 also includes a first spring 3732 and a second spring 3734. The slidable portion 3711 is attached to one end of first spring 3732 and to one end of second spring 3734. The other ends of the first spring 3732 and second spring 3734 are attached to the other portion of the housing 3710. Spring-loaded rollers 3724, 3725 are made of an electrically conductive material and may provide, for example, positive voltage (e.g., V+) and a negative voltage (e.g., V-) contacts. Housing 3710 and other components of the frame-side component 3720 may be made of, or coated by, a non-conductive or electrically insulative material. Spring-loaded rollers 3724, 3725 may be in electrical communication with a window controller via wiring passing through conduit 3780 and the window controller may be electrically connected to a power source and/or one or more sensors.

The window or door side (second) component 3750 includes contact pads 3792, 3794 with troughs 3796, 3798 that are at least partially made of an electrically conductive material. The troughs 3796, 3798 can seat and help maintain the spring-loaded rollers 3724, 3725 in contact with the electrically conductive material when the door or window is in a closed position. When the door or window is moved from an open position to a closed position, the spring-loaded rollers 3724, 3725 roll into the troughs 3796, 3798, compressing the first and second springs 3732, 3734, establishing an electrical connection between the spring-loaded rollers 3724, 3725 and the contact pads 3792, 3794 at the troughs 3796, 3798. When the door or window is in a closed position, the compressed first spring 3732 and second spring 3734 provide a pressure at the spring-loaded rollers 3724, 3725 that facilitates maintaining electrical contact with contact pads 3792, 3794. When the door or window is moved from the closed position to the open position, the spring-loaded rollers 3724, 3725 roll out of the troughs 3796, 3798, disengaging the electrical connection.

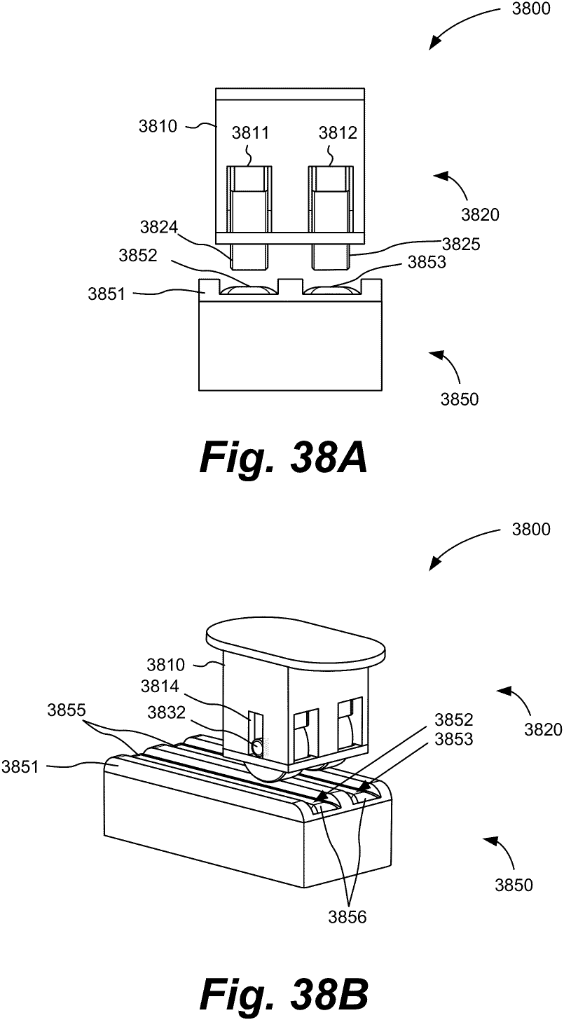

FIG. 38A is a schematic drawing depicting a side view of components of a detachable power transfer (DPT) connector 3800, according to certain embodiments. FIG. 38B is a schematic drawing depicting an isometric view of components of the detachable power transfer (DPT) connector 3800 in FIG. 38A. While FIGS. 38A and 38B show an example of components of DPT connector 3800, any number of these components may be included in DPT connector 3800, or any of the components may be omitted. In alternative configurations, different or additional components may be included in DPT connector 3800.

DPT connector 3800 includes a frame-side (first) component 3820 and a window or door side (second) component 3850. Frame-side component 3820 includes a housing 3810 having a first recess 3811 and a second recess 3812 and four slots 3814 in outer walls of the housing 3810. Frame-side component 3820 also includes first and second spring-loaded rollers 3824, 3825 that can move within first recess 3811 and second recess 3812 respectively. The first spring-loaded roller 3824 is connected to an axle 3832 that can rotate within a slot 3814 in housing 3810. The second spring-loaded roller 3825 is connected to another axle 3832 that can rotate within another slot 3814 in housing 3810. The axles 3832 can move along the slots 3814. First and second spring-loaded rollers 3824, 3825 can displace until movement is restricted when the axles 3832 contact the inner surface of the respective slots 3814.

Spring-loaded rollers 3824, 3825 are made of an electrically conductive material and may provide, for example, positive voltage (e.g., V+) and a negative voltage (e.g., V-) contacts. Housing 3810 and other components of the frame-side component 3820 may be made of, or coated by, a non-conductive or electrically insulative material. Spring-loaded rollers 3824, 3825 may be in electrical communication with a window controller, which may be electrically connected to a power source and/or one or more sensors.

The window or door side (second) component 3850 includes a contact pad area 3851 with lengthwise rails 3852, 3853 that are at least partially made of an electrically conductive material. Each of the lengthwise rails 3852, 3853 include a leading edge ramp 3855 and a trailing edge ramp 3856. When the door or window is moved from an open position to a closed position, the spring-loaded rollers 3824, 3825 roll up the leading edge ramps 3855 compressing the springs and locating spring-loaded rollers 3824, 3825 in contact with the electrically conductive material of the lengthwise rails 3852, 3853. The compression of the springs places pressure on spring-loaded rollers 3824, 3825 which may help maintain electrical contact with the electrically conductive material contact when the window or door is in the closed position. When the door is moved from the closed position to the open position, the spring-loaded rollers 3824, 3825 roll out of the lengthwise rails 3852, 3853, disengaging the electrical connection.

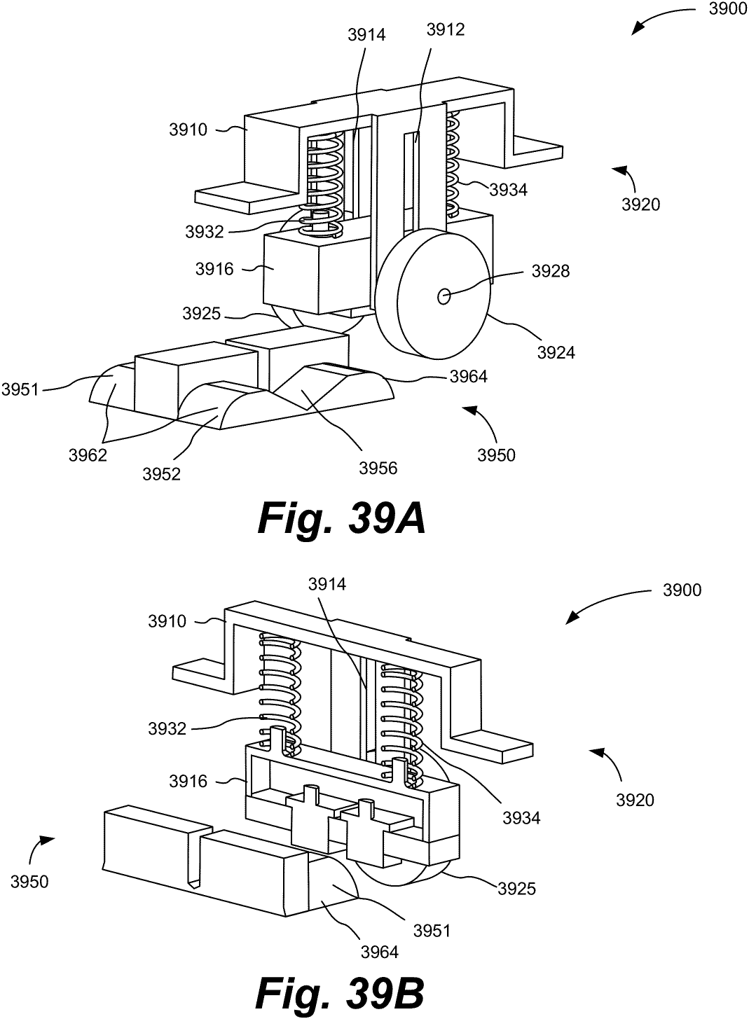

FIG. 39A is a schematic drawing depicting an isometric view of components of a detachable power transfer (DPT) connector 3900, according to certain embodiments. FIG. 39B is a schematic drawing depicting a sectional view of components of the detachable power transfer (DPT) connector 3900 in FIG. 39A. While FIGS. 39A and 39B show an example of components of DPT connector 3900, any number of these components may be included in DPT connector 3900, or any of the components may be omitted. In alternative configurations, different or additional components may be included in DPT connector 3900.

DPT connector 3900 includes a frame-side (first) component 3920 and a door side (second) component 3950. Frame-side component 3920 includes a housing 3910 having a first slot 3912 and a second slot 3914 in two opposing walls of the housing 3910. Frame-side component 3920 also includes a movable portion 3916 and first and second spring-loaded rollers 3924, 3925 attached to two axles 3928 that are rotatably attached to the movable portion 3916. The first spring-loaded roller 3924 is connected to a first axle 3928 that can move along a first slot 3912 in another portion of housing 3910. The second spring-loaded roller 3925 is connected to a second axle 3928 that can rotate within a second slot 3914 of the other portion of the housing 3910. Frame-side component 3820 also includes a first spring 3932 and a second spring 3934. The movable portion 3916 is attached to one end of first spring 3932 and to one end of second spring 3934. The other ends of the first spring 3932 and second spring 3934 are attached to the other portion of the housing 3910. In this illustrated example, the first and second spring-loaded rollers 3924, 3925 are located to the outside of the walls of the housing 3920 in which the first and second slots 3912, 3914 are located. First and second spring-loaded rollers 3924, 3925 can displace until movement is restricted when the axles 3928 contact the inner surfaces at the ends of the respective slots 3912, 3914. Spring-loaded rollers 3924, 3925 are made of an electrically conductive material and may provide, for example, positive voltage (e.g., V+) and a negative voltage (e.g., V-) contacts. Housing 3910 and other components of the frame-side component 3920 may be made of, or coated by, a non-conductive or electrically insulative material. Spring-loaded rollers 3924, 3925 may be in electrical communication with a window controller, which may be electrically connected to a power source and/or one or more sensors.

The window or door side (second) component 3950 includes contact pads 3951, 3952. Each of the contact pads 3951, 3952 includes a leading edge ramp 3962 and a trailing edge ramp 3964. The contact pads 3951, 3952 also include troughs 3956 that are at least partially made of an electrically conductive material. The troughs 3956 can seat and help maintain the spring-loaded rollers 3924, 3925 in contact with the electrically conductive material in the troughs 3956 when the door or window is in a closed position. When the door or window is moved from an open position to a closed position, first and second spring-loaded rollers 3924, 3925 roll up the leading edge ramps 3962 and into the troughs 3956, compressing first and second springs 3932, 3934, and establishing an electrical connection between first and second spring-loaded rollers 3924, 3925 and the conductive material of the troughs 3956. When the door or window is in a closed position, the compressed first spring 3932 and compressed second spring 3934 provide a pressure at the first and second spring-loaded rollers 3924, 3925 that facilitates maintaining electrical contact with contact pads 3951, 3952. When the door or window is moved from the closed position to the open position, the first and second spring-loaded rollers 3924, 3925 roll out of the troughs 3956, disengaging the electrical connection.

Although some examples of DPT connectors are described as having spring-loaded conductive elements in a frame-side component and a leading edge ramp in the door/window side component, in another implementation, the spring-loaded conductive elements may be in the door/window side component attached the movable door and the leading edge ramp in the frame-side component attached to the frame of the building. For example, the first component 3120 may be attached to movable door 3101 and second component 3150 may be attached to sash 3105. As another example, the first component 3220 may be attached to movable door 3201 and second component 3250 may be attached to sash 3205. As another example, the first component 3300 may be attached to a movable door or movable window and second component 3400 may be attached to a framing of the building such as a sash. In yet another example, the first component 3620 may be attached to a movable door or movable window.

DPT connectors described herein can be employed to provide an electrical connection for providing power in various configurations of movable windows and doors such as, for example, movable door 900m, detachable doors 2101a-d, movable frame 705, movable frames 805, 807, movable frame 925, movable frame 935, movable door 921, movable doors 1901b-e, movable doors 1993b-e, movable door 1997b-e, movable doors 2001b-e, EC windows 2701, EC windows 2801, EC windows 2901, and EC window/door 3001, 3002, and 3003, etc.

DPT connectors described herein can be used to provide an electrical connection to a movable window or door that translates and/or rotates into a closed position. For example, DPT connectors may be used to provide electrical connection to movable frame 935 in FIG. 9D that translates and rotates using a movement mechanism 937 or movable frame 925 in FIG. 9C that rotates about an axis of rotation 917. For instance, a DPT connector may be employed with a frame-side component with two spring-loaded conductive elements such as, e.g., spring-loaded articulating tabs or arms 3124, 3125 in FIG. 31, spring-loaded rollers 3224, 3225, or spring-loaded rollers 3324, 3325 in FIG. 33. The DPT connector may also have a window/door side component with two conductive pads for engaging with the two active spring-loaded conductive elements. The window/door side component may have a leading edge ramp that ramps in a direction through the width of the movable door/window.

As another example, DPT connectors can be used to electrically connect one window/door with another window or door to provide power, for example, in a plurality of movable doors (e.g., detachable doors 2101a-d). In this example, the frame-side component may have two spring-loaded conductive elements such as, e.g., spring-loaded articulating tabs or arms 3124, 3125 in FIG. 31, spring-loaded rollers 3224, 3225, or spring-loaded rollers 3324, 3325 in FIG. 33 in an adjacent door.

Although the DPT connectors in certain illustrated examples, (e.g., in FIG. 31-31) are described as providing an electrical connection to a movable door, it would be understood that these DPT connectors may also be employed to provide electrical connection to a movable window.

In one embodiment, the DPT connector includes magnetic elements with opposing polarity on the frame-side component and on the door/window side component. The magnetic elements of the connector components attract each other and engage to make the electrical connection.

Although the foregoing embodiments have been described in some detail to facilitate understanding, the described embodiments are to be considered illustrative and not limiting. It will be apparent to one of ordinary skill in the art that certain changes and modifications can be practiced within the scope of the appended claims.

Modifications, additions, or omissions may be made to any of the above-described implementations without departing from the scope of the disclosure. Any of the implementations described above may include more, fewer, or other features without departing from the scope of the disclosure. Additionally, the steps of described features may be performed in any suitable order without departing from the scope of the disclosure. Also, one or more features from any implementation may be combined with one or more features of any other implementation without departing from the scope of the disclosure. The components of any implementation may be integrated or separated according to particular needs without departing from the scope of the disclosure.

Any of the software components or functions described in this application, may be implemented as software code using any suitable computer language and/or computational software such as, for example, Java, C, C#, C++ or Python, LabVIEW, Mathematica, or other suitable language/computational software, including low level code, including code written for field programmable gate arrays, for example in VHDL. The code may include software libraries for functions like data acquisition and control, motion control, image acquisition and display, etc. Some or all of the code may also run on a personal computer, single board computer, embedded controller, microcontroller, digital signal processor, field programmable gate array and/or any combination thereof or any similar computation device and/or logic device(s). The software code may be stored as a series of instructions, or commands on a CRM such as a random access memory (RAM), a read only memory (ROM), a magnetic medium such as a hard-drive or a floppy disk, or an optical medium such as a CD-ROM, or solid stage storage such as a solid state hard drive or removable flash memory device or any suitable storage device. Any such CRM may reside on, or within, a single computational apparatus, and may be present on or within different computational apparatuses within a system or network. Although the foregoing disclosed implementations have been described in some detail to facilitate understanding, the described implementations are to be considered illustrative and not limiting. It will be apparent to one of ordinary skill in the art that certain changes and modifications can be practiced within the scope of the appended claims.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g., “such as”) provided with respect to certain implementations herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or implementations of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

1-20. (canceled)

21. A magnetic power transfer connector comprising:
a first component comprising
a housing, and
a floating portion configured to float within the housing, the floating portion comprising a first cone, a second cone, metal or one or more first magnets, and a plurality of pins; and
a second component comprising
a first cup,
a second cup, wherein the first cup and the second cup are configured to receive the first and second cones respectively,
a plurality of pads configured for connection with the plurality of pins, and
one or more second magnets of opposing polarity from the one or more first magnets.

22. The magnetic power transfer connector of claim 21, wherein the first component further comprises a retaining magnet within the housing, the retaining magnet configured to retain the floating portion within the housing when the first component is greater than an actuation distance from the second component.

23. (canceled)

24. The magnetic power transfer connector of claim 21, wherein the one or more first magnets are within the first cone and/or the second cone.

25. The magnetic power transfer connector of claim 21, wherein the one or more second magnets are at or near a surface of the first cup and/or the second cup.

26. The magnetic power transfer connector of claim 21, wherein the floating portion further includes one or more retaining arms configured to retain the floating portion at least partially within the housing when a separation distance between an outer surface of the first component and an outer surface of the second component is greater than an actuation distance .

27. The magnetic power transfer connector of claim 21, wherein the floating portion has six degrees of freedom within the housing.

28. The magnetic power transfer connector of claim 21, wherein the magnetic power transfer connector is configured to magnetically actuate connecting the plurality of pins to the plurality of pads when a separation distance between an outer surface of the first component and an outer surface of the second component is equal to or less than an actuation distance .

29. The magnetic power transfer connector of claim 21, wherein the metal or the one or more first magnets and the one or more second magnets are configured to connect the plurality of pins to the plurality of pads when the first component is equal to or less than an actuation distance from the second component.

30. The magnetic power transfer connector of claim 21, wherein the first component comprises a window controller within the housing.

31-32. (canceled)

33. The magnetic power transfer connector of claim 21, wherein the first component and the second component are located in a window or door frame.

34. The magnetic power transfer connector of claim 21, wherein either the first component or the second component are located within a movable frame around an insulated glass unit, the insulated glass unit comprising an optically switchable device.

35. A door or window system comprising:
a plurality of detachable sliding doors or windows configured to slide along, and connect to and disconnect from, a rail;
wherein each detachable sliding door or window comprises one or more magnetic power transfer connectors of any one of claims 1,
wherein each magnetic transfer connector comprises:
a first component comprising
a housing, and
a floating portion configured to float within the housing, the floating portion comprising a first cone, a second cone, metal or one or more first magnets, and a plurality of pins; and
a second component comprising
a first cup,
a second cup, wherein the first cup and the second cup are configured to receive the first and second cones respectively,
a plurality of pads configured for connection with the plurality of pins, and
one or more second magnets of opposing polarity from the one or more first magnets.

36. (canceled)

37. The door or window system of claim 35, wherein each detachable sliding door or window includes at least one insulated glass unit an optically switchable device.

38. A door or window, comprising:
one or more magnetic power transfer connectors, wherein each magnetic transfer connector comprises:
a first component comprising
a housing, and
a floating portion configured to float within the housing, the floating portion comprising a first cone, a second cone, metal or one or more first magnets, and a plurality of pins; and
a second component comprising
a first cup,
a second cup, wherein the first cup and the second cup are configured to receive the first and second cones respectively,
a plurality of pads configured for connection with the plurality of pins, and one or more second magnets of opposing polarity from the one or more first magnets.

39-47. (canceled)

48. A detachable power transfer connector comprising:
a first component comprising one or more spring-loaded conductive elements for providing power; and
a second component comprising one or more conductive pads configured to electrically contact the one or more spring-loaded conductive elements;
wherein the detachable power transfer connector has only two active electrical contacts between the first and second components.

49. The detachable power transfer connector of claim 48, wherein the one or more conductive pads comprise a compliant electrically conductive material.

50. The detachable power transfer connector of claim 49, wherein the compliant electrically conductive material comprises one or more of a woven metallic fabric, conductive elastomers, bristles, a thin metal foil, or one or more springs.

51. The detachable power transfer connector of claim 48, wherein the detachable power transfer connector is between 0.25 inches and 1.5 inches wide.

52. The detachable power transfer connector of claim 48, wherein the one or more conductive pads are comprised of a metal or metal plated.

53. The detachable power transfer connector of claim 48, wherein the one or more conductive pads are gold-plated, silver-plated, nickel-plated, or copper-plated.

54. The detachable power transfer connector of claim 48, wherein the at least a portion of one or more of the one or more conductive pads or the one or more spring-loaded conductive elements are made of a carbon brush material.

55. The detachable power transfer connector of claim 48, wherein each of the one or more spring-loaded conductive elements comprises a spring-loaded articulating tab with a wheel at a distal end.

56. The detachable power transfer connector of claim 48, wherein:
the second component is configured to attach to a movable window or a movable door, and
the one or more spring-loaded conductive elements are in electrical communication with a memory chip or an integrated circuit device programmable with information associated with the movable door or the movable window.

57. The detachable power transfer connector of claim 56, wherein the memory chip or integrated circuit device is (i) located within the first component or (ii) located within a frame of a building and is in electrical communication with the first component.

58. The detachable power transfer connector of claim 56, wherein the one or more spring-loaded conductive elements are further in electrical communication with one or more window controllers.

59. The detachable power transfer connector of claim 58, wherein the information associated with the movable door or the movable window includes a wire length between the movable window or the movable door and the one or more window controllers.

60. The detachable power transfer connector of claim 48, wherein each of the one or more spring-loaded conductive elements comprises a spring-loaded roller or wheel.

61. The detachable power transfer connector of claim 48, wherein the first component comprises a housing, the housing comprising a leading edge ramp.

62. The detachable power transfer connector of claim 61, wherein the one or more spring-loaded conductive elements are configured to slide or roll along the leading edge ramp to compress one or more springs attached to the spring-loaded conductive elements.

63. The detachable power transfer connector of claim 62, wherein the second component is configured to attached to a movable window or a movable door, and wherein the one or more spring-loaded conductive elements and respective one or more conductive pads are configured to electrically contact each other when the movable door or the movable door is in, or nearly in, a closed position.

64. The detachable power transfer connector of claim 61, wherein the housing of the first component further comprises a trailing edge ramp.

65. The detachable power transfer connector of claim 48, wherein the second component is configured to attach to a movable window or a movable door and the two active electrical contacts provide power to the movable window or the movable door.

66. The detachable power transfer connector of claim 48, wherein the first component is configured to attach to a frame of a building.

67. The detachable power transfer connector of claim 48, wherein:
the second component is configured to attach to a movable window or a movable door; and
the one or more spring-loaded conductive elements and respective one or more conductive pads are configured to electrically contact each other when the movable door or the movable door is in, or nearly in, a closed position.

68. The detachable power transfer connector of claim 67, wherein the one or more conductive pads are configured for connection to a plurality of pins in electrical communication with the movable window or the movable door.

69. The detachable power transfer connector of claim 48, further comprising one or more first magnets attached to the first component and one or more second magnets attached to the second component, wherein the one or more first magnets have opposing polarity to the one or more second magnets.

70. The detachable power transfer connector of claim 69, wherein the one or more first magnets and one or more second magnets are configured to magnetically actuate connecting the spring-loaded conductive elements with the one or more conductive pads.

71. A movable door or window system comprising:
at least one movable door or window configured to move into a closed position within a frame of a building; and
a detachable power transfer connector comprising a first component attached to the frame of the building and a second component attached to the at least one movable door or window, the first component comprising one or more spring-loaded conductive elements for providing power, the second component comprising one or more conductive pads configured to electrically contact the one or more spring-loaded conductive elements,
wherein the detachable power transfer connector has only two active electrical contacts between the first and second components.

72. The movable door or window system of claim 71, wherein the one or more conductive pads comprise a compliant conductive material.

73. The movable door or window system of claim 71, wherein the one or more conductive pads are comprised of a metal or are metal plated.

74. The movable door or window system of claim 71, wherein the at least a portion of one or more of the one or more conductive pads or a portion of the one or more spring-loaded conductive elements are made of a carbon brush material.

75. The movable door or window system of claim 71, wherein each of the one or more spring-loaded conductive elements comprises a spring-loaded articulating tab with a wheel at a distal end.

76. The movable door or window system of claim 71, further comprising a memory chip or an integrated circuit device programmable to include information associated with the at least one movable door or window.

77. The movable door or window system of claim 76, wherein the memory chip or integrated circuit device is (i) located within the first component or (ii) located within a frame of a building and is in electrical communication with the first component.

78. The movable door or window system of claim 76, wherein the one or more spring-loaded conductive elements are further in electrical communication with one or more window controllers.

79. The movable door or window system of claim 78, wherein the information includes a wire length between the at least one movable door or window and the one or more window controllers.

80. The movable door or window system of claim 71, wherein each of the one or more spring-loaded conductive elements comprises a spring-loaded roller or wheel.

81. The movable door or window system of claim 71, wherein the first component comprises a housing, the housing comprising a leading edge ramp.

82. The movable door or window system of claim 81, wherein the one or more spring-loaded conductive elements are configured to slide or roll along the leading edge ramp to compress one or more springs attached to the spring-loaded conductive elements.

83. The movable door or window system of claim 82, wherein the one or more spring-loaded conductive elements and respective one or more conductive pads are configured to electrically contact each other when the at least one movable door or window is in, or nearly in, a closed position.

84. The movable door or window system of claim 82, wherein the housing of the first component further comprises a trailing edge ramp.

85. The movable door or window system of claim 71, wherein the two active electrical contacts provide power to the at least one movable door or window.

86. The movable door or window system of claim 71, wherein the first component is configured to attach to a frame of a building.

87. The movable door or window system of claim 71, wherein the one or more spring-loaded conductive elements and respective one or more conductive pads are configured to electrically contact each other when the at least one movable door or window is in, or nearly in, a closed position.

88. The movable door or window system of claim 71, wherein the one or more conductive pads are configured for connection to a plurality of pins in electrical communication with the at least one movable door or window.

89. The movable door or window system of claim 71, further comprising one or more first magnets attached to the first component and one or more second magnets attached to the second component, wherein the one or more first magnets have opposing polarity to the one or more second magnets.

90. The movable door or window system of claim 89, wherein the one or more first magnets and one or more second magnets are configured to magnetically actuate connecting the spring-loaded conductive elements with the one or more conductive pads.

91-109. (canceled)
